(19) United States
(12) Patent Application Publication
(10) Pub. No.: US 2025/0278764 A1
(43) Pub. Date: Sep. 4, 2025

(54) JOB SUPPORT DEVICE AND JOB SUPPORT METHOD

(71) Applicant: TOSHIBA TEC KABUSHIKI KAISHA, Tokyo (JP)

(72) Inventor: Shino Nishikawa, Yokohama Kanagawa (JP)

(21) Appl. No.: 18/912,656

(22) Filed: Oct. 11, 2024

(30) Foreign Application Priority Data
Mar. 1, 2024 (JP) 2024-031655

(51) Int. Cl. G06Q 30/0283

(52) U.S. Cl. CPC G06Q 30/0283

(57) ABSTRACT

A job support device according to an embodiment includes a check-in unit configured to, if receiving an instruction to start use of a facility, store, in correlation with a facility identifier, in a storage unit, a user identifier of a user who uses the facility and a date and time when the user started the use, a halfway entrance unit configured to, if halfway entrance of a user is indicated to the facility being used, store, in correlation with the facility identifier, in the storage unit, a user identifier of the user who enters the facility halfway and a date and time of the halfway entrance, and a check-out unit configured to, if receiving an instruction to end the use of the facility, calculate a use charge of the facility based on a use time of the facility of each of the user identifiers correlated with the facility identifier.

### CROSS-REFERENCE TO RELATED APPLICATION

This application is based upon and claims the benefit of priority from Japanese Patent Application No. 2024-031655, filed on Mar. 1, 2024, the entire contents of which are incorporated herein by reference.

### FIELD

Embodiments described herein relate generally to a job support device and a job support method.

### BACKGROUND

There has been a store adopting a transaction form for performing reception at an entrance time and performing, at an exit time, checkout corresponding to a use time. For example, in a leisure facility such as a karaoke box store, a darts bar, or a manga café or a sports facility such as a sports gym, a golf course, or a bowling alley, reception is performed at an entrance time to the store or the facility and checkout for a usage fee of the facility, a price of eaten and drunken commodities, or the like is performed at an exit time. For example, there has been proposed a section service provision system for providing an occupied section that a user can occupy and use.

Incidentally, in the store adopting the form explained above, it is an important element to grasp states of facilities, for example, whether the facilities are used by users or are vacant. Since some users exit the facilities (exit rooms) hallway and other users enter the facilities (enter rooms) halfway, it is not easy to accurately quantify use situations of the facilities.

### DESCRIPTION OF THE DRAWINGS

FIG. 1 is a diagram illustrating an example of a configuration of a facility management system according to an embodiment;

FIG. 2 is a diagram illustrating an example of hardware components of a base server according to the embodiment;

FIG. 3 is a diagram illustrating an example of a data configuration of a room information DB according to the embodiment;

FIG. 4 is a diagram illustrating an example of a data configuration of a state management DB according to the embodiment;

FIG. 5 is a diagram illustrating an example of a data configuration of a user management DB according to the embodiment;

FIG. 6 is a diagram illustrating an example of a data configuration of a reservation management DB according to the embodiment;

FIG. 7 is a diagram illustrating an example of a data configuration of an operation result DB according to the embodiment;

FIG. 8 is a diagram illustrating an example of hardware components of a reception terminal according to the embodiment;

FIG. 9 is a diagram illustrating an example of hardware components of a terminal for external sales according to the embodiment;

FIG. 10 is a diagram illustrating an example of functional components of the base server, the terminal for external sales, and the reception terminal;

FIG. 11 is a state transition diagram illustrating an example of a state transition rule of a karaoke box according to the embodiment;

FIG. 12 is a sequence chart illustrating an example of cooperation start processing performed between the base server and the reception terminal;

FIG. 13 is a diagram illustrating an example of an operation screen displayed on the reception terminal;

FIG. 14 is a diagram illustrating an example of a room list screen displayed on the reception terminal;

FIG. 15 is a diagram illustrating a display example of a room button according to the embodiment;

FIG. 16 is a diagram illustrating a display example of the room button;

FIG. 17 is a diagram illustrating a display example of the room button;

FIG. 18 is a diagram illustrating a display example of the room button;

FIG. 19 is a diagram illustrating an example of a vacancy selection screen displayed on the reception terminal;

FIG. 20 is a diagram illustrating an example of a user information input screen displayed on the reception terminal;

FIG. 21 is a diagram illustrating an example of the user information input screen;

FIG. 22 is a diagram illustrating an example of the user information input screen;

FIG. 23 is a sequence chart illustrating an example of check-in processing performed between the base server and the reception terminal;

FIG. 24 is a diagram illustrating an example of a failure setting screen displayed on the reception terminal;

FIG. 25 is a sequence chart illustrating an example of processing relating to failure setting performed between the base server and the reception terminal;

FIG. 26 is a diagram illustrating an example of a staying selection screen displayed on the reception terminal;

FIG. 27 is a diagram illustrating an example of a commodity menu screen displayed on the reception terminal;

FIG. 28 is a sequence chart illustrating an example of processing relating to commodity order performed between the base server and the reception terminal;

FIG. 29 is a diagram illustrating an example of a room details screen displayed on the reception terminal;

FIG. 30 is a sequence chart illustrating an example of change processing performed between the base server and the reception terminal;

FIG. 31 is a diagram illustrating an example of a halfway exit screen displayed on the reception terminal;

FIG. 32 is a sequence chart illustrating an example of processing relating to halfway exit performed between the base server and the reception terminal;

FIG. 33 is a sequence chart illustrating an example of processing relating to entrance cancellation performed between the base server and the reception terminal;

FIG. 34 is a diagram illustrating an example of a number of users addition screen displayed on the reception terminal;

FIG. 35 is a sequence chart illustrating an example of processing relating to halfway entrance performed between the base server and the reception terminal;

FIG. 36 is a diagram illustrating an example of a service time setting screen displayed on the reception terminal;

FIG. 37 is a sequence chart illustrating an example of processing relating to grant of a service time performed between the base server and the reception terminal;

FIG. 38 is a diagram illustrating an example of a complaint registration screen displayed on the reception terminal;

FIG. 39 is a sequence chart illustrating an example of processing relating to registration of a complaint performed between the base server and the reception terminal;

FIG. 40 is a diagram illustrating an example of a complaint reception screen displayed on a store clerk terminal in the embodiment;

FIG. 41 is a diagram illustrating an example of a moving destination selection screen displayed on the reception terminal;

FIG. 42 is a sequence chart illustrating an example of processing relating to room movement of a karaoke box performed between the base server and the reception terminal;

FIG. 43 is a diagram illustrating an example of a checkout screen displayed on the reception terminal;

FIG. 44 is a sequence chart illustrating an example of check-out processing performed between the base server and the reception terminal;

FIG. 45 is a diagram illustrating an example of a cleaning start screen displayed on the reception terminal;

FIG. 46 is a diagram illustrating an example of a cleaning completion screen displayed on the reception terminal;

FIG. 47 is a sequence chart illustrating an example of processing relating to cleaning management performed between the base server and the reception terminal;

FIG. 48 is a diagram illustrating an example of an operation situation screen displayed on the reception terminal;

FIG. 49 is a diagram illustrating another example of the operation situation screen;

FIG. 50 is a diagram illustrating an example of a report by room screen displayed on the reception terminal;

FIG. 51 is a diagram illustrating an example of a cleaning report by person in charge screen displayed on the reception terminal;

FIG. 52 is a sequence chart illustrating an example of processing relating to display of an operation situation performed between the base server and the reception terminal;

FIG. 53 is a diagram illustrating an example of a room booking screen displayed on the terminal for external sales;

FIG. 54 is a sequence chart illustrating an example of processing relating to room booking of a karaoke box performed between the base server and the terminal for external sales; and

FIG. 55 is a sequence chart illustrating an example of an alert processing unit of the base server.

### DETAILED DESCRIPTION

An aspect of embodiments is to provide a job support device and a job support method capable of managing a use situation of a facility for each user.

A job support device according to an embodiment includes: a check-in unit configured to, if receiving an instruction to start use of a facility, store, in correlation with a facility identifier capable of identifying the facility, in a storage unit, a user identifier of a user who uses the facility and a date and time when the user started the use; a halfway entrance unit configured to, if halfway entrance of a user is indicated to the facility being used, store, in correlation with the facility identifier of the facility, in the storage unit, a user identifier of the user who enters the facility halfway and a date and time of the halfway entrance; and a check-out unit configured to, if receiving an instruction to end the use of the facility, calculate a use charge of the facility based on a use time of the facility of each of the user identifiers correlated with the facility identifier of the facility.

An embodiment is explained below with reference to the drawings. In the embodiment explained below, an example of application to a karaoke box store (hereinafter simply referred to as store as well) is explained. However, this embodiment is not limiting. Examples of any time based business can employ the job support device described herein, also include gyms, music/recording studios, modeling studios, virtual reality environments, massage parlors, arts and crafts studios, golf driving ranges, laser tag chambers, gun ranges, hotels, machine rental facilities, and the like.

In the present embodiment, the karaoke box store is a store including one or more facilities for enjoying karaoke, so-called karaoke boxes. Specific room IDs are respectively set in the karaoke boxes. The room IDs are series of room numbers or the like set in order to individually identify the karaoke boxes.

### [Explanation of a Facility Management System]

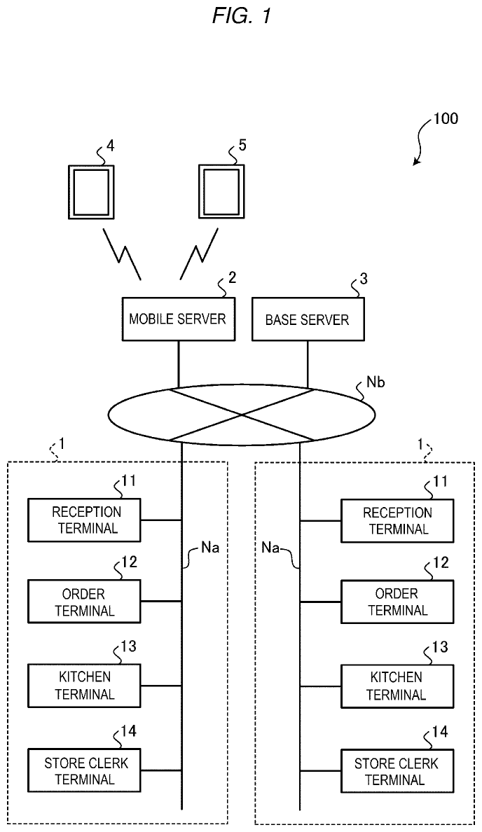

FIG. 1 is a diagram illustrating an example of a configuration of a facility management system 100. The facility management system 100 includes a plurality of store systems 1, a mobile server 2, a base server 3, a user terminal 4, and a terminal for external sales 5. The store system 1 is a common system provided in stores that respectively expand as chains. The store system 1 includes a reception terminal 11, an order terminal 12, a kitchen terminal 13, and a store clerk terminal 14.

Here, the facility management system 100 is an example of a job support device in the present embodiment. At least a part of various terminals included in the facility management system 100 (the reception terminal 11 and the order terminal 12 (explained below) of the store system 1, the base server 3, the user terminal 4, and the terminal for external sales 5) implements functional units included in the job support device.

The reception terminal 11, the order terminal 12, the kitchen terminal 13, and the store clerk terminal 14 are communicably connected via a first network Na. The first network Na is a network such as a LAN (Local Area Network) provided in the store. The LAN may be a wired LAN or may be a wireless LAN. The first network Na is communicably connected to a second network Nb explained below via communication equipment such as a not-illustrated router.

### [Reception Terminal]

The reception terminal 11 is installed at a reception of the store. The reception of the store is a place where a user stops by before entering a karaoke box or if exiting the karaoke box. The reception is referred to as front desk as well.

The reception terminal 11 receives entrance into the karaoke box, so-called check-in. Specifically, the reception terminal 11 receives input of check-in information necessary if the user uses the karaoke box. The check-in information includes, for example, a room ID of the karaoke box to be used, information concerning the user who uses the karaoke box such as a member ID, an entrance date and time, a use scheduled time, a room course, and an option course (hereinafter simply referred to as option).

The room ID is unique identification information allocated to each of a plurality of karaoke boxes included in the store in order to individually identify the karaoke boxes. The member ID is unique identification information allocated to a user having a membership agreement with the store, a so-called member. The user performs member registration by installing application software exclusive for the store, a so-called store application in the user terminal 4 such as a smartphone or a tablet terminal carried by the user. The user performs the member registration to be a member. A member ID specific to the user is allocated to the user. The member ID is displayed in a form of a machine-readable code symbol such as a barcode or a two-dimensional code on a screen of the user terminal 4 by starting the store application.

The entrance date and time is a date and time when the user checked in to start use of the karaoke box. The use scheduled time indicates a time when the user is scheduled to use the karaoke box. The room course is a course menu relating to use of the karaoke box. Examples of the room course include a charge plan for, for example, setting a room charge of the karaoke box to a fixed amount for predetermined time. The option is a course menu relating to foods and beverages. Examples of the option include a drink bar and a one-drink system. Note that the room course may include the option.

The reception terminal 11 receives exit from the karaoke box, so-called check-out. Specifically, the reception terminal 11 receives input of check-out information necessary if the user exits the karaoke box. The check-out information includes, for example, information capable of specifying a room ID of the karaoke box used by the user. The reception terminal 11 executes checkout of a charge involved in the use of the karaoke box. It is assumed that the reception terminal 11 corresponds to various payment methods such as cash, a credit card, electronic money, and code settlement. However, the reception terminal 11 may correspond to any one kind of the payment methods.

The reception terminal 11 cooperates with the base server 3 to execute processing relating to the check-in and the check-out explained above.

Note that, in the present embodiment, a form in which an employee of the store operates the reception terminal 11 is explained. However, not only this, but the reception terminal 11 may be a facing-type terminal that the store clerk and the user can operate or may be a self-service-type terminal that the user operates by himself or herself.

The reception terminal 11 may exclusively perform processing relating to the check-in. A reception device that exclusively performs processing relating to the check-out (hereinafter referred to as checkout terminal) may be separately provided. In this case, the reception terminal 11 that exclusively performs the processing relating to the check-in can be referred to as registration terminal, POS (Point Of Sales), or the like as well. The checkout terminal can also be referred to as settlement terminal, POS terminal, or the like as well.

### [Order Terminal]

The order terminal 12 is a terminal device that the user uses if the user orders a commodity in the karaoke box. The order terminal 12 is a terminal device such as a tablet PC installed in each of the karaoke boxes. The user selects a commodity that the user desires to order out of a commodity menu list displayed on the touch panel of the order terminal 12 and inputs a quantity. Accordingly, order data of the user is transmitted to the base server 3 together with the store ID of the store, a room ID of the karaoke box, and the like and notified to the kitchen terminal 13 of the same store via the base server 3.

Note that the order terminal 12 may be a handy terminal carried by the employee and having a function of inputting order content of a commodity received from the user. The user can use the user terminal 4 as an order terminal by installing application software exclusive for the store in the user terminal 4 carried by the user and inputting an ID of the application software, for example, a member code to the user terminal 4 at the time of entrance.

### [Kitchen Terminal]

The kitchen terminal 13 is equipment for outputting information concerning commodities (food and beverage menu items) ordered by the user of the karaoke box. As the kitchen terminal 13, there is a kitchen terminal of a type that outputs the information concerning the food and beverage menu items by displaying the information on a display device and a kitchen terminal of a type that outputs the information concerning the food and beverage menu items by printing the information on recording paper with a printer. In general, the kitchen terminal 13 is installed in a kitchen of the store where cooking and the like of the food and beverage menu items are performed. A person in charge of the kitchen grasps, with the information output from the kitchen terminal 13, the food and beverage menu item ordered by the user of the karaoke box, prepares the food and beverage menu item, and provides the food and beverage menu item to the user.

### [Store Clerk Terminal]

The store clerk terminal 14 is a terminal device that the employee of the store operates. The store clerk terminal 14 is implemented by a mobile terminal such as a smartphone or a tablet terminal and carried by the employee. The employee of the store can check, via the store clerk terminal 14, a state of the karaoke box and various alerts transmitted from the base server 3.

The facility management system 100 connects each of the store systems 1 explained above, the mobile server 2, and the base server 3 via the second network Nb. The second network Nb is a wide area network such as the Internet or an Intranet, a mobile communication network, or the like.

### [Mobile Server]

The mobile server 2 provides a bidirectional data communication service with the user terminal 4, the terminal for external sales 5, and the like. The mobile server 2 provides the data communication service using a short-range wireless communication network such as WiFi (registered trademark), a mobile communication network, or the like.

### [Base Server]

The base server 3 is a server device that performs operation support for stores where the store systems 1 are provided. The base server 3 manages states of the karaoke boxes provided in the stores and performs support relating to use and operation of the karaoke boxes. Note that the base server 3 may be a base server that provides a service under an on-premise environment or may be a base server that provides a service under a cloud computing environment.

### [User Terminal]

The user terminal 4 is a terminal device carried by the user who uses the karaoke box. The user terminal 4 is implemented by a mobile terminal such as a smartphone or a tablet terminal and carried by the user. By operating the user terminal 4, the user can, for example, make a use reservation at a desired store and order a commodity in a store that the user entered.

### [Terminal for External Sales]

The terminal for external sales 5 is a terminal device operated by an employee who goes out of the store and induces pedestrians and the like to use the store (hereinafter referred to as external salesperson as well). In general, in a store, in a state in which there are many vacant rooms of karaoke boxes, an employee of the store and a person in charge of an area to which the store belongs go to a busy street or the like in the neighborhood and perform an external sales activity for inducing pedestrians and the like to use the store. It is assumed that the terminal for external sales 5 is used in such an external sales activity.

The terminal for external sales 5 is implemented by a mobile terminal such as a smartphone or a tablet terminal and carried by the external salesperson. The terminal for external sales 5 can display a reservation situation of the karaoke box and make a use reservation of the karaoke box for an induced user by cooperating with the base server 3. In the following explanation, the use reservation of the karaoke box performed by the external salesperson is referred to as “room booking” as well.

Configurations of main devices among the devices included in the facility management system 100 explained above are explained below.

### [Hardware Components of the Base Server]

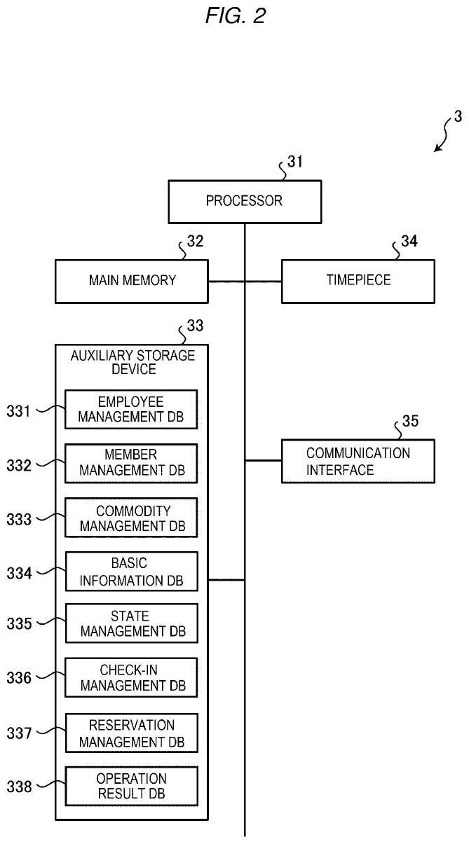

FIG. 2 is a diagram illustrating an example of hardware components of the base server 3. As illustrated in FIG. 2, the base server 3 includes a processor 31, a main memory 32, an auxiliary storage device 33, a timepiece 34, and a communication interface 35.

The processor 31 is equivalent to a central part of a computer. The processor 31 controls the units in order to implement various functions of the base server 3 according to an operating system or application programs. The processor 31 is, for example, a CPU (Central Processing Unit). The processor 31 is preferably a multicore processor including a plurality of processor cores and capable of executing a plurality of kinds of processing in parallel.

The main memory 32 is equivalent to a main storage part of the computer. The main memory 32 includes a nonvolatile memory region and a volatile memory region. The main memory 32 stores the operating system or the application programs in the nonvolatile memory region. The main memory 32 sometimes stores, in the nonvolatile or volatile memory region, data necessary for the processor 31 in executing processing for controlling the units. The main memory 32 uses the volatile memory region as a work area where data is rewritten as appropriate by the processor 31. The nonvolatile memory region is, for example, a ROM (Read Only Memory). The volatile memory region is, for example, a RAM (Random Access Memory).

The auxiliary storage device 33 is equivalent to an auxiliary storage part of the computer. For example, an EEPROM, a HDD (Hard Disk Drive), or an SSD (Solid State Drive) can be the auxiliary storage device 33. The auxiliary storage device 33 stores various application programs executable by the processor 31, setting information relating to the execution of the application programs, and the like. The auxiliary storage device 33 stores data used by the processor 31 in performing various kinds of processing, various database (DBs) explained below, data generated by the processing in the processor 31, and the like.

The timepiece 34 tracks a date and time. The processor 31 processes, as a present date and time, the date and the time tracked by the timepiece 34.

The communication interface 35 is a communication device connectable to the second network Nb. The communication interface 35 performs data communication with an external device via the second network Nb.

The processor 31 is connected to the units via a system transmission line. The system transmission line includes an address bus, a data bus, and a control signal line. In the base server 3, the processor 31 and the main memory 32, the auxiliary storage device 33, the timepiece 34, and the communication interface 35 are connected via the system transmission line to configure a computer.

The base server 3 in the present embodiment retains, in the auxiliary storage device 33, an employee management DB 331, a member management DB 332, a commodity management DB 333, a basic information DB 334, a state management DB 335, a check-in management DB 336, a reservation management DB 337, an operation result DB 338, and the like.

### [Employee Management DB]

The employee management DB 331 is a database for managing employees relating to operations of stores. The employee management DB 331 stores employee information such as passwords, names, belonging stores, authorities, and terminal addresses, for example, in correlation with employee IDs of the employees.

The employee ID is an example of identification information capable of identifying each of the employees. The password is information for collation in performing authentication for the employee. For example, a store ID capable of identifying a store to which the employee belongs is stored in the belonging store. Note that a store registrable in the belonging store is not limited to one store and a plurality of stores may be registered. For example, in the case of a person in charge of an area where a plurality of stores are present, store IDs of the plurality of stores are registered.

The name is information indicating a name of the employee corresponding to the employee ID. In the authority, information indicating a range of actions that the employee can perform is registered. For example, in the authority, a range of data referable in the store system 1 and a range of processing executable in the store system 1 are registered. If an authority is determined for each of attributes of the employee such as a post or a department, the attribute of the employee may be registered in the item of the authority. In the terminal address, addresses of the store clerk terminal 14 and the terminal for external sales 5 carried by the employee corresponding to the employee ID are registered. The addresses are identifiers in performing communication. For example, a host name, an IP address, or an MMS (multimedia messaging service) account can be used. If application software for cooperating with the base server 3 is installed in the store clerk terminal 14 and the terminal for external sales 5 and an ID of the application software, for example, the employee ID is input at an operation start time, the employee ID can also be used as the address.

### [Member Management DB]

The member management DB 332 is a database for managing information concerning users registered as use members of the store, so-called members. The member management DB 332 stores member information such as a name, an age, a contact, a rank, and coupon information in correlation with, for example, member IDs of the members.

The member IDs are an example of identification information respectively allocated to the members. The name and the age are information indicating a name and an age of a member corresponding to the member ID. For example, a member card recording a member code is issued to a user who became a member. Alternatively, the member code is displayed in a form of a machine-readable code symbol such as a barcode or a two-dimensional code on a display device of a smartphone or the like of the user by dedicated application software installed in the smartphone or the like.

A telephone number or the like of the user terminal 4 carried by the member is registered in the contact. The rank is information indicating relative positioning among members. The rank is preferably determined according to, for example, the number of times of use, a use frequency, and the like of a karaoke box store and a contribution degree and the like of the member to the store. In the store, for example, a service (a price-cut, a discount, or the like) corresponding to the rank can be granted to the member.

The coupon information is service information for receiving a service such as a price-cut (or a discount) distributed to the user in advance. If the coupon information is applied at a checkout time, a discount service corresponding to content of the coupon information is applied.

### [Commodity Management DB]

The commodity management DB 333 is a database that stores data concerning commodities that can be provided to users of the karaoke box. The commodity management DB 333 stores data concerning commodities such as a name, a price, a commodity image, a segment, and a restriction in correlation with, for example, commodity IDs of the commodities.

The commodity ID is an example of identification information respectively allocated to the commodities. Examples of the commodities include foods, beverages, cooked products, and cigarettes. Pay rental articles such as luminaires, musical instruments, and acoustic equipment also belong to the commodities. For example, a room course and an option may also be stored in the commodity management DB 333 as commodities.

The name is information indicating a name of a commodity. The price is information indicating a price of the commodity. The commodity image is image data such as an image or an illustration representing the commodity. In the segment, segment information indicating segments segmented according to categories or the like of commodities is registered. For example, the commodity is segmented into a recommended commodity, a lunch, a salad, a dessert, a drink, others, and the like.

The restriction specifies a restriction relating to provision of a commodity. For example, a restriction for disallowing provision to minors is added to commodities such as cigarettes and alcoholic beverages. If a commodity is a room course or an option, a restriction for disallowing provision to minors is also added if provision of alcoholic beverages is included in the commodity.

Note that information stored by the commodity management DB 333 is not limited to the examples explained above. For example, an amount of the price-cut or the discount or a condition for performing the price-cut or the discount (for example, whether a user is a member) may be stored in correlation with the commodity ID. The commodity management DB 333 may be provided for each of store IDs. Accordingly, a menu of commodities can be varied for each of stores.

### [Basic Information DB]

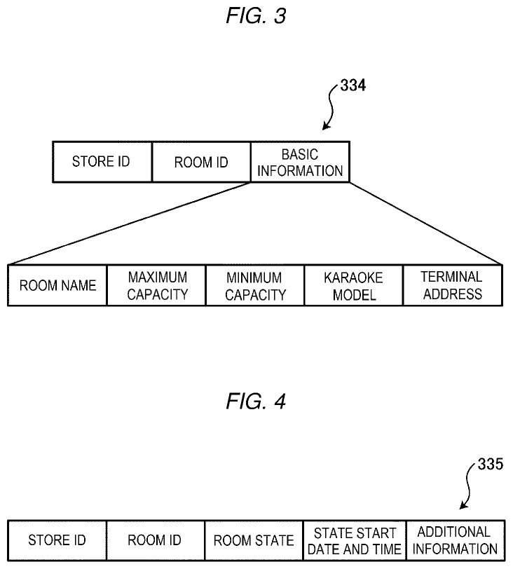

The basic information DB 334 is a database that stores basic information concerning karaoke boxes provided in each of stores. FIG. 3 is a diagram illustrating an example of a data configuration of the basic information DB 334. As illustrated in FIG. 3, the basic information DB 334 stores a store ID, a room ID, and basic information in correlation.

The store ID is identification information capable of identifying each the room of stores. The ID is identification information capable of identifying each of karaoke boxes provided in the store corresponding to the store ID. The basic information includes information such as specifications of the karaoke box corresponding to the room ID. For example, the basic information includes a room name, a maximum capacity, a minimum capacity, a karaoke model, a terminal address, and information (names and identification information) of equipment provided in a room of the karaoke box.

The maximum capacity is information indicating an upper limit value of the number of users who can be accommodated in the karaoke box. The minimum capacity is information indicating a lower limit value of the number of users who can be accommodated in the karaoke box. The karaoke model is information indicating a model name, a brand name, or the like of a karaoke device installed in the karaoke box. The terminal address is an address of the order terminal 12 provided in the karaoke box.

Note that a data configuration of the basic information is not limited to the example illustrated in FIG. 3. For example, the basic information may include setting of a use fee per unit time, extension possibility of a use time, and the like.

### [State Management DB]

The state management DB 335 is a database for managing a current state of a karaoke box provided in each of stores. FIG. 4 is a diagram illustrating an example of a data configuration of the state management DB 335. As illustrated in FIG. 4, the state management DB 335 includes a store ID, a room ID, a room state, a state start date and time, and additional information in correlation.

The room state indicates a current state of the karaoke box corresponding to the room ID. Examples of the state of the karaoke box include “vacant”, “staying”, “waiting for cleaning”, “cleaning”, and “out of order”.

The “vacant” indicates that the karaoke box is in a usable state. The “staying” indicates a state in which the karaoke box is used by a user. The “waiting for cleaning” indicates a state before cleaning is performed after the karaoke box is used. The “cleaning” indicates a state in which cleaning of the karaoke box is performed. The “out of order” indicates a state in which the karaoke box cannot be used because of a malfunction of karaoke equipment or the like.

In the state start date and time, a date and time when the karaoke box was switched to the state is registered. In the additional information, additional information incidental to the room state is registered. For example, in the additional information of the state “out of order”, a failure reason, comment content input by an employee, and the like are registered.

### [Check-In Management DB]

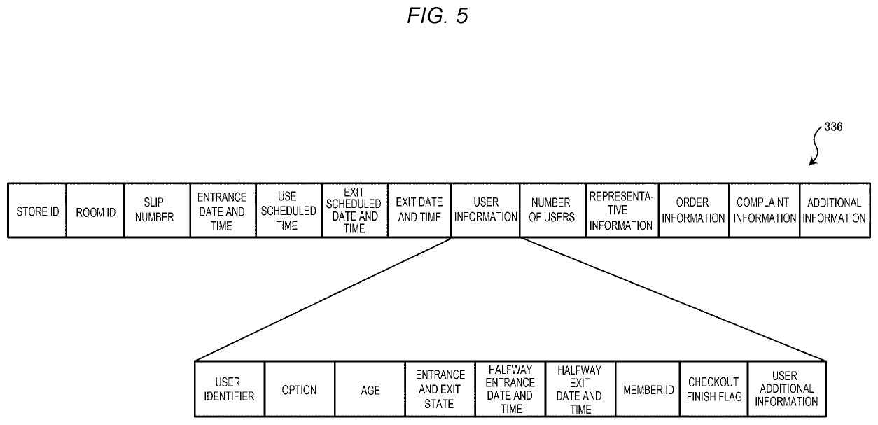

The check-in management DB 336 is a database that stores information concerning a karaoke box in a state of being used and a user using the karaoke box. FIG. 5 is a diagram illustrating an example of a data configuration of the check-in management DB 336. As illustrated in FIG. 5, the check-in management DB 336 stores a store ID, a room ID, a slip number, an entrance date and time, a use scheduled time, an exit scheduled time, an exit date and time, user information, the number of users, representative information, order information, complaint information, additional information, and the like in correlation.

The slip number is a number issued at the time of use start (check-in) of the karaoke box. The slip number is an example of a management number capable of uniquely specifying a transaction relating to the use of the karaoke box. The entrance date and time (a use start date and time) is information indicating a date and time when the use of the karaoke box was started. The use scheduled time is information indicating a time length in which the karaoke box is scheduled to be used. The exit scheduled date and time is a date and time obtained by adding the use scheduled time to the entrance date and time. The exit date and time is information indicating a date and time when the user actually exited, that is, a date and time when the user finished the use of the karaoke box.

The user information retains information concerning each of users who use the karaoke box corresponding to the room ID. For example, the user information retains a user identifier, an option, an age, an entrance and exit state, a halfway entrance date and time, a halfway exit date and time, a member ID, a checkout finish flag, user additional information, and the like.

The user identifier is identification information capable of identifying each of users who entered the same karaoke box. The user identifier is an identifier such as a serial number capable of identifying the user. The option is information indicating a type of an option selected by the user. The age is information indicating a birthday or an age category of the user corresponding to the user identifier.

The entrance and exit state is information indicating an entrance and exit state of the user. Examples of the entrance and exit state include “staying”, “halfway entered”, “halfway exited”, “and “entrance cancelled”. The “staying” indicates that a state of staying in the karaoke box and means that the user entered the karaoke box at the entrance date and time explained above. The “halfway entered” indicates a state of having entered the karaoke box halfway and means that the user entered the karaoke box at or after the entrance date and time explained above. The “halfway exited” indicates that a state of having exited the karaoke box halfway and is a state given if exit operation was performed in a state in which an “staying” user remains.

The “entrance cancelled” indicates that the user was cancelled and is, for example, a state given if cancellation operation for entrance was performed because of a mistake of number of users selection. The user in the state of the “entrance cancelled” is treated as having not entered from the beginning and is excluded from a target of a use amount.

The halfway entrance date and time is information indicating a date and time when the user entered the karaoke box halfway. The halfway entrance means that an additional user enters the karaoke box halfway in a state in which a user having entered in the karaoke box is present. The halfway exit date and time is information indicating a date and time when the user exited the karaoke box halfway. The halfway exit means that the user exits the karaoke box halfway in a state in which a user staying in the karaoke box is present.

In the member ID, if the user is a member, a member ID of the user is registered. The checkout finish flag is flag information indicating whether the user corresponding to the user identifier finished checkout. The user for whom the checkout finish flag is set to checkout finished is treated as having paid a use amount. Note that it is assumed that, in an initial state of the checkout finish flag, a not-checked out state is set.

In the user additional information, additional information concerning users is registered. For example, if an identification card was checked for age verification of the user in check-in, information indicating a type of the identification card (a driver's license, a student identification card, or the like) used for the age verification is registered in the user additional information. For example, if the user is a nonmember, a contact (a telephone number or the like) of the user is registered in the user additional information.

The number of users is information indicating the number of users registered in the user information, that is, the number of user identifiers. The number of remaining identifiers excluding a user identifier for which the entrance and exit state is the “entrance cancelled” among the user identifiers registered in the user information is the number of users. The number of users of the karaoke box may be the number of the remaining user identifiers excluding user identifiers for which the entrance and exit state is the “entrance cancelled” and the “halfway exited”. Note that, a user identifier for which the checkout finish flag is the “not checked-out” even if the entrance and exit state is the “halfway exited” may be included in the number of users.

In the representative information, information concerning a representative user among the users included in the user information is registered. For example, if the representative user is a member, a user identifier or a member ID of the user is registered in the representative information. For example, if the representative user is a nonmember, a user identifier of the user is registered in the representative information.

In the order information, information capable of specifying a commodity ordered by the user is registered. For example, in the order information, information indicating a type of a room course is registered. For example, in the order information, information capable of specifying a commodity such as a food and beverage ordered by the user of the karaoke box is registered.

In the complaint information, complaint information indicating a complaint such as an opinion, a demand, or a complaint received from the user of the karaoke box is registered. For example, in the complaint information, complaint content, a comment of an employee, a registration date and time, and the like are registered.

In the additional information, additional information concerning use of the karaoke box is stored. For example, in the additional information, if extension of a use time is provided from the store as a free-of-charge service, a service time indicating the extension time is stored in the additional information.

### [Reservation Management DB]

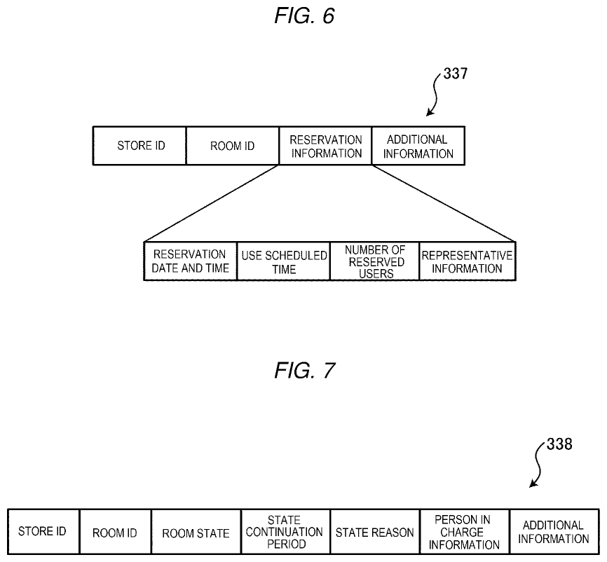

The reservation management DB 337 is a database for managing a use reservation for a karaoke box. FIG. 6 is a diagram illustrating an example of a data configuration of the reservation management DB 337. As illustrated in FIG. 6, the reservation management DB 337 stores a store ID, a room ID, reservation information, and additional information in correlation.

The reservation information includes, for example, a reservation date and time, a use scheduled time, the number of reserved users, and representative information. The reservation date and time is information indicating a scheduled date and time of using the karaoke box. The use scheduled time is information indicating a scheduled time length of using the karaoke box. The number of reserved users is information indicating a number of users scheduled to use the karaoke box. The representative information is information indicating a representative user and is, for example, a member ID or a name of a user who made a reservation.

In the additional information, additional information concerning a use reservation for the karaoke box is registered. For example, in the additional information, information indicating a date and time when a reservation was made (hereinafter referred to as reservation reception date and time as well) is registered. In the case of a use reservation made by an external salesperson (hereinafter referred to as “room booking” as well), in the additional information, information capable of identifying the reservation by the external salesperson such as an employee ID of the external salesperson who made the room booking is registered. In the additional information, information concerning a use amount exchanged between the external salesperson and a customer, a notice from the external salesperson to an employee of the store, and the like are registered.

### [Operation Result DB]

The operation result DB 338 is a database for managing an operation result of a karaoke box. FIG. 7 is a diagram illustrating an example of a data configuration of the operation result DB 338. As illustrated in FIG. 7, the operation result DB 338 stores a store ID, a room ID, a room state, a state continuation time, a state reason and person in charge information, additional information, and the like in correlation.

The room state is information indicating a state of the karaoke box corresponding to the room ID. The state continuation period is information indicating a period in which the state of the karaoke box continued. For example, in the state continuation period, a start date and time and an end date and time of the state, a continuation time of the state, and the like are registered.

In the state reason, for example, a reason why the karaoke box is in a state indicated by the room state is registered. For example, a name of broken equipment, a reason why the karaoke box cannot be used, and the like are registered for the karaoke box in a state such as “out of order”.

In the person in charge information, an operator who instructed to switch the karaoke box to the state indicated by the room state and information capable of specifying an employee who performs work incidental to the state are registered. For example, if the karaoke box is in the “cleaning”, a name, an employee ID, and the like of an employee in charge of cleaning are registered in the person in charge information.

In the additional information, additional information relating to the room state is registered. For example, a notice to the other employees is registered for the karaoke box in the state such as “out of order”. For example, if return to cleaning for returning the state of “vacant” to the state of “cleaning” is performed, for example, a reason for returning the karaoke box to cleaning is registered.

Note that DBs retained by the base server 3 are not limited to the examples explained above. For example, the base server 3 may retain a store management DB that stores, in correlation with store IDs of stores, chain names and addresses of the stores, addresses of terminals provided in the stores, and the like. For example, the base server 3 may retain, in the auxiliary storage device 113, a charge DB specifying a use charge of the karaoke box. The charge DB stores, for example, in correlation with a store ID and a room ID, for example, a use charge per unit time of a karaoke box corresponding to the room ID. The charge DB stores use charges and discount amounts in the case in which a user is a member and a nonmember, discount amounts corresponding to ranks of a member, and use charges, discount amounts, and the like in the case in which a user is a student and a nonstudent.

### [Hardware Components of a Reception Terminal]

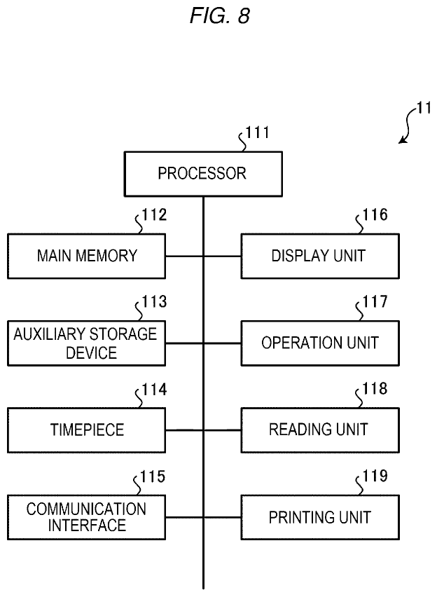

FIG. 8 is a diagram illustrating an example of hardware components of the reception terminal 11. The reception terminal 11 includes a processor 111, a main memory 112, an auxiliary storage device 113, a timepiece 114, a communication interface 115, a display unit 116, an operation unit 117, a reading unit 118, and a printing unit 119.

The processor 111 is equivalent to a central part of a computer. The processor 111 controls the units in order to implement various functions of the reception terminal 11 according to an operating system or application programs. The processor 111 is, for example, a CPU. The processor 111 is preferably a multicore processor including a plurality of processor cores and capable of executing a plurality of kinds of processing in parallel.

The main memory 112 is equivalent to a main storage part of the computer. The main memory 112 includes a nonvolatile memory region and a volatile memory region. The main memory 112 stores the operating system or the application programs in the nonvolatile memory region. The main memory 112 sometimes stores, in the nonvolatile or volatile memory region, data necessary for the processor 111 in executing processing for controlling the units. The main memory 112 uses the volatile memory region as a work area where data is rewritten as appropriate by the processor 111. The nonvolatile memory region is, for example, a ROM. The volatile memory region is, for example, a RAM.

The auxiliary storage device 113 is equivalent to an auxiliary storage part of the computer. For example, an EEPROM, a HDD, or an SSD can be the auxiliary storage device 113. The auxiliary storage device 113 stores various application programs executable by the processor 111, setting information relating to the execution of the application programs, and the like. The auxiliary storage device 113 stores data used by the processor 111 in executing various kinds of processing, data generated by the processing in the processor 111, and the like.

The timepiece 114 tracks a date and time. The processor 111 processes, as a present date and time, the date and the time tracked by the timepiece 114.

The communication interface 115 is a communication device connectable to the first network Na. The communication interface 115 performs data communication with an external device via the first network Na.

The display unit 116 is a display device such as an LCD (Liquid Crystal Display). The display unit 116 displays various kinds of information under the control of the processor 111. The operation unit 117 is an input device such as a keyboard or a pointing device. The operation unit 117 outputs, to the processor 111, operation content input via the input device. Note that the operation unit 117 may be a touch panel provided in the display unit 116.

The reading unit 118 is a reading device that reads information from a medium that retains information. For example, the reading unit 118 is a code scanner that reads information from a code symbol such as a barcode or a two-dimensional code or is a digital camera. For example, the reading unit 118 is a magnetic card reader that reads information from a card medium such as a magnetic card. The printing unit 119 is a printing device such as a thermal printer.

The processor 111 is connected to the units via a system transmission line. The system transmission line includes an address bus, a data bus, and a control signal line. In the reception terminal 11, the processor 111 and the main memory 112, the auxiliary storage device 113, the timepiece 114, the communication interface 115, and the like are connected by the system transmission line to configure a computer.

### [Hardware Components of the Terminal for External Sales]

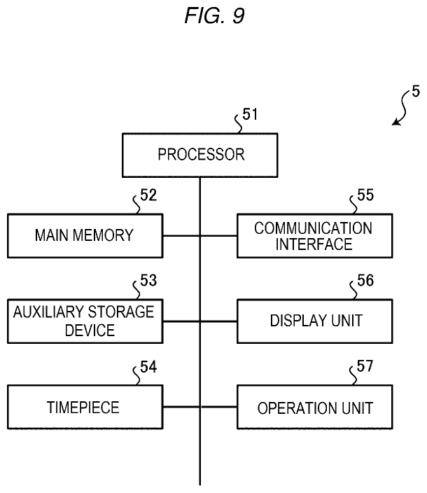

FIG. 9 is a diagram illustrating an example of hardware components of the terminal: for external sales 5. The terminal for external sales 5 includes a processor 51, a main memory 52, an auxiliary storage device 53, a timepiece 54, a communication interface 55, a display unit 56, and an operation unit 57.

The processor 51 is equivalent to a central part of a computer. The processor 51 controls the units in order to implement various functions of the terminal for external sales 5 according to an operating system or application programs. The processor 51 is, for example, a CPU. The processor 51 is preferably a multicore processor including a plurality of processor cores and capable of executing a plurality of kinds of processing in parallel.

The main memory 52 is equivalent to a main storage part of the computer. The main memory 52 includes a nonvolatile memory region and a volatile memory region. The main memory 52 stores the operating system or the application programs in the nonvolatile memory region. The main memory 52 sometimes stores, in the nonvolatile or volatile memory region, data necessary for the processor 51 in executing processing for controlling the units. The main memory 52 uses the volatile memory region as a work area where data is rewritten as appropriate by the processor 51. The nonvolatile memory region is, for example, a ROM. The volatile memory region is, for example, a RAM.

The auxiliary storage device 53 is equivalent to an auxiliary storage part of the computer. For example, an EEPROM, a HDD, or an SSD can be the auxiliary storage device 53. The auxiliary storage device 53 stores various application programs executable by the processor 51, setting information relating to the execution of the application programs, and the like. The auxiliary storage device 53 stores data used by the processor 51 in performing various kinds of processing, data generated by the processing in the processor 51, and the like.

The timepiece 54 tracks a date and time. The processor 51 processes, as a present date and time, the date and the time tracked by the timepiece 54.

The communication interface 55 is a communication device connectable to the second network Nb (or the first network Na). The communication interface 55 performs data communication with an external device via the second network Nb.

The display unit 56 is a display device such as an LCD (Liquid Crystal Display). The display unit 56 displays various kinds of information under the control of the processor 51. The operation unit 57 is an input device such as a keyboard or a pointing device. The operation unit 57 outputs, to the processor 51, operation content input via the input device. Note that the operation unit 57 may be a touch panel provided in the display unit 56.

The processor 51 is connected to the units via a system transmission line. The system transmission line includes an address bus, a data bus, and a control signal line. In the terminal for external sales 5, the processor 51 and the main memory 52, the auxiliary storage device 53, the timepiece 54, the communication interface 55, and the like are connected by the system transmission line to configure a computer.

Note that the store clerk terminal 14 includes, for example, the same hardware components as the hardware components of the terminal for external sales 5. The terminal for external sales 5 and the store clerk terminal 14 may be implemented by the same device.

### [Functional Components]

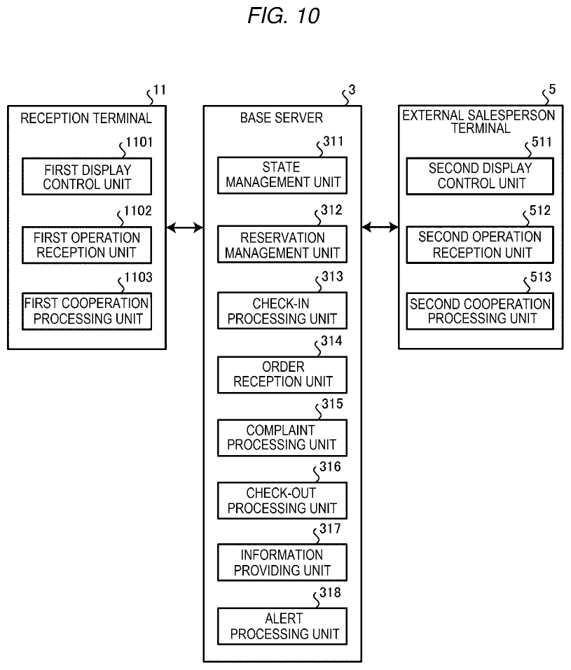

Subsequently, functional components included in the base server 3, the terminal for external sales 5, and the reception terminal 11 explained above are explained with reference to FIG. 10. FIG. 10 is a diagram illustrating an example of the functional components of the base server 3, the terminal for external sales 5, and the reception terminal 11.

### [Functional Components of the Base Server]

First, the functional components of the base server 3 are explained. As illustrated in FIG. 10, the base server 3 includes, as the functional components, a state management unit 311, a reservation management unit 312, a check-in processing unit 313, an order reception unit 314, a complaint processing unit 315, a check-out processing unit 316, an information provision unit 317, and an alert processing unit 318.

The functional components of the base server 3 may be software components implemented by cooperation of the processor 31 of the base server 3 and various programs stored in the nonvolatile memory region. The functional components of the base server 3 may be hardware components implemented by dedicated circuits and the like mounted on the base server 3.

### [State Management Unit]

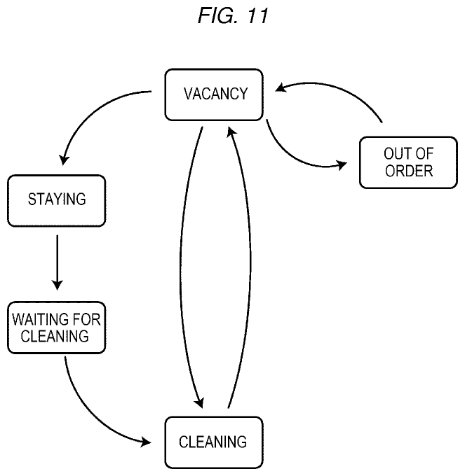

The state management unit 311 manages a state of the karaoke box. For example, the state management unit 311 manages states of karaoke boxes based on a predetermined karaoke box state transition rule. FIG. 11 is a state transition diagram illustrating an example of a karaoke box state transition rule.

In the state transition diagram of FIG. 11, a state of the “vacant” is a base point. If check-in processing is performed for a karaoke box in the state of the “vacant”, the state management unit 311 switches the state of the karaoke box to the “staying”. Specifically, if the state management unit 311 cooperates with the check-in processing unit 313 explained below to detect that a new data entry was registered in the check-in management DB 336, the state management unit 311 switches a room state of the state management DB 335 corresponding to a set of a store ID and a room ID included in the data entry from the “vacant” to the “staying”. The state management unit 311 registers an operation result of the karaoke box in the operation result DB 338 in correlation with the store ID and the room ID of the karaoke box, the state of which was switched.

Here, the state management unit 311 executes the following processing in the registration of the operation result. First, the state management unit 311 retrieves a data entry in which a room state is a state before switching and an end date and time of the state is blank from data entries of the operation result DB 338 relating to a set of the store ID and the room ID for which the room state was switched. The state management unit 311 registers the present date and time in an end date and time of the retrieved data entry. The state management unit 311 registers, in the operation result DB 338, the set of the store ID and the room ID for which the state was switched, a room state indicating a state after the switching, and a data entry in which the present date and time is set in a start date and time.

If check-out processing is performed for the karaoke box in the state of the “staying”, the state management unit 311 switches the state of the karaoke box to the “waiting for cleaning”. Specifically, if cooperating with the check-out processing unit 316 explained below to detect that a data entry is removed from the check-in management DB 336, the state management unit 311 switches a room state of the state management DB 335 corresponding to a set of a store ID and a room ID included in the data entry from the “staying” to the “waiting for cleaning”. The state management unit 311 registers an operation result of the karaoke box in the operation result DB 338 in correlation with the store ID and the room ID of the karaoke box, the state of which was switched.

If receiving a cleaning start instruction for the karaoke box that is in the state of the “waiting for cleaning”, the state management unit 311 switches the state of the karaoke box to the “cleaning”. Specifically, if receiving a cleaning start notification instructing a cleaning start for the karaoke box from the store system 1 (the reception terminal 11 or the store clerk terminal 14), the state management unit 311 specifies, from the state management DB 335, a data entry corresponding to a store ID and a room ID indicated by the cleaning start notification. Subsequently, the state management unit 311 switches a room state of the specified data entry from the “waiting for cleaning” to the “cleaning”. The state management unit 311 registers an operation result of the karaoke box in the operation result DB 338 in correlation with the store ID and the room ID of the karaoke box, the state of which was switched.

Note that, if an employee ID of an employee in charge of cleaning is included in the cleaning start notification, the state management unit 311 registers, in a person in charge information field of the operation result DB 338, the employee ID and a name of the employee corresponding to the employee ID.

If receiving a cleaning completion indication for the karaoke box that is in the state of the “cleaning”, the state management unit 311 switches the state of the karaoke box to the “vacant”. Specifically, if receiving a cleaning completion notification instructing cleaning completion for the karaoke box from the store system 1 (the reception terminal 11 or the store clerk terminal 14), the state management unit 311 specifies, from the state management DB 335, a data entry corresponding to a store ID and a room ID indicated by the cleaning completion notification. Subsequently, the state management unit 311 switches a room state of the specified data entry from the “cleaning” to the “vacant”. The state management unit 311 registers an operation result of the karaoke box in the operation result DB 338 in correlation with the store ID and the room ID of the karaoke box, the state of which was switched.

Note that, if the employee ID of the employee in charge of cleaning is included in the cleaning completion notification, the state management unit 311 registers, in the person in charge information field of the operation result DB 338, the employee ID and a name of the employee corresponding to the employee ID.

If receiving a return to cleaning instruction for the karaoke box that is in the state of the “vacant”, the state management unit 311 switches the state of the karaoke box to the “cleaning”. Specifically, if receiving, from the store system 1 (the reception terminal 11 or the store clerk terminal 14), a return to cleaning instruction instructing to return to the state of cleaning, the state management unit 311 specifies, from the state management DB 335, a data entry corresponding to a store ID and a room ID indicated by the return to cleaning instruction. Subsequently, the state management unit 311 switches a room state of the specified data entry from the “vacant” to the “cleaning”. The state management unit 311 registers an operation result of the karaoke box in the operation result DB 338 in correlation with the store ID and the room ID of the karaoke box, the state of which was switched.

Note that, if, for example, a reason for returning to the cleaning is included in the return to cleaning instruction, the state management unit 311 registers the reason in a state reason field and an additional information field of the operation result DB 338.

If receiving a failure occurrence notification for the karaoke box that is in the state of the “vacant”, the state management unit 311 switches the state of the karaoke box to the “out of order”. Specifically, if receiving, from the store system 1 (the reception terminal 11 or the store clerk terminal 14), a failure occurrence notification indicating that a failure occurred in the karaoke box, the state management unit 311 specifies, from the state management DB 335, a data entry corresponding to a store ID and a room ID indicated by the failure occurrence notification. Subsequently, the state management unit 311 switches a room state of the specified data entry from the “vacant” to the “out of order”. The state management unit 311 registers, in the operation result DB 338, an operation result of the karaoke box in correlation with the store ID and the room ID of the karaoke box, the state of which was switched.

Note that, if a failure reason, a comment, and the like are included in the failure occurrence notification, the state management unit 311 registers the failure reason and the comment in the state reason field and the additional information field of the operation result DB 338.

If receiving a repair completion indication for the karaoke box that is in the state of the “out of order”, the state management unit 311 switches the state of the karaoke box to the “vacant”. Specifically, if receiving, from the store system 1 (the reception terminal 11 or the store clerk terminal 14), a repair completion indication indicating that repair of the karaoke box was completed, the state management unit 311 specifies, from the state management DB 335, a data entry corresponding to a store ID and a room ID indicated by the repair completion indication. Subsequently, the state management unit 311 switches a room state of the specified data entry from the “out of order” to the “vacant”. The state management unit 311 registers, in the operation result DB 338, an operation result of the karaoke box in correlation with the store ID and the room ID of the karaoke box, the state of which was switched.

As explained above, the state management unit 311 switches the room state of the state management DB 335 according to a current state of the karaoke box. The state management unit 311 registers an operation result of the karaoke box in the operation result DB 338 according to the state switching of the karaoke box. Accordingly, the current state of the karaoke box is stored in the state management DB 335. Time-series state transition of the karaoke box is recorded in the operation result DB 338 as an operation result.

### [Reservation Management Unit]

Referring back to FIG. 10, the reservation management unit manages a use reservation for a karaoke box. Specifically, if receiving a reservation instruction including a set of a store ID and a room ID to be a reservation target and a reservation date and time from the store system 1, the user terminal 4, the terminal for external sales 5, or the like, the reservation management unit 312 registers reservation information such as the reservation date and time in the reservation management DB 337 in correlation with the indicated set of the store ID and the room ID.

The reservation management unit 312 manages the reservation information registered in the reservation management DB 337. Specifically, the reservation management unit 312 deletes, from the reservation management DB 337, a data entry relating to reservation information at a predetermined time (for example, fifteen minutes) elapsed from a reservation date and time.

### [Check-In Processing Unit]

The check-in processing unit 313 is an example of a check-in unit and a halfway entrance unit. The check-in processing unit 313 cooperates with the reception terminal 11 to execute processing relating to check-in of a user (hereinafter referred to as check-in processing as well). Specifically, if receiving check-in information indicating, for example, a set of a store ID and a room ID from the reception terminal 11, the check-in processing unit 313 issues a specific slip number and transmits the issued slip number to the reception terminal 11. The check-in processing unit 313 registers the indicated set of the store ID and the room ID, the issued slip number, and various kinds of information included in the check-in information in the check-in management DB 336 in correlation.

The check-in information includes a data element based on a data configuration of the check-in management DB 336. For example, the check-in information includes an entrance date and time, a use scheduled time, user information, and representative information. Note that, if registering the user information in the check-in management DB 336, the check-in processing unit 313 sets an entrance and exit state of users as the “staying” and registers the entrance date and time in an entrance date and time field of the users.

Note that the check-in processing unit 313 may determine usability of a karaoke box based on maximum capacities and minimum capacities of the karaoke boxes registered in the basic information DB 334 and the number of users who check in. For example, if the number of users exceeds a maximum capacity of the karaoke box indicated by the check-in information or if the number of users is less than a minimum capacity of the karaoke box, the check-in processing unit 313 determines that the karaoke box cannot be used. In this case, the check-in processing unit 313 may cooperate with the information provision unit 317 explained below to inform an operator of the reception terminal 11 that the karaoke box cannot be used.

If receiving a reading instruction for reservation information from the reception terminal 11, the check-in processing unit 313 reads reservation information indicated by the reading instruction from the reservation management DB 337 and executes check-in processing based on the read reservation information. Specifically, the check-in processing unit 313 executes, based on content registered in the reservation information, check-in processing for a karaoke box corresponding to a store ID and a room ID correlated with the reservation information. The check-in processing unit 313 deletes a data entry relating to the reservation information from the reservation management DB 337 according to the execution of the check-in processing based on the reservation information.

Note that the check-in processing unit 313 may narrow down, based on a date and time when the reading instruction for the reservation information was received, reservation information read from the reservation management DB 337. For example, the check-in processing unit 313 may be configured to, if receiving a reading instruction indicating a store ID and a room ID, read, from the reservation management DB 337, among reservation information corresponding to the condition, reservation information in which a reservation date and time is set within a predetermined time (for example, fifteen minutes) before and after a date and time when the reading instruction was received. Accordingly, even if a plurality of kinds of reservation information corresponding to the condition indicated by the reading instruction are present, the check-in processing unit 313 can perform the check-in processing using reservation information suitable for the present date and time.

The check-in processing unit 313 changes, according to a change instruction transmitted from the reception terminal 11, registration content of a data entry registered in the check-in management DB 336. Specifically, if receiving a change instruction designating a set of a store ID and a room ID, the check-in processing unit 313 specifies, from the check-in management DB 336, a data entry corresponding to a designated condition. Subsequently, the check-in processing unit 313 executes, based on the content indicated by the change instruction, processing for changing content of the data entry.

For example, if receiving a change instruction instructing to change a room ID, the check-in processing unit 313 changes a room ID included in a data entry corresponding to the change instruction to the room ID indicated by the change instruction. For example, if receiving a change instruction instructing to change a room course, the check-in processing unit 313 changes a room course included in a data entry corresponding to the change instruction to the room course indicated by the change instruction.

If receiving a change instruction indicating halfway entrance of a user (hereinafter referred to as halfway entrance instruction), the check-in processing unit 313 adds information concerning the user indicated by the halfway entrance indication to the user information of the check-in management DB 336. The check-in processing unit 313 sets an entrance and exit state of the added user to the “halfway entered” and registers a date and time indicated by the halfway entrance instruction in the halfway entrance date and time.

If receiving a change instruction indicating entrance cancelation of the user (hereinafter referred to as entrance cancellation instruction), the check-in processing unit 313 changes an entrance and exit state of the user indicated by the entrance cancellation instruction to the “entrance cancelled” from the user information of the check-in management DB 336.

### [Order Reception Unit]

The order reception unit 314 receives an order for a commodity from a user using a karaoke box and notifies received order content to, for example, the kitchen terminal 13 of a store where the karaoke box is placed. Specifically, if receiving, via the order terminal 12 or the like, an order instruction indicating an order target commodity from a user entering a karaoke box, the order reception unit 314 notifies order content to the kitchen terminal 13 of a store where the karaoke box is placed. The order reception unit 314 specifies, from the check-in management DB 336, a data entry relating to the karaoke box of the user who made the order and registers the order content in an order information field included in the data entry.

Note that the order reception unit 314 may determine possibility of the order based on restrictions of commodities registered in the commodity management DB 333, an age category of a user using a karaoke box, and the like. For example, if age categories of all users using a karaoke box are a minor, the order reception unit 314 determines that commodities such as alcoholic beverages and cigarettes cannot be ordered. In this case, the order reception unit 314 may cooperate with the information provision unit 317 explained below to provide a commodity menu of extracted orderable commodities to the users or, if an unorderable commodity is ordered, may inform the users that the users cannot order the commodity.

The order reception unit 314 may switch a notification destination of order content according to a type of an order target commodity. For example, if the order target commodity is a beverage or a cooked food, the order reception unit 314 may notify the kitchen terminal 13. If the order target commodity is a luminaire, a musical instrument, or the like, the order reception unit 314 may notify the store clerk terminal 14.

Concerning a commodity included in a room course or an option ordered at a check-in time, the order reception unit 314 may cooperate with the check-in processing unit 313 to notify the kitchen terminal 13 and the like.

The complaint processing unit 315 registers a complaint received from a user of a karaoke box and inform the complaint to an employee. Specifically, if receiving a complaint registration instruction instructing registration of complaint content or the like from the reception terminal 11, the complaint processing unit 315 specifies, from the check-in management DB 336, a data record relating to a karaoke box at a registration destination indicated by the complaint registration instruction. Then, the complaint processing unit 315 registers, for example, the complaint content indicated by the complaint registration instruction in a complaint information field of the specified data record.

If receiving the complaint registration instruction, the complaint processing unit 315 informs, for example, the complaint content indicated by the complaint registration instruction to the store clerk terminal 14 of a store at a transmission source.

Note that, in the present embodiment, it is assumed that the complaint registration instruction is transmitted from the reception terminal 11. However, not only this, but the complaint registration instruction may be transmitted from any device (the order terminal 12 or the store clerk terminal 14) of the store system 1 or the complaint registration instruction may be transmitted from the user terminal 4.

### [Check-Out Processing Unit]

The check-out processing unit 316 is an example of a halfway exit unit and a check-out unit. The check-out processing unit 316 cooperates with the reception terminal 11 to execute processing relating to check-out of a user (hereinafter referred as to check-out processing). Specifically, if receiving check-out information indicating a slip number from the reception terminal 11, the check-in processing unit 313 executes the check-out processing for a user of a karaoke box corresponding to the indicated condition.

In the check-out processing, the check-out processing unit 316 specifies, from the check-in management DB 336, a data entry corresponding to the condition designated by the checkout information and calculates a use amount of the karaoke box based on various kinds of information included in the specified data entry.

For example, if registering a date and time at a point in time when the check-out information was received in an exit date and time field of the specified data entry, the check-out processing unit 316 calculates a time length from an entrance date and time to an exit date and time (hereinafter referred to as use time as well). If a free time is set, in order to not charge for a time equivalent to the free time, the check-out processing unit 316 sets, as the use time, the remaining time obtained by subtracting a time equivalent to the free time. However, the check-out processing unit 316 secures a time specified by a room course or the like without subtracting the time.

Subsequently, the check-out processing unit 316 calculates a use charge of the karaoke box based on a use time calculated for each user (user identifier), a type of a room course, a type of an option, a price of a commodity registered in order information, various discount conditions for members and the like, and the like. The check-out processing unit 316 calculates a use charge for each user by, for example, dividing the use charge of the karaoke box by the number of users. However, a user identifier for which a checkout finish flag is the “checkout finished” and a user identifier for which an entrance and exit state is the “entrance cancelled” are excluded from a calculation target of the use charge.

Note that a method of calculating a use charge for each user is not limited to the above. The check-out processing unit 316 may calculate use charge more in detail for each user. For example, the check-out processing unit 316 may calculate the use charge for each user based on, for example, options correlated with user identifiers, a discount corresponding to an attribute of the user (a discount corresponding to, for example, whether the user is a member, an age category of the user, or whether the user is a student). Concerning a user identifier for which an entrance and exit state is the “halfway entered”, the check-out processing unit 316 may calculate the use charge based on a use time from a halfway entrance date and time to an exit date and time.

Subsequently, the check-out processing unit 316 transmits transaction data including the use charge of the karaoke box and the use charge for each user to the reception terminal 11 that transmitted the check-out information. Note that the check-out processing unit 316 may transmit the transaction data including a slip number and a part or all of data entries specified from the check-in management DB 336.

If receiving a checkout completion instruction indicating checkout completion from the reception terminal 11 to which the transaction data was transmitted, the check-out processing unit 316 sets check finish flags of users included in a data entry of the check-in management DB 336 relating to the transaction data to checkout finished. Then, the check-out processing unit 316 removes the data entry for which the checkout was completed from the check-n management DB 336 by, for example, moving the data entry to another DB.

If receiving, from the reception terminal 11, a halfway exit instruction of a user who exits a karaoke box halfway, the check-out processing unit 316 sets an entrance and exit state of the user indicated by the halfway exit instruction to the “halfway exited”. Specifically, if a user identifier of the user who exits the karaoke box halfway is indicated by the halfway exit instruction together with a store ID and a room ID, the check-out processing unit 316 specifies a data entry corresponding to the indicated condition from the check-in management DB 336. The check-out processing unit 316 switches an entrance and exit state included in the specified data entry to the “halfway exited” and registers a date and time indicated by the halfway exit instruction in a halfway exit date and time.

Note that, if checkout for the user who exits the karaoke box halfway is instructed in the halfway exit instruction, the check-out processing unit 316 may individually calculate a use amount relating to the user. In this case, concerning the user identifier for which the entrance and exit state is set to the “halfway exited”, the check-out processing unit 316 calculates a use time from an entrance date and time (or a halfway entrance date and time) to a halfway exit date and time and calculates a use amount based on the use time. Note that, as in the calculation method explained above, the check-out processing unit 316 can calculate the use amount based on the use amount, the attribute of the user, and the like.

Subsequently, the check-out processing unit 316 transmits transaction data including the calculated use amount to the reception terminal 11 that transmitted the halfway exit instruction. Note that the check-out processing unit 316 may transmit the transaction data including a slip number and other data relating to the karaoke box that the user exits the karaoke box halfway. Then, if receiving a checkout completion notification for notifying checkout completion from the reception terminal 11 that transmitted the transaction data, the check-out processing unit 316 sets a checkout finish flag correlated with a user identifier of the user who exits the karaoke box halfway to the “checkout finished”.

Accordingly, the facility management system 100 can individually perform checkout for a user who exits a karaoke box halfway. Therefore, it is possible to improve convenience of the user relating to use of the karaoke box.

### [Information Provision Unit]

The information provision unit 317 cooperates with the various DBs and the functional components explained above to provide support information for supporting use and operation of a karaoke box to the external devices such as the reception terminal 11 and the terminal for external sales 5.

Specifically, if receiving a login request including a set of an employee ID and a password of an operator from the external device such as the reception terminal 11 or the terminal for external sales 5, the information processing unit 317 executes authentication processing for collating the set of the employee ID and the password with a set of an employee ID and a password registered in the employee management DB 331. If the authentication is successful, the information provision unit 317 provides, based on a store ID and an attribute correlated with the employee ID, support information for supporting use and operation of a karaoke box provided in a store corresponding to the store ID to the external device that transmitted the login request.

For example, the information provision unit 317 provides support information for supporting operation relating to check-in processing and check-out processing. For example, the information provision unit 317 provides support information representing an operation state of the karaoke box. For example, the information provision unit 317 provides support information for supporting operation relating to a use reservation for the karaoke box.

Note that the support information is a concept including, besides data stored in the various DBS, a derivation result derived from the data, a screen such as a GUI (Graphical User Interface), and control information for causing the external device to display the screen. Various screen examples displayed based on the support information are explained below.

### [Alert Processing Unit]

The alert processing unit 318 performs various alerts concerning use or operation of a karaoke box. For example, if detecting that the present date and time reached a predetermined time (for example, ten minutes) before an exit scheduled date and time of the karaoke box, the alert processing unit 318 alerts a user of the karaoke box to the exit scheduled date and time.

Specifically, the alert processing unit 318 compares the present date and time and exit scheduled dates and times included in the data entries of the check-in management DB 336 to detect a data entry in which the present date and time reached the predetermined time (for example, ten minutes) before the exit scheduled date and time. Then, the alert processing unit 318 transmits, based on a set of a store ID and a room ID included in the detected data entry, alert information including the exit schedule date and time to the order terminal 12 provided in a karaoke box of a store corresponding to the store ID.

Accordingly, the facility management system 100 can inform a user using the karaoke box that the exit scheduled date and time is close. Therefore, the facility management system 100 can improve convenience relating to the use of the karaoke box.

Note that a transmission destination of the alert information is not limited to the order terminal 12. If the user terminal 4 of the user can be specified based on a member ID or the like, the alert processing unit 318 may transmit the alert information to the user terminal 4 of the user using the karaoke box. In this case, the alert processing unit 318 may transmit the alert information to the user terminal 4 of a representative user or may transmit the alert information to the user terminals 4 of users for whom entrance and exit states are the “staying” and the “halfway entered”. Alert timing for the exit scheduled date and time is not limited to the predetermined time before the exit scheduled date and time. The alert processing unit 318 may perform the alert at timing when the present date and time reached the exit scheduled date or timing when the present date and time exceeded the exit scheduled date and time by a predetermined time.

### [Functional Components of the Reception Terminal 11]

Subsequently, functional components of the reception terminal 11 are explained. As illustrated in FIG. 10, the reception terminal 11 includes a first display control unit 1101, a first operation reception unit 1102, and a first cooperation processing unit 1103 as functional components.

The functional components of the reception terminal 11 may be software components implemented by cooperation of the processor 111 of the reception terminal 11 and various programs stored in the nonvolatile memory region. The functional components of the reception terminal 11 may be hardware components implemented by dedicated circuits or the like mounted on the reception terminal 11.

The first display control unit 1101 controls the display unit 116 of the reception terminal 11 and causes the display unit 116 to display various screens. For example, the first display control unit 1101 cooperates with the first cooperation processing unit 1103 to display various screens for supporting use and operation of a karaoke box.

The first operation reception unit 1102 receives operation from the operator via the operation unit 117 of the reception terminal 11. For example, the first operation reception unit 1102 receives operation on the various screens displayed by the first display control unit 1101.

The first cooperation processing unit 1103 cooperates with the base server 3 to support processing relating to use and operation of the karaoke box using the reception terminal 11. Specifically, the first cooperation processing unit 1103 displays, based on various kinds of support information provided from the base server 3, a screen for supporting use and operation of the karaoke box on the display unit 116. Note that, in starting the cooperation with the base server 3, the first cooperation processing unit 1103 transmits a login request including an employee ID and a password of an employee to be an operator to the base server 3 to authenticate the operator. Then, the first cooperation processing unit 1103 displays, based on support information provided from the base server 3 according to authentication success, a screen for supporting use and operation of the karaoke box on the display unit 116.

### [Functional Components of the Terminal for External Sales]

Subsequently, functional components of the terminal for external sales 5 are explained. As illustrated in FIG. 10, the terminal for external sales 5 includes a second display control unit 511, a second operation reception unit 512, and a second cooperation processing unit 513 as functional components.

The functional components of the terminal for external sales 5 may be software components implemented by cooperation of the processor 51 of the terminal for external sales 5 and various programs stored in the nonvolatile memory region. The functional components of the terminal for external sales 5 may be hardware components implemented by dedicated circuits or the like mounted on the terminal for external sales 5.

The second display control unit 511 controls the display unit 56 of the terminal for external sales 5 and causes the display unit 56 to display various screens. For example, the second display control unit 511 cooperates with the second cooperation processing unit 513 to display various screens for supporting use and operation of a karaoke box.

The second operation reception unit 512 receives operation from an operator via the operation unit 57 of the terminal for external sales 5. For example, the second operation reception unit 512 receives operation on various screens displayed by the second display control unit 511.

The second cooperation processing unit 513 cooperates with the base server 3 to support processing relating to use and operation of a karaoke box using the terminal for external sales 5. Specifically, the second cooperation processing unit 513 displays, based on various kinds of support information provided from the base server 3, a screen for supporting use and operation of the karaoke box on the display unit 56.

Note that it is assumed that, in starting cooperation with the base server 3, the second cooperation processing unit 513 authenticates the operator by transmitting a login request including an employee ID and a password of an employee to be the operator to the base server 3. The second cooperation processing unit 513 displays, based on support information provided from the base server 3 according to authentication success, a screen for supporting use and operation of the karaoke box on the display unit 56.

### [Operation Example of the Facility Management System]

Operation examples of the base server 3, the terminal for external sales 5, and the reception terminal 11 explained above are explained below.

### [Cooperative Operation of the Base Server and the Terminal for External Sales]

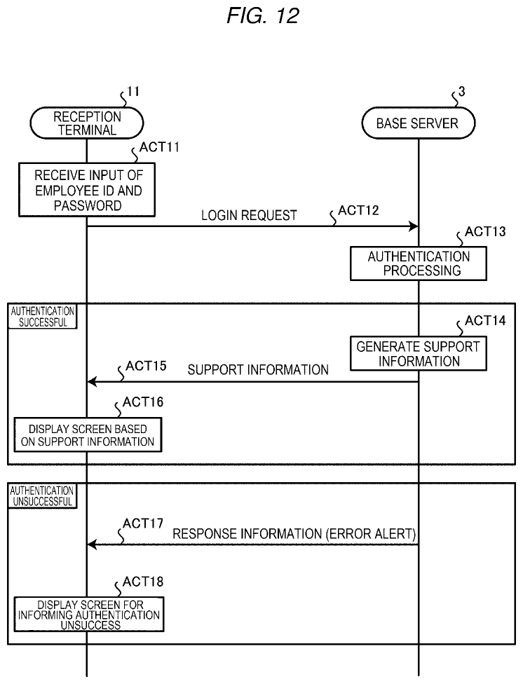

First, an operation example performed between the base server 3 and the reception terminal 11 is explained. FIG. 12 is a sequence chart illustrating an example of cooperation start processing performed between the base server 3 and the reception terminal 11.

First, in starting operation of the reception terminal 11, an employee inputs an employee ID and a password of the employee to the reception terminal 11. If receiving the input of the employee ID and the password (ACT 11), the first cooperation processing unit 1103 of the reception terminal 11 transmits a login request including a store ID of a store of the employee and a set of the input employee ID and the input password to the base server 3 (ACT 12).

If receiving the login request, the information provision unit 317 of the base server 3 executes authentication processing for collating the set of the employee ID and the password included in the login request and sets of employee IDs and passwords registered in the employee management DB 331 (ACT 13).

Here, if a set coinciding with the set of the employee ID and the password included in the login request is stored in the employee management DB 331, the information provision unit 317 determines that the authentication is successful. In this case, the information provision unit 317 refers to the various DBs and extracts data relating to the store ID indicated by the login request to generate support information relating to the store having the store ID (ACT 14). The information provision unit 317 provides the generated support information to the reception terminal 11 (ACT 15).

The first cooperation processing unit 1103 of the reception terminal 11 causes, based on the support information provided from the base server 3, the display unit 116 to display a screen for supporting use and operation of a karaoke box (ACT 16). Note that the information provision unit 317 of the base server 3 provides, according to various kinds of operation performed by the reception terminal 11, support information corresponding to content of the operation to the reception terminal 11.

If a set coinciding with the set of the employee ID and the password included in the login request is not stored in the employee management DB 331, the information provision unit 317 determines that the authentication is unsuccessful.

In this case, the information provision unit 317 transmits response information for informing authentication unsuccess to the reception terminal 11 (ACT 17). In this case, the first cooperation processing unit 1103 of the reception terminal 11 causes, based on the response information provided from the base server 3, the display unit 116 to display a screen for informing the authentication unsuccess (ACT 18).

For example, the first cooperation processing unit 1103 of the reception terminal 11 causes, based on the support information provided from the base server 3 according to the authentication success, the display unit 116 to display an operation screen for supporting use and operation of the karaoke box.

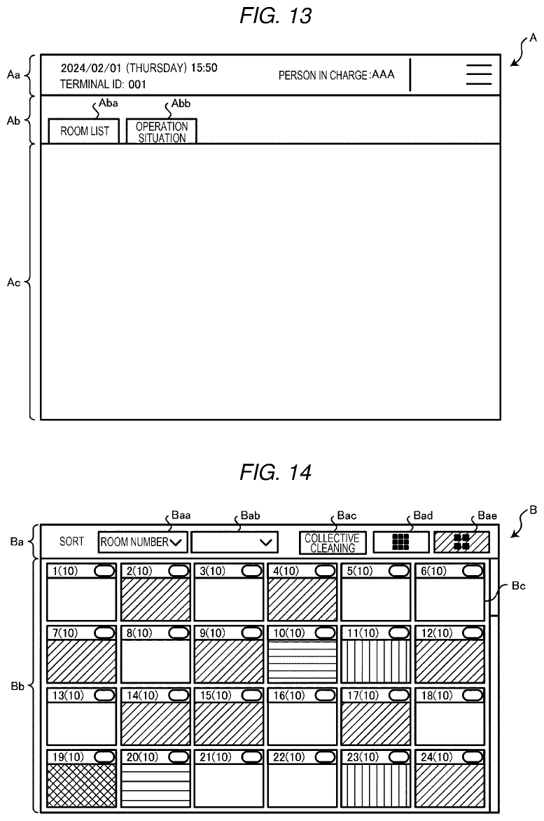

FIG. 13 is a diagram illustrating an example of an operation screen displayed on the reception terminal 11. As illustrated in FIG. 13, an operation screen A includes an information display field Aa, a tab display field Ab, and a display region Ac.

In the information display field Aa, the present date and time and various kinds of information such as a terminal ID capable of identifying the reception terminal 11 and a name of an operator for whom authentication was successful are displayed. In the tab display field Ab, for example, a tab Aba and a tab Abb are displayed. In the tab display field Ab, for example, the tab Aba and the tab Abb are displayed. The tab Aba and the tab Abb are operation pieces for switching functions. A screen corresponding to a selected function is displayed in the display region Ac.

The tab Aaa is an operation piece for selecting list display of karaoke boxes provided in a store where the reception terminal 11 is provided. If receiving operation of the tab Aaa, the first cooperation processing unit 1103 transmits a room list request including a store ID of the store to the base server 3.

If receiving the room list request, the information provision unit 317 of the base server 3 provides, based on data entries of various DBs relating to the store ID indicated by the room list request, support information representing states of karaoke boxes included in the store having the store ID to the reception terminal 11.

The first cooperation processing unit 1103 causes, based on the support information provided from the base server 3, the display unit 116 (the display region Ac) to display a room list screen representing a list of karaoke boxes. Note that the tab Aba may be automatically selected in an initial state in which the operation screen A is displayed.

FIG. 14 is a diagram illustrating an example of the room list screen displayed on the reception terminal 11. As illustrated in FIG. 14, a room list screen B includes an operation piece field Ba and a list region Bb.

In the list region Bb, room buttons Bc respectively representing karaoke boxes are arrayed and displayed. The room buttons Bc are an example of images respectively representing facilities of a store and are, for example, rectangular display regions. Room IDs of karaoke boxes corresponding thereto are correlated with the room buttons Bc. The room buttons Bc are provided as many as rooms of the karaoke boxes and arrayed, for example, in the order of the room IDs.

In the operation piece field Ba, various operation pieces relating to display control for the room buttons Bc are displayed. For example, in the operation piece field Ba, a first operation piece Baa and a second operation piece Bab for indicating arrangement order (display order) of the room buttons Bc displayed in the list region Bb, a third operation piece Bac for narrowing down the room buttons Bc to be displayed, a fourth operation piece Bad and a fifth operation piece Bae for changing the number of the room buttons Bc displayed in one screen, and the like are provided.

In the first operation piece Baa and the second operation piece Bab, the order of the room buttons Bc to be displayed can be changed by combining, for example, the order of room IDs (room numbers) and the order of exit scheduled time, a karaoke model, and a maximum capacity (or a minimum capacity). In the first operation piece Baa and the second operation piece Bab, the order of the room buttons Bc to be displayed can be changed in a state in which a target to be displayed is the “staying”, the “cleaning”, the “out of order”, or the like. Note that, in FIG. 14, an example is illustrated in which the room buttons Bc are displayed in room number order set in the first operation piece Baa.

The third operation piece Bac is an operation piece for making it possible to select only the room button Bc of karaoke boxes in states of waiting for cleaning and cleaning. If receiving operation of the third operation piece Bac, the first cooperation processing unit 1103 disables the selection operation by, for example, graying out the room buttons Bc of other states other than the room buttons Bc of the karaoke boxes in the states of waiting for cleaning and cleaning. That is, only the room buttons Bc of the karaoke boxes in the states of waiting for cleaning and cleaning are enabled to be in a selectable state.

If receiving operation for selecting one or a plurality of room buttons Bc out of the enabled room buttons Bc, the first cooperation processing unit 1103 switches a name “collective cleaning” displayed in the third operation piece Bac to “change”. The third operation piece Bac (hereinafter referred to as change button as well) after switching to the “change” is an operation piece for collectively switching states of the selected room buttons Bc. Note that, in order to prevent the room buttons Bc for the “waiting for cleaning” and the “cleaning” from being mixed and selected, the first cooperation processing unit 1103 may perform exclusive control for receiving selective operation for the room buttons Bc only for one state.

If receiving the operation of the change button explained above, the first cooperation processing unit 1103 performs processing for switching states of karaoke boxes corresponding to the selected room buttons Bc to the following state. For example, if receiving the operation of the change button in a state in which the room button Bc of the “waiting for cleaning” is selected, the first cooperation processing unit 1103 transmits a cleaning start notification including a store ID of the store where the reception terminal 11 is provided, the room IDs of the selected room buttons Bc, and the like to the base server 3 to switch the states of karaoke boxes corresponding thereto to the state of the “cleaning”. For example, if receiving operation of the change button in a state in which the room button Bc of the “cleaning” is selected, the first cooperation processing unit 1103 transmits a cleaning completion notification including the store ID of the store where the reception terminal 11 is provided and the room IDs of the selected room buttons Bc to the base server 3 to switch the states of karaoke boxes corresponding thereto to the state of the “vacant”.

Note that the first cooperation processing unit 1103 may hide, on condition that the room button Bc was operated, the room buttons Bc other than the room buttons Bc of the karaoke boxes in the states of the “waiting for cleaning” and the “cleaning” to display the room buttons Bc narrowed down to the states of the “waiting for cleaning” and the “cleaning”.

In the fourth operation piece Bad and the fifth operation piece Bae, it is possible to instruct to respectively display different numbers of the room buttons Bc. For example, the fourth operation piece Bad is an operation piece for instructing to display 6×8 room buttons Bc in one screen. The fifth operation piece Bae is an operation piece for instructing to display 6×4 room buttons Bc in one screen. According to operation of the fourth operation piece Bad or the fifth operation piece Bae, the first cooperation processing unit 1103 changes the number of the room buttons Bc displayed in one screen and changes the size of the room buttons Bc and an information amount displayed on the room buttons Bc. Note that, in FIG. 14, an example is illustrated in which the fifth operation piece Bae is selected.

On each of the room buttons Bc, information corresponding to basic information and a state of a karaoke box corresponding to the room button Bc is displayed. Accordingly, the room buttons Bc are displayed in a form of capable of identifying current states of the facilities. Display examples are explained below.

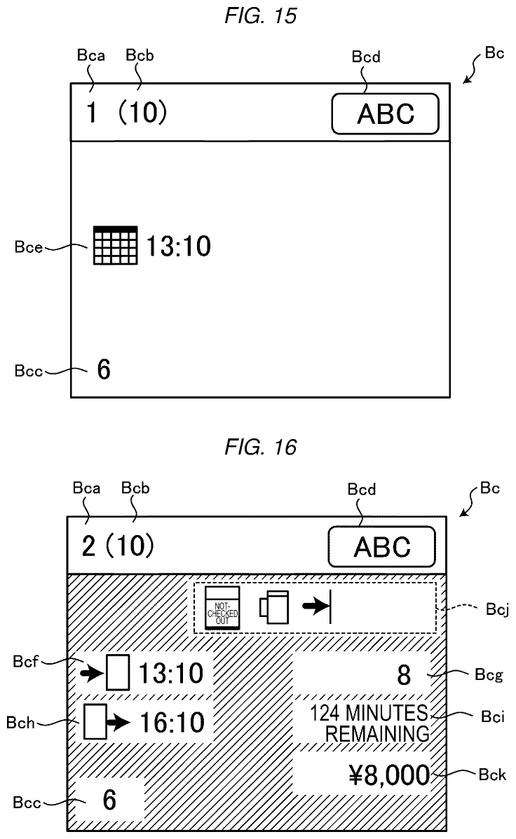

FIGS. 15 to 18 are diagrams illustrating display examples of the room button Bc. Here, FIG. 15 illustrates the room button Bc of a karaoke box that is in the state of the “vacant”. As illustrated in FIG. 15, on the room button Bc of the karaoke box in the “vacant” state, basic information such as a room name Bca, a maximum capacity Bcb, a minimum capacity Bcc, and a karaoke model Bcd is displayed. Note that, even if the karaoke box is in the state of the “vacant”, a most recent reservation date and time Bce is displayed on the room button Bc if reservation information relating to the karaoke box is registered in the reservation management DB 337.

FIG. 16 illustrates the room button Bc of a karaoke box in the state of the “staying”. As illustrated in FIG. 16, on the room button Bc of the karaoke box in the “staying” state, information concerning a user using the karaoke box is displayed besides the basic information such as the room name Bca, the maximum capacity Bcb, the minimum capacity Bcc, and the karaoke model Bcd. Note that information concerning equipment provided in a room may be displayed on the room button Bc.

For example, on the room button Bc of the karaoke box in the “staying” state, information such as a use start date and time Bcf, the number of users Bcg, exit scheduled time Bch, a remaining time Bci, an information icon Bcj, and a sales amount Bck is displayed. Here, the use start date and time Bcf, the number of users Bcg, and the exit scheduled time Bch correspond to an entrance date and time, the number of users, and an exit scheduled date and time included in a data record of a karaoke box corresponding thereto stored in the check-in management DB 336. The remaining time Bci is information indicating a time from the present date and time to the exit scheduled date and time.

On the information icon Bcj, an icon representing information incidental to the use of the karaoke box is displayed. For example, on the information icon Bcj, an icon representing a room course or the like is displayed based on a data record of the karaoke box corresponding thereto stored in the check-in management DB 336. On the information icon Bcj, if reservation information in which a reservation date and time is set within a predetermined time from the exit scheduled date and time is registered in the reservation management DB 337, an icon image representing extension impossibility is displayed based on a data record of the karaoke box corresponding thereto stored in the reservation management DB 337.

The sales amount Bck represents a use amount of the karaoke box at the present point in time. The sales amount Bck is calculated by, for example, cooperating with the check-out processing unit 316.

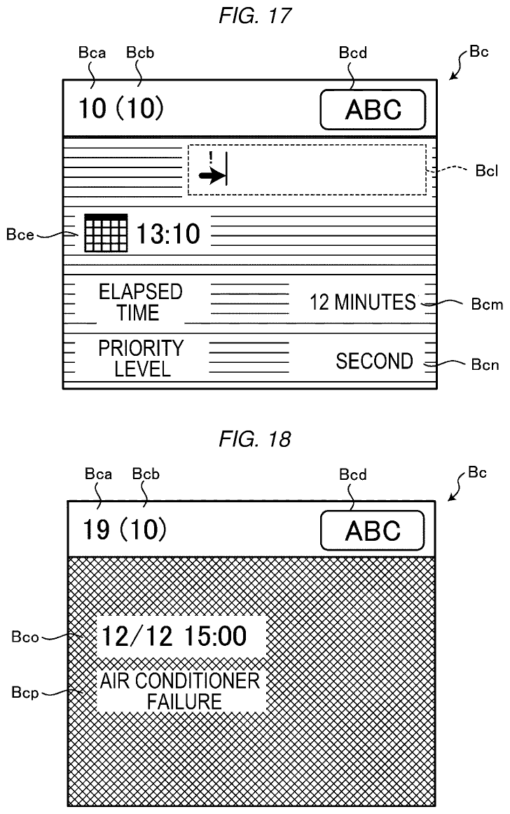

FIG. 17 illustrates the room button Bc of the karaoke box in the states of the “waiting for cleaning” and the “cleaning”. As illustrated in FIG. 17, on the room button Bc of a karaoke box that is in the states of the “waiting for cleaning” and the “cleaning”, basic information such as the room name Bca, the maximum capacity Bcb, and the karaoke model Bcd is displayed. If reservation information is registered in the karaoke box of the room button Bc, the most recent reservation date and time Bce is displayed.

On the room button Bc of the karaoke box in the states of the “waiting for cleaning” and the “cleaning”, an information icon Bcl, an elapsed time Bcm, a priority rank Bcn, and the like are displayed.

On the information icon Bcl, an icon representing information incidental to cleaning of the karaoke box is displayed. For example, on the information icon Bcl, if a time from the present date and time to a most recent reservation date and time is a predetermined time or less, an icon image representing urgency is displayed based on a data record of the karaoke box corresponding thereto stored in the reservation management DB 337.

The elapsed time Bcm indicates an elapsed time after switching to the state of the “waiting for cleaning” (or the “cleaning”). The elapsed time Bcm corresponds to, for example, a time from a state start date and time of a karaoke box corresponding thereto stored in the state management DB 335 to the present date and time.

The priority rank Bcn indicates a priority rank for performing cleaning. A method of deriving the priority rank does not particularly matter. Various methods can be used. For example, the priority rank Bon may be a rank at the time when elapsed times Bcm are arranged in the descending order. The priority rank Bon may be determined according to whether a use reservation is set for a karaoke box corresponding thereto, a time from the present date and time to a reservation date and time.

FIG. 18 illustrates the room button Bc of a karaoke box that is in the state of the “out of order”. As illustrated in FIG. 18, on the room button Bc of the karaoke box in the “out of order” state, basic information such as the room name Bca, the maximum capacity Bcb, and the karaoke model Bcd is displayed. On the room button Bc of the karaoke box in the “out of order” state, a failure date and time Bco, a failure reason Bcp, and the like are displayed.

The failure date and time Bco indicates a date and time of switching to the state of the “out of order”. The failure date and time Bco corresponds to, for example, a state start date and time of the karaoke box corresponding thereto stored in the state management DB 335. The failure reason Bcp indicates a reason why the karaoke box is in the state of the “out of order”. The failure reason Bcp corresponds to, for example, a failure reason of the karaoke box corresponding thereto stored in the state management DB 335.

Note that the room buttons Bc of the states explained above are displayed in a state in which the states can be visually identified. For example, the room buttons Bc are displayed in display colors different from one another corresponding to the respective states of the “vacant”, the “staying”, the “waiting for cleaning”, the “cleaning”, and the “out of order”, whereby the states are displayed in an identifiable state.

Accordingly, the operator can easily check states of the karaoke boxes provided in the store of the operator by viewing the room list screen B. Therefore, the facility management system 100 can improve convenience relating to use and operation of the karaoke boxes.

The room button Bc of the “vacant” state may be displayed to be capable of identifying whether there is a use reservation for a karaoke box corresponding thereto. For example, the room button Bc may be displayed in a state of being capable of identifying presence or absence of a reservation by differentiating a display color for the room button Bc with a use reservation and the room button Bc without a use reservation. The room button Bc may be displayed in a state of capable of identifying the remaining time until a reservation date and time by differentiating the display color of the room button Bc or changing light and shade of the display color according to a time length from the present date and time until a most recent reservation date and time.

Accordingly, the operator can easily check, by viewing the room list screen B, whether a use reservation is present in the karaoke box in the “vacant” state. The operator can intuitively grasp, by viewing the room list screen B, a remaining time until a use reservation set in the karaoke box in the “vacant” state. Therefore, the facility management system 100 can improve convenience relating to use and operation of the karaoke box.

The room button Bc of the “staying” state may be displayed by switching a display color according to a time length of the remaining time. For example, the room button Bc may be displayed to be capable of identifying a relation between an exit scheduled date and time and the remaining time by dividing the remaining time into a plurality of stages of time intervals such as eleven minutes or more until the exit scheduled date and time, the remaining zero to ten minutes until the exit scheduled date and time, one to fifteen minutes elapsed from the exit scheduled date and time, and sixteen minutes or more elapsed from the exit scheduled date and time and switching the display color for each of the divisions or changing light and shade of the display color.

Accordingly, the operator can easily check a use situation of the karaoke box in the “staying” state by viewing the room list screen B. The operator can easily check, by viewing the room list screen B, a karaoke box in which the exit scheduled date and time is exceeded. Therefore, the facility management system 100 can improve convenience relating to use and operation of the karaoke box.

Each of the room buttons Bc functions as an operation piece for receiving various kinds of operation for a karaoke box corresponding thereto. Specifically, if receiving operation for the room button Bc, the first cooperation processing unit 1103 notifies the base server 3 of an operation request including the store ID of the store where the reception terminal 11 is provided and a room ID corresponding to the karaoke box of the operated room button Bc.

If receiving an operation request, the information provision unit 317 of the base server 3 provides, based on a current state of a karaoke box corresponding to a set of a store ID and a room ID indicated by the operation request, support information for supporting operation corresponding to the state to the reception terminal 11 at a transmission source that transmitted the operation request. The first cooperation processing unit 1103 of the reception terminal 11 causes the display unit 116 to display various screens based on the support information provided from the base server 3.

For example, if receiving operation on the room button Bc of the “vacant” state, the first cooperation processing unit 1103 causes the display unit 116 to display a vacancy selection screen including operation pieces for performing operation of check-in, failure setting, return to cleaning, and the like.

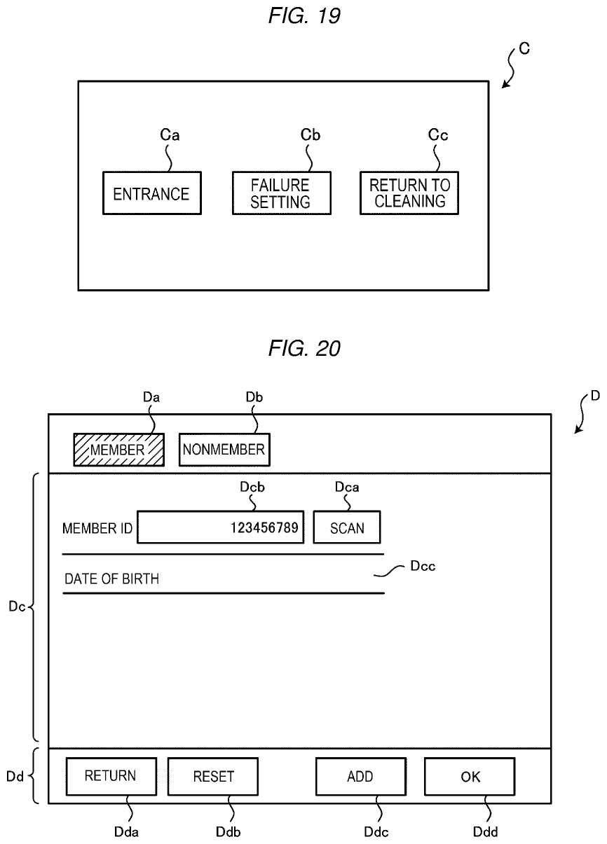

FIG. 19 is a diagram illustrating an example of the vacancy selection screen displayed on the reception terminal 11. Here, a vacancy selection screen C is a screen example displayed if the room button Bc of the “vacant” state is operated and includes operation pieces such as an entrance button Ca, a failure setting button Cb, and a return to cleaning button Cc.

The entrance button Ca is an operation piece for performing check-in of a user. If receiving operation of the entrance button Ca, the first cooperation processing unit 1103 displays a user information input screen for inputting user information of the user who performs check-in.

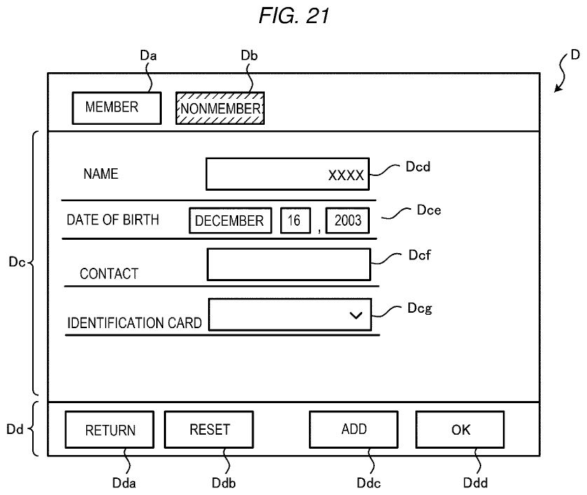

Here, FIGS. 20 and 21 are diagrams illustrating an example of the user information input screen displayed on the reception terminal 11. As illustrated in FIGS. 20 and 21, a user information input screen D includes a member button Da, a nonmember button Db, a user information field Dc, and an operation piece field Dd.

The member button Da and the nonmember button Db are operation pieces for switching an input item according to whether a user is a member. If receiving operation of the member button Da, the first cooperation processing unit 1103 displays an input item for members in the user information field Dc.

FIG. 20 illustrates a state in which the member button Da is selected. A scan button Dca, a member ID display field Dcb, a date of birth input field Dcc, and the like are displayed in the user information field Dc. Here, the scan button Dca is an operation piece for instructing to read a member ID.

If receiving operation of the scan button Dca, the first cooperation processing unit 1103 cooperates with the reading unit 118 or the like to read a member ID from a medium carried by the user. If acquiring the member ID via the reading unit 118 or the like, the first cooperation processing unit 1103 displays the acquired member ID in the member ID display field Dcb. The first cooperation processing unit 1103 transmits a member reference request including the acquired member ID to the base server 3. If receiving the member reference request, the information provision unit 317 of the base server 3 reads, from the member management DB, member information corresponding to the member ID indicated by the member reference request and provides the member information to the reception terminal 11 at a request source.

If acquiring member information from the base server 3 as a response to the member reference request, the first cooperation processing unit 1103 displays a date of birth included in the member information in the date of birth input field Dcc. Note that the first cooperation processing unit 1103 may display information other than the date of birth included in the member information in the user information field Dc in the case in which the member button Da is selected.

On the other hand, if the nonmember button Db is selected, the first cooperation processing unit 1103 displays an input item for nonmembers in the user information field Dc. FIG. 21 illustrates a state in which the nonmember button Db is selected. A name input field Dcd, a date of birth input field Dce, a contact input field Dcf, an identification card selection button Dcg, and the like are displayed in the user information field Dc.

The name input field Dcd is an input field for inputting a name of a user. The date of birth input field Dce is an input field for inputting a date of birth of the user. The contact input field Dcf is an input field for inputting a contact of the user.

The operator of the reception terminal 11 inputs, for example, a name of the user and a date of birth described in an identification card to the name input field Dcd and the date of birth input field Dce. The operator of the reception terminal 11 inputs, for example, a telephone number of the user terminal 4 carried by the user to the contact input field Dcf. Note that the user himself or herself may perform the input to the name input field Dcd, the date of birth input field Dce, and the contact input field Dcf.

The identification card selection button Dcg is an operation piece capable of selecting various identification cards such as a driver's license and a student identification card. In the store, in the case of a nonmember user, an employee sometimes checks the identification card of the user in order to check an age and the like of the user. The identification card selection button Dcg is operated if the employee checks the identification card of the user. A type of the checked identification card can be selected. The selected type of the identification card is used as an indicator in applying a service such as a student discount. Note that the input to the other input field may be disabled until any one of the types is selected.

As illustrated in FIGS. 20 and 21, various operation pieces are provided in the operation piece field Dd. For example, in the operation piece field Dd, a return button Dda, a reset button Ddb, an addition button Ddc, an OK button Ddd, and the like are provided. The return button Dda is an operation piece for instructing to return to a screen at a transition source. If the return button Dda is operated, the first cooperation processing unit 1103 displays the screen at the transition source.

The reset button Ddb is an operation piece for instructing to reset information input to the user information field Dc. If the reset button Ddb is operated, the first cooperation processing unit 1103 clears various kinds of information input to the user information field Dc.

The addition button Ddc is an operation piece for instructing to add a user. If the addition button Ddc is operated, the first cooperation processing unit 1103 retains, as user information for one user, in the RAM or the like, various kinds of information input to the user information field Dc. The first cooperation processing unit 1103 clears the user information field Dc and prepares for input of user information of the next user. Note that, if retaining the user information for one user, the first cooperation processing unit 1103 may give a user identifier.

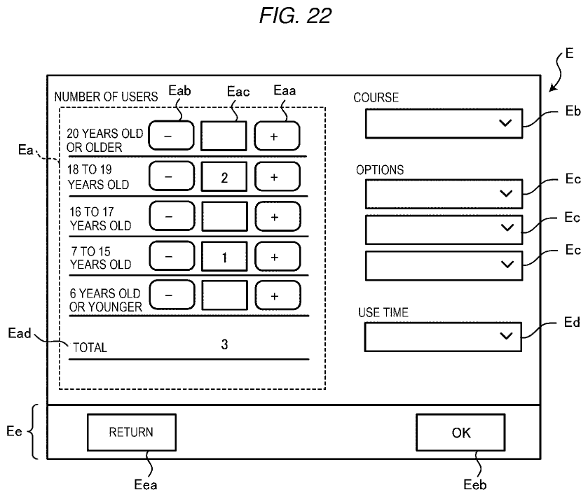

The OK button Ddd is an operation piece for instructing to decide the user. If the OK button Ddd is operated, the first cooperation processing unit 1103 causes the display unit 116 to display a use information input screen illustrated in FIG. 22. If information is input to the user information field Dc at a point in time when the OK button Ddd is operated, the first cooperation processing unit 1103 retains the input various kinds of information in the RAM or the like as user information for one user and thereafter causes the display unit 116 to display a basic information input screen.

Note that, in the present embodiment, user information is input on the user information input screen D for each of users who use a karaoke box. However, not only this, but, for example, only user information of a representative user may be input. Information that can be input on the user information input screen D is not limited to the example explained above.

FIG. 22 is a diagram illustrating an example of the use information input screen displayed on the reception terminal 11. As illustrated in FIG. 22, a use information input screen E includes a number of users input field Ea, a course input field Eb, an option input field Ec, a use scheduled time input field Ed, and an operation piece field Ee.

In the number of users input field Ea, the number and age categories of users using a karaoke box can be input. In the number of users input field Ea, for example, a + button Eaa, a − button Eab capable of designating the number of users for each age category and a number of users display field Eac are provided. The + button Eaa is an operation piece for instructing to add one to the number of users. The − button Eab is an operation piece for instructing to reduce one from the number of users.

Every time pressing operation of the + button Eaa is received, the first cooperation processing unit 1103 adds one to the number of users in an age category corresponding to the pressing operation and displays the number of users after the addition in the number of users display field Eac of the age category. Every time pressing operation of the − button Eab is received, the first cooperation processing unit 1103 subtracts one from the number of users of an age category corresponding to the pressing operation and displays the number of users after the subtraction in the number of users display field Eac of the age category. Note that it is assumed that the − button Eab is enabled if the number of users displayed in the number of users display field Eac is one or more. The setting of the number of users is not limited to the operation via the + button Eaa and the − button Eab. A numerical value may be directly input to the number of users display field Eac.

Note that the first cooperation processing unit 1103 may discriminate age categories based on dates of birth of users input on the user information input screen D and display the discriminated number of users for each of the discriminated age categories in the number of users display field Eac of the corresponding age category. In this case, the + button Eaa and the − button Eab can be used for number of users adjustment.

A total number of users display field Ead is provided in the number of users input field Ea. The first cooperation processing unit 1103 totals the numbers of users displayed in the number of users display fields Eac of the age categories and displays the total number of users in the total number of users display field Ead.

In the course input field Eb, a room course to be used by the user can be designated. For example, in the course input field Eb, an operation piece of a pulldown format or the like capable of selecting one room course out of a preset plurality of types of room courses is provided. The operator selects one room course out of the plurality of types of room courses, whereby the selected room course is input to the course input field Eb.

In the option input field Ec, an option to be used by the user can be designated. For example, in the option input field Ec, an operation piece of a pulldown format or the like capable of selecting one option out of a preset plurality of types of options is provided. The operator selects one option out of the plurality of types of options, whereby the selected option is input to the option input field Ec.

Note that, in FIG. 22, a plurality of option input fields Ec are provided to make it possible to select a plurality of types of options. However, the number of option input fields Ec may be one. An option can be selected for each user. For example, an option can be selected for each user by providing the option input field Ec in the user information input screen D.

As options displayed as choices in the option input field Ec, it is preferable to display, based on conditions such as an age cattery and a room course of a user, options selectable under the conditions. For example, if the user is a minor, it is preferable to exclude, from the choices, an option including provision of alcoholic beverages. It is preferable to exclude, from the choices, an option that cannot be combined with the room course selected in the course input field Eb. Note that the information provision unit 317 of the base server 3 may extract or the first cooperation processing unit 1103 may extract a selectable option.

The use scheduled time input field Ed is an input field for inputting a use scheduled time. The operator inputs, to the use scheduled time input field Ed, a time when the user is scheduled to use a karaoke box. Note that, if the time input to the use scheduled time input field Ed interferes with a reservation date and time set in the same karaoke box, the first cooperation processing unit 1103 may display an alert screen for alerting to the interference with the reservation date and time and urging a change of the use scheduled time or the karaoke box. Here, “interfere with the reservation date and time” means that, for example, the time overlaps the reservation date and time or a date and time taking into account a cleaning time after karaoke box use overlaps the reservation date and time. Note that the information provision unit 317 of the base server 3 may determine or the first cooperation processing unit 1103 may determine whether the time interferes with the reservation date and time.

Various operation pieces are provided in the operation piece field Ee. For example, a return button Eea, an OK button Eeb, and the like are provided in the operation piece field Ee. The return button Eea is an operation piece for instructing to return to a screen at a transition source. If the return button Eea is operated, the first cooperation processing unit 1103 displays the screen at the transition source.

The OK button Eeb is an operation piece for instructing to decide information input to the use information input screen E. If the OK button Eeb is operated, the first cooperation processing unit 1103 transmits, to the base server 3, check-in information including the store ID of the store where the reception terminal 11 is provided, a room ID of a karaoke box for which the operation was performed, and various kinds of information input on the user information input screen D and the use information input screen E. Specifically, the first cooperation processing unit 1103 transmits, to the base server 3, a check-in instruction including the user information retained on the user information input screen D and the various kinds of information input to the use information input screen E.

Note that, at timing when the OK button Eeb is operated, by comparing a maximum capacity and a minimum capacity of the karaoke box for which the operation was performed and a total number of users, usability of the karaoke box may be determined and a result of the determination may be informed. Specifically, if the total number of users is more than the maximum capacity or less than the minimum capacity, a message or the like for informing to that effect may be displayed on the display unit 116. In this case, the information provision unit 317 of the base server 3 may determine or the first cooperation processing unit 1103 may determine the usability of the karaoke box.

If receiving a check-in instruction from the reception terminal 11, the check-in processing unit 313 of the base server 3 starts check-in processing. Specifically, if receiving the check-in instruction, the check-in processing unit 313 issues a slip number. The check-in processing unit 313 registers the issued slip number and a store ID, a room ID, user information, and the like included in the check-in instruction in the check-in management DB 336 in correlation.

Note that, if registering the user information included in the check-in instruction in the check-in management DB 336, the check-in processing unit 313 sets entrance and exit states of users to the “staying” and sets the checkout finish flag to the “not checked out” and registers the entrance and exit state and the checkout finish flag. The check-in processing unit 313 selects a representative from the users of the user information included in the check-in instruction and registers a user identifier of the representative in the representative information field of the check-in management DB 336. The representative may be indicated by the check-in instruction or the check-in processing unit 313 may automatically select the representative. If automatically selecting the representative, the check-in processing unit 313 may select, based on the user identifier, as the representative, a user input first. The check-in processing unit 313 registers elements other than the items of the check-in management DB 336 in the additional information field or a user additional information field.

If completing the registration in the check-in management DB 336, the check-in processing unit 313 of the base server 3 transmits the issued slip number to the reception terminal 11 at a transmission source of the check-in instruction. Accordingly, in the base server 3, the state management unit 311 switches a state of a karaoke box corresponding to a store ID and a room ID for which the check-in processing was performed from the “vacant” to the “staying”.

After transmitting the check-in instruction, if receiving the slip number from the base server 3, the first cooperation processing unit 1103 of the reception terminal 11 controls the printing unit 119 to print a slip including at least the slip number. For example, the first cooperation processing unit 1103 causes the printing unit 119 to print a slip including the slip number, a room ID, an entrance date and time, an exit scheduled date and time, and the number of users. The slip number may be printed in a state in which the slip number is encoded into a code symbol such as a barcode or a two-dimensional code. Such a slip number is input to the reception terminal 11, for example, at the time of check-out.

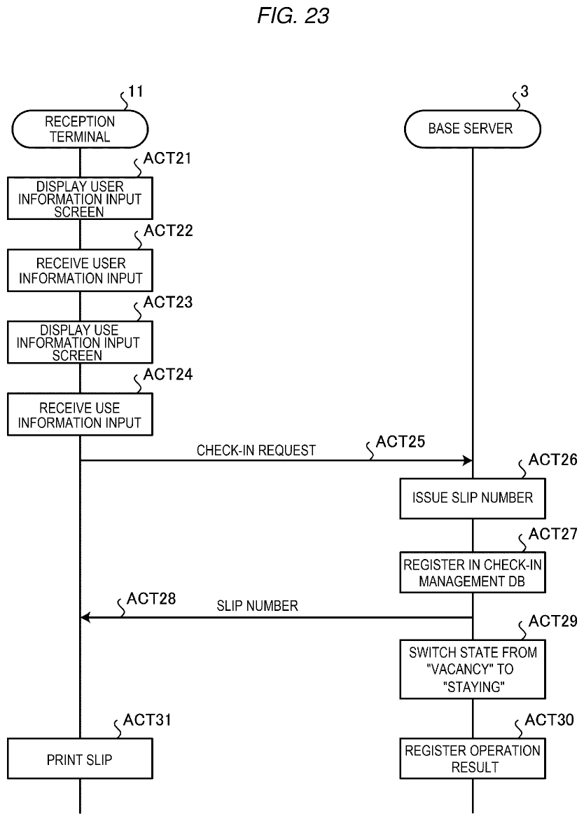

Here, operation examples of the base server 3 and the reception terminal 11 relating to the check-in processing explained above are explained with reference to FIG. 23. FIG. 23 is a sequence chart illustrating an example of check-in processing performed between the base server 3 and the reception terminal 11. Note that, as a premise of the processing, it is assumed that a karaoke box to be an operation target is in the state of the “vacant”.

First, the first cooperation processing unit 1103 of the reception terminal 11 displays the user information input screen D on the display unit 116 (ACT 21) and stays on standby until user information of a user using the karaoke box is input. If receiving input of the user information (ACT 22), the first cooperation processing unit 1103 displays the use information input screen E on the display unit 116 (ACT 23) and stays on standby until use information such as a room course is input. If receiving input of the use information (ACT 24), the first cooperation processing unit 1103 transmits a check-in request including the store ID of the store where the reception terminal 11 is provided, a room ID of the karaoke box, the user information, and the use information to the base server 3 (ACT 25).

If receiving the check-in request, the check-in processing unit 313 of the base server 3 issues a slip number (ACT 26). Subsequently, the check-in processing unit 313 registers the issued slip number and the store ID, the room ID, the user information, and the use information included in the check-in request in the check-in management DB 336 in correlation (ACT 27). Subsequently, the check-in processing unit 313 notifies the issued slip number to the base server 3 (ACT 28).

The state management unit 311 of the base server 3 switches a state of the state management DB 335 corresponding to the room ID indicated by the check-in request from the “vacant” to the “staying” (ACT 29). The state management unit 311 registers an operation result of the karaoke box, the state of which was switched, in the operation result DB 338 (ACT 30).

If receiving the slip number from the base server 3 as a response to the check-in request, the first cooperation processing unit 1103 of the reception terminal 11 prints a slip including the slip number (ACT 31). If the slip is printed, the operator of the reception terminal 11 hands the slip over to the user and urges the user to move to the karaoke box.

Accordingly, in the store, the check-in of the user is completed and the user can use the karaoke box.

Note that a method of entrance (check-in) of the user who did not make a reservation for the karaoke box is explained above. However, in the case of a user who made a reservation for the karaoke box, the check-in can be performed by, for example, a method explained below.

First, the operator of the reception terminal 11 requests the base server 3 to read reservation information based on key information capable of specifying the reservation information. Here, the key information does not particularly matter if the key information is information serving as a key for a search such as a member ID of the user, a reservation date and time, or a reserved room ID. If reading the reservation information corresponding to the key information from the reservation management DB 337, the check-in processing unit 313 (or the information provision unit 317) of the base server 3 transmits the reservation information to the reception terminal 11.

The first cooperation processing unit 1103 displays the user information input screen D and the use information input screen E based on the reservation information provided from the base server 3. For example, the first cooperation processing unit 1103 displays the user information input screen D and the use information input screen E reflecting information (a member ID) of the user, the number of users, a use scheduled time, and the like included in the reservation information. Then, as explained above, the first cooperation processing unit 1103 transmits a check-in request including the information input to the user information input screen D and the use information input screen E to the base server 3.

Accordingly, in the reception terminal 11, the check-in processing based on the reservation information can be performed. Note that, in the base server 3, the reservation information is deleted from the reservation management DB 337 according to the transmission of the reservation information to the reception terminal 11 or completion of the registration in the check-in management DB 336.

Referring back to FIG. 19, the failure setting button Cb of the vacancy selection screen C is an operation piece operated if a failure or the like occurs in the karaoke box. If receiving operation of the failure setting button Cb, the first cooperation processing unit 1103 displays a failure setting screen for inputting a failure reason and the like.

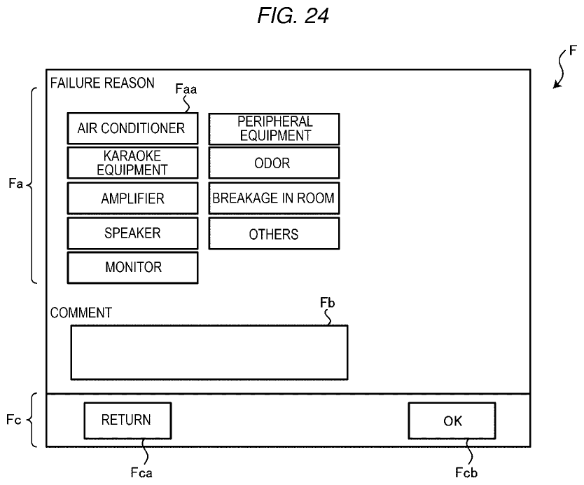

FIG. 24 is a diagram illustrating an example of the failure setting screen displayed on the reception terminal 11. As illustrated in FIG. 24, a failure setting screen F includes a failure reason input field Fa, a comment field Fb, and an operation piece field Fc.

In the failure reason input field Fa, choice buttons Faa representing names of various fixtures provided in the karaoke box, reasons, and the like are provided. The operator selects a relevant choice button Faa, whereby a name of the choice button Faa is input as a failure reason. Note that selectable choice buttons Faa are not limited to one choice button Faa. A plurality of choice buttons Faa can be selected.

Any character strings can be input to the comment field Fb. The operator inputs, for example, a supplementary matter about the failure reason and a comment such as a notice to the other employees to the comment field Fb.

Various operation pieces are provided in the operation piece field Fc. For example, in the operation piece field Fc, a return button Fca, an OK button Fcb, and the like are provided. The return button Fca is an operation piece for instructing to return to a screen at a transition source. If the return button Fca is operated, the first cooperation processing unit 1103 displays the screen at the transition source.

The OK button Fcb is an operation piece for instructing to decide the information input to the failure setting screen F. If the OK button Fcb is operated, the first cooperation processing unit 1103 transmits a failure occurrence notification including the store ID of the store where the reception terminal 11 is provided, a room ID of a karaoke box for which the operation was performed, a failure reason input to the failure setting screen F, and a comment to the base server 3. Note that the first cooperation processing unit 1103 may transmit the failure occurrence notification including an employee ID of the operator.

If receiving the failure occurrence notification, the state management unit 311 of the base server 3 specifies, from the state management DB 335, a data entry corresponding to the store ID and the room ID indicated by the failure occurrence notification. Subsequently, the state management unit 311 switches a room state of the specified data entry from the “vacant” to the “out of order”. Thus, the reception terminal 11 updates, according to the switching of the state of the karaoke box, display of the room button Bc corresponding to the state.

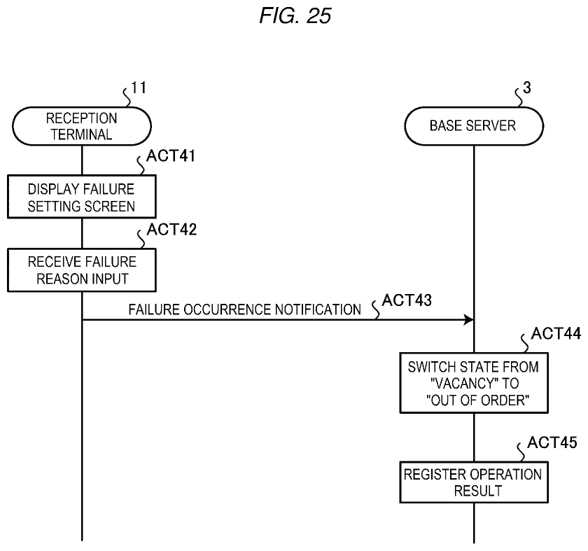

Here, operation examples of the base server 3 and the reception terminal 11 relating to the failure setting explained above are explained with reference to FIG. 25. FIG. 25 is a sequence chart illustrating an example of processing relating to the failure setting performed between the base server 3 and the reception terminal 11. Note that, as a premise of the processing, it is assumed that a karaoke box to be an operation target is in the state of the “vacant”.

First, the first cooperation processing unit 1103 of the reception terminal 11 displays the failure setting screen F on the display unit 116 (ACT 41) and stays on standby until a failure reason and the like are input. If receiving input of a failure reason and the like (ACT 42), the first cooperation processing unit 1103 transmits a failure occurrence notification including the store ID of the store where the reception terminal 11 is provided, a room ID of the karaoke box, and the input failure reason to the base server 3 (ACT 43).

If receiving the failure occurrence notification, the state management unit 311 of the base server 3 switches a state of the state management DB 335 corresponding to the room ID indicated by the failure occurrence notification from the “vacant” to the “out of order” (ACT 44). The state management unit 311 registers an operation result of the karaoke box, the state of which was switched, in the operation result DB 338 (ACT 45).

Accordingly, in the reception terminal 11, the karaoke box in which the failure occurred is displayed to be identifiable. Therefore, the operator of the reception terminal 11 can easily check, from the room list screen or the like, a karaoke box that cannot be used at the present point in time.

Referring back to FIG. 19, the return to cleaning button Cc of the vacancy selection screen C is an operation piece operated if the karaoke box in the “vacant” state is returned to the state of the “cleaning”. If receiving operation of the return to cleaning button Cc, the first cooperation processing unit 1103 displays a return to cleaning screen (not illustrated) including an operation piece for instructing to return the state to the cleaning.

If receiving the instruction to return to the cleaning from the return to cleaning screen, the first cooperation processing unit 1103 transmits a return to cleaning instruction including, for example, a room ID of the karaoke box for which the operation was performed to the base server 3. Note that the first cooperation processing unit 1103 may transmit the return to cleaning instruction including the employee ID of the operator to the base server 3.

If receiving the return to cleaning instruction, the state management unit 311 of the base server 3 specifies, from the state management DB 335, a data entry corresponding to the store ID and the room ID indicated by the return to cleaning instruction. Subsequently, the state management unit 311 switches a room state of the specified data entry from the “vacant” to the “cleaning”. Thus, the reception terminal 11 updates, according to the switching of the state of the karaoke box, display of the room button Bc corresponding to the state.

Subsequently, a screen example displayed if the room button Bc of the “staying” state is operated is explained. If receiving operation on the room button Bc of the “staying” state, the first cooperation processing unit 1103 causes the display unit 116 to display a staying selection screen G including operation pieces for performing operation such as commodity order reception, halfway entrance, halfway exit, complaint registration, room movement, and check-out.

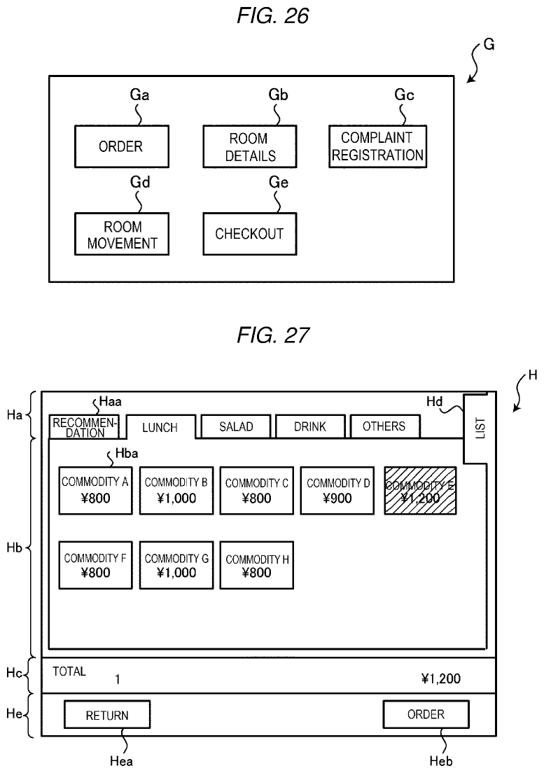

FIG. 26 is a diagram illustrating an example of the staying selection screen displayed on the reception terminal 11. As illustrated in FIG. 26, the staying selection screen G includes operation pieces such as an order button Ga, a room details button Gb, a complaint registration button Gc, a room movement button Gd, and a checkout button Ge.

The order button Ga is an operation piece for performing order of a commodity received from the user of the karaoke box. If receiving operation of the order button Ga, the first cooperation processing unit 1103 transmits, to the base server 3, a commodity menu request indicating the store ID of the store where the reception terminal 11 is provided and the room ID of the karaoke box for which the operation was performed.

If receiving the commodity menu request from the reception terminal 11, the information provision unit 317 of the base server 3 provides, based on the commodity management DB 333, support information including commodity information of orderable commodities to the reception terminal 11 that transmitted the commodity menu request.

For example, if specifying, from the check-in management DB 336, a data entry corresponding to a set of the store ID and the room ID indicated by the reception terminal 11, the information provision unit 317 of the base server 3 extracts an orderable commodity from the commodity management DB 333 based on, for example, age categories of users included in the data entry.

As an example, if a minor is included in the users, the information provision unit 317 provides support information for supporting commodity order operation to the reception terminal 11 based on commodity information of the remaining commodities obtained by excluding, based on restrictions set for commodities, commodities not allowed to be provided to minors. If information capable of specifying the use who placed an order is indicated, the information provision unit 317 of the base server 3 may extract commodity information based on an age category of the relevant user.

If receiving the support information from the base server 3 as a response to the commodity menu request, the first cooperation processing unit 1103 causes, based on the support information, the display unit 116 to display a commodity menu screen on which a commodity can be ordered.

FIG. 27 is a diagram illustrating an example of the commodity menu screen displayed on the reception terminal 11. As illustrated in FIG. 27, a commodity menu screen H includes a category selection field Ha, a commodity menu field Hb, an amount field Hc, a list button Hd, and an operation piece field He.

In the category selection field Ha, tab operation pieces Haa divided according to, for example, categories of commodities are displayed. If the tab operation piece Haa is selected, commodities belonging to a division of an operated tab operation piece are displayed in the commodity menu field Hb. Note that, in FIG. 25, an example is illustrated in which tab operation pieces are provided for each of divisions of a recommended commodity, a lunch, a salad, a dessert, a drink, and others (rental good and the like). In FIG. 27, an example is illustrated in which the tab operation piece Haa of lunch is selected.

In the commodity menu field Hb, commodity buttons Hba representing commodities are displayed. Commodity IDs of commodities corresponding to the commodity buttons Hba are correlated with the commodity buttons Hba. Commodity information such as commodity names and prices of the commodities corresponding to the commodity IDs is displayed on the commodity buttons Hba. The commodity buttons Hba also function as operation pieces for selecting order target commodities.

If receiving selection operation for the commodity button Hba, the first cooperation processing unit 1103 retains, in the RAM or the like, the commodity ID of the selected commodity button Hba and the number of times the commodity button Hba was selected (the number of items) in association. In the following explanation, processing for retaining the commodity ID and the number of items relating to the selected commodity is referred to as “sales registration” as well.

In the amount field Hc, a total number of items of the commodity selected from the commodity menu field Hb and a total amount are displayed. The first cooperation processing unit 1103 displays, based on the commodity ID and the number of items of the commodity subjected to the sales registration, a price of the commodity corresponding to the commodity ID, and the like, the total number of items of the commodity selected from the commodity menu field Hb and the total amount in the amount field Hc. Note that, if a price-cut or a discount is applied, the first cooperation processing unit 1103 may display an amount of the price-cut or the discount in the amount field Hc.

A list button Hd is provided. The list button Hd is an operation piece for instructing to display a list of commodities subjected to the sales registration. If receiving operation of the list button Hd, the first cooperation processing unit 1103 displays a list screen (not illustrated) on which commodity names, prices, the numbers of items, and the like of commodities subjected to sales registration are displayed as a list for each of the commodities. In the list screen, the commodities subjected to the sales registration can be checked and addition or deletion of the number of times, cancellation of a commodity, and the like can be performed. The first cooperation processing unit 1103 changes the numbers of item of a commodity subjected to the sales registration and cancels the commodity according to a change of the number of items and cancellation operation.

In the operation piece field He, various operation pieces relating to commodity order are displayed. For example, in the operation piece field He, a return button Hea, an order button Heb, and the like are provided. The return button Hea is an operation piece for instructing to return to a screen at a transition source. The order button Heb is an operation piece for instructing to decide an order.

If the return button Hea is operated, the first cooperation processing unit 1103 cooperates with the base server 3 to display a screen at a transition source. If the order button Heb is operated, the first cooperation processing unit 1103 transmits, to the base server 3, order information including the store ID of the store where the reception terminal 11 is provided, a room ID of a karaoke box for which the operation was performed, and a commodity ID and the number of items of the commodity subjected to the sales registration.

If receiving the order information from the reception terminal 11, the order reception unit 314 of the base server 3 specifies, from the check-in management DB 336, a data entry corresponding to a set of the store ID and the room ID indicated by the order information. Then, the order reception unit 314 registers order content included in the order information, that is, the commodity ID and the number of items of the ordered commodity in an order information field of the specified data entry. The order reception unit 314 of the base serve 3 transmits the room ID and the order content to the kitchen terminal 13 and the store clerk terminal 14 of the store ID indicated by the order information to notify that the user ordered the commodity.

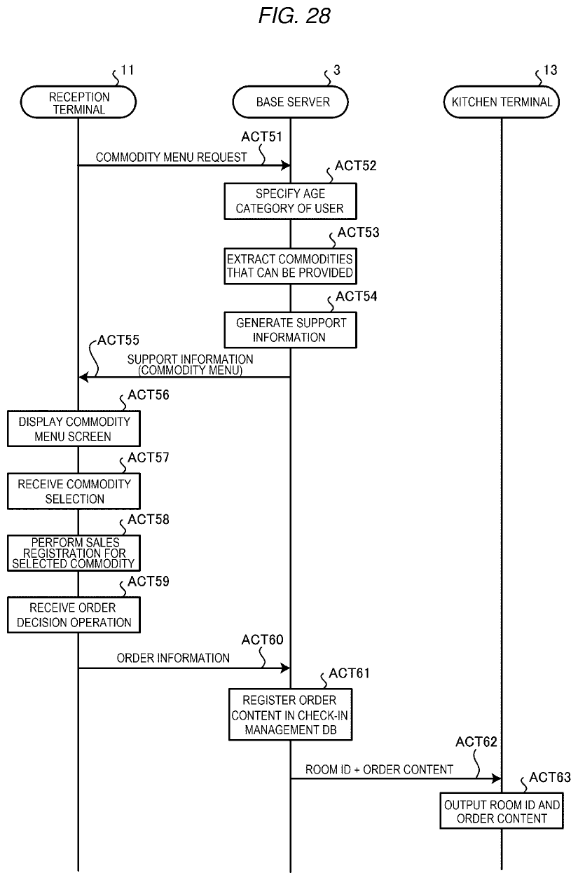

Here, operation examples of the base server 3 and the reception terminal 11 relating to the commodity order explained above are explained. FIG. 28 is a sequence chart illustrating an example of processing relating to a commodity order performed between the base server 3 and the reception terminal 11. Note that, as a premise of the processing, it is assumed that a karaoke box to be an operation target is in the state of the “staying”.

First, the first cooperation processing unit 1103 of the reception terminal 11 transmits, according to operation of the order button Ga or the like, a commodity menu request including the store ID of the store where the reception terminal 11 is provided and a room ID of a karaoke box being used by a user who orders a commodity to the base server 3 (ACT 51).

If receiving the commodity menu request, the information provision unit 317 of the base server 3 specifies an age category of the user based on a data entry of the check-in management DB 336 corresponding to a set of the store ID and the room ID indicated by the commodity menu request (ACT 52). Subsequently, the information provision unit 317 extracts, from the commodity management DB 333, based on the restrictions and the like set for the commodities of the commodity management DB 333, commodity information of commodities provided in the store of the store ID indicated by the commodity menu request and providable to the user (ACT 53). Subsequently, the information provision unit 317 generates, based on the extracted commodity information, support information for supporting commodity order operation such as a commodity menu (ACT 54) and provides the generated support information to the reception terminal 11 (ACT 55).

If receiving the support information as a response to the commodity menu request, the first cooperation processing unit 1103 of the reception terminal 11 displays the commodity menu screen H on the display unit 116 based on the support information. If receiving commodity selection operation via the commodity menu screen H (ACT 57), the first cooperation processing unit 1103 performs sales registration for the commodity (ACT 58). Then, if receiving order decision operation with the order button Heb or the like (ACT 59), the first cooperation processing unit 1103 transmits, to the base server 3, order information including the store ID of the store where the reception terminal 11 is provided, a room ID of a karaoke box for which the operation was performed, and a commodity ID and the number of items of the commodity subjected to the sales registration (ACT 60).

If receiving the order information, the order reception unit 314 of the base server 3 registers order content included in the order information in a data entry of the check-in management DB 336 corresponding to a set of the store ID and the room ID indicated by the order information (ACT 61). Subsequently, the order reception unit 314 transmits the indicated room ID and the order content to the kitchen terminal 13 of the store ID indicated by the order information (ACT 62).

The kitchen terminal 13 outputs the room ID and the order content transmitted from the base server 3 (ACT 63) to inform an operator in a kitchen that the user ordered the commodity.

According to the processing explained above, the order content of the commodity ordered by the user using the karaoke box and the room ID of the karaoke box are notified to a person in charge or the like of the kitchen. Accordingly, the commodity ordered by the user is delivered to the karaoke box used by the user.

Note that, in the present embodiment, an example is explained in which a commodity is ordered using the reception terminal 11. However, not only this, but an order performed using the user terminal 4, the order terminal 12, or the like can be implemented by the same method. Specifically, according to operation of the operator, the user terminal 4 or the order terminal 12 cooperates with the base server 3 to display a screen on which a commodity can be ordered such as the commodity menu screen H explained above and transmits order information to the base server 3.

Referring back to FIG. 26, the room details button Gb of the staying selection screen G is an operation piece for displaying detailed information of the karaoke box for which the operation was performed. If receiving operation of the room details button Gb, the first cooperation processing unit 1103 transmits, to the base server 3, a room details request including the store ID of the store where the reception terminal 11 is provided and the room ID of the karaoke box for which the operation was performed.

If receiving the room details request from the reception terminal 11, the information provision unit 317 of the base server 3 specifies, from the check-in management DB 336, a data entry corresponding to a condition of a set of the store ID and the room ID indicated by the room details request. Subsequently, the information provision unit 317 provides, based on the specified data entry, support information indicating details of the karaoke box being used to the reception terminal 11 that transmitted the room details request.

If transmitting the room details request to the base server 3, the first cooperation processing unit 1103 causes, based on the support information provided from the base server 3, the display unit 116 to display a room details screen showing the details of the karaoke box being used.

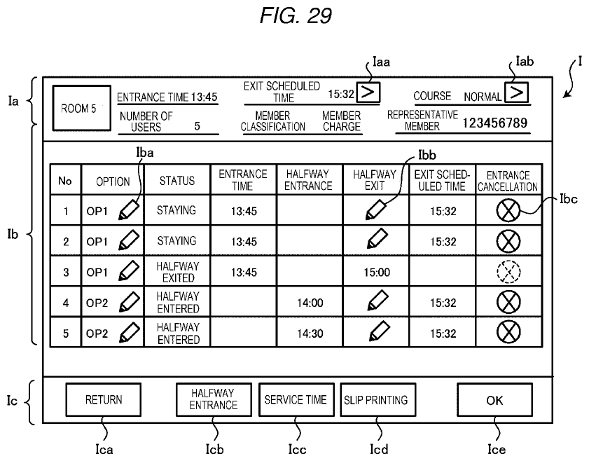

FIG. 29 is a diagram illustrating an example of the room details screen displayed on the reception terminal 11. As illustrated in FIG. 29, a room details screen I includes a detailed information field Ia, a user information field Ib, and an operation piece field Ic.

In the detailed information field Ia, besides a room name “room 5” of the karaoke box for which the operation was performed, for example, information concerning the user using the karaoke box is displayed. Specifically, in the detailed information field Ia, entrance time (an entrance date and time), exit scheduled time (an exit scheduled date and time), a course (a room course), the number of users, a member classification, a member charge, a representative member (representative information), and the like are displayed. Here, the member classification and the member charge are information displayed if a member is included in users.

In the detailed information field Ia, a date and time change button Iaa is displayed in association with the exit scheduled date and time. The date and time change button Iaa is an operation piece for instructing to change the exit schedule date and time. If receiving operation of the date and time change button Iaa, the first cooperation processing unit 1103 displays a time change screen (not illustrated) on which the exit scheduled date and time can be extended or reduced. On the time change screen, a time to be added or reduced can be designated. For example, an operation piece capable of designating, in units of thirty minutes, the time to be added or reduced is provided on the time change screen.

If the time to be added or reduced is designated, the first cooperation processing unit 1103 transmits, to the base server 3, a change instruction including the store ID of the store where the reception terminal 11 is provided, the room ID of the karaoke box for which the operation was performed, and the time to be added or reduced.

The check-in processing unit 313 of the base server 3 specifies, according to the change instruction, from the check-in management DB 336, a data entry corresponding to conditions of the indicated store ID and the indicated room ID. Then, the check-in processing unit 313 adds or subtracts the time indicated by the change instruction to or from a use scheduled time and a use scheduled date and time included in the specified data entry. According to the addition or the subtraction of the time, the exit scheduled time of the detailed information field Ia is updated to the exit scheduled time after the change.

Note that it is preferable that the check-in processing unit 313 is configured to, in adding the time, refer to the reservation management DB 337 and add the time after checking reservation situations of the store ID and the room ID indicated by the change instruction. Specifically, the check-in processing unit 313 may be configured to add the time if determining that the use scheduled date and time after the change does not interfere with a reservation date and time set in the same karaoke box.

The check-in processing unit 313 may be configured to, in adding the time, refer to the basic information DB 334 and add the time after confirming that extension impossibility is not set. If confirming that the use schedule date and time after the change interferes with the reservation date and time or the extension impossibility is set, the check-in processing unit 313 transmits, to the reception terminal 11 that transmitted the change instruction, response information informing that the time cannot be extended.

In the detailed information field Ia, a course change button Iab is displayed in association with a room course. The course change button Iab is an operation piece for instructing to change the room course. If receiving operation of the course change button Iab, the first cooperation processing unit 1103 displays a course change screen (not illustrated) on which the room course can be changed. On the course change screen, the room course after the change can be designated. For example, on the course change screen, an operation piece of a pulldown format or the like capable of selecting the room course after the change is provided. The course change screen may include an operation piece capable of designating an application date and time when the room course after the change is applied.

If the room course after the change is designated, the first cooperation processing unit 1103 transmits, to the base server 3, a change instruction including the store ID of the store where the reception terminal 11 is provided, the room ID of the karaoke box for which the operation was performed, and the room course after the change.

The check-in processing unit 313 of the base server 3 specifies, from the check-in management DB 336, a data entry corresponding to conditions of the indicated store ID and the indicated room ID. Then, the check-in processing unit 313 changes a room course included in the specified data entry to the room course indicated by the change instruction. According to the change of the room course, the room course of the detailed information field Ia is updated to the room course after the change.

If an application date and time of the room course after the change is indicated in the change instruction, the check-in processing unit 313 changes the room course at the indicated date and time. However, it is preferable to store, in additional information or the like, information relating to the room course before the change. For example, the check-in processing unit 313 stores, in the additional information field, the room course before the change, a date and time when application of the room course before the change was started (for example, an entrance date and time), and a date and time when the application of the room course before the change was ended (for example, an application date and time of the room course after the change) in correlation. It is assumed that use amounts for the room courses before the change and after the change are respectively calculated according to continuation times.

Note that, even if the application date and time of the room course is instructed, if the continuation time of the room course before the change does not a predetermined time length (for example, thirty minutes), the check-in processing unit 313 may return response information for informing change impossibility to the reception terminal 11 that transmitted the change instruction. If the application date and time of the room course after the change is further in the past than the date and time when the application of the room course before the change was started, the check-in processing unit 313 may return response information for informing that the application times overlap. The check-in processing unit 313 may reduce the room course before the change and change the room course before the change to the room course after the change. In the latter case, if the change instruction is received from the reception terminal 11, the check-in processing unit 313 preferably changes the room course before the change to the room course after the change.

In the room course after the change, if an option of the user currently being used cannot be used, the check-in processing unit 313 may return, to the reception terminal 11 that transmitted the change instruction, response information for informing that the room course cannot be changed and a change of the option is urged. Note that it is assumed that a correspondence relation between each of room sources and options usable in the room courses is specified in advance in a form of setting information or the like.

In the user information field Ib of the room details screen I, content based on the user information of the check-in management DB 336 is displayed. Specifically, in the user information field Ib, information such as an option, an age category, a status (an entrance and exit state), entrance time (an entrance date and time), halfway entrance (a halfway entrance date and time), halfway exit (a halfway exit date and time), and exit scheduled time (an exit scheduled date and time) is displayed in correlation for each user identifier (No.).

Here, in the halfway entrance, in the case of a user whose entrance and exit state is the “halfway entered”, a halfway entrance date and time of the user is displayed. In the halfway exit, in the case of a user whose entrance and exit state is the “halfway exited”, an exit date and time of the user is displayed. In the exit scheduled time, an exit scheduled date and time of the detailed information field Ia is displayed for a user other than the user whose entrance and exit state is the halfway exited.

In the user information field Ib, an option change button Iba is displayed in association with the option. The option change button Iba is an operation piece for instructing to change the option. If receiving operation of the option change e button Iba, the first cooperation processing unit 1103 displays an option change screen (not illustrated) on which the option can be changed. On the option change screen, the option after the change can be designated. For example, on the option change screen, an operation piece of a pulldown format or the like capable of selecting the option after the change is provided.

Note that, on the option change screen, it is preferable to display choices of selectable option types based on an age category and a room course of a user. The option change screen may include an operation piece capable of designating an application date and time when the option after the change is applied.

If the option after the change is designated, the first cooperation processing unit 1103 transmits, to the base server 3, a change instruction including the store ID of the store where the reception terminal 11 is provided, the room ID of the karaoke box for which the operation was performed, a user identifier for which the operation was performed, and the option after the change.

The check-in processing unit 313 of the base server 3 specifies, according to the change instruction, from the check-in management DB 336, user information corresponding to conditions of the indicated store ID, the indicated room ID, and the indicated user identifier. The check-in processing unit 313 changes an option included in the specified user information to the option indicated by the change instruction. According to the change of the option, the option of the user identifier for which the operation was performed is updated to the option after the change in the user information field Ib.

If an application date and time of the option after the change is indicated in the change instruction, the check-in processing unit 313 changes the option at the indicated date and time. However, it is preferable to store information relating to the option before the change in the user additional information or the like. In this case, for example, the check-in processing unit 313 stores the option before the change, a date and time when application of the option before the change was started (for example, an entrance date and time), and a date and time when the application of the option before the change was ended (for example, an application date and time of the option after the change) in the additional information field in correlation. Note that use amounts of the options before the change and after the change are respectively calculated according to a continuation time.

Note that, even if the application date and time is indicated, if the continuation time of the option before the change does not reach a predetermined time length (for example, thirty minutes), the check-in processing unit 313 may return response information for informing change impossibility to the reception terminal 11 that transmitted the change instruction. If the application date and time of the option after the change is further in the past than the date and time when the application of the option before the change was started, the check-in processing unit 313 may return response information for informing that the application times overlap. The check-in processing unit 313 may reduce the option before the change and change the option before the change to the option after the change. In the latter case, if the change instruction is received from the reception terminal 11, the check-in processing unit 313 preferably changes the option before the change to the option after the change.

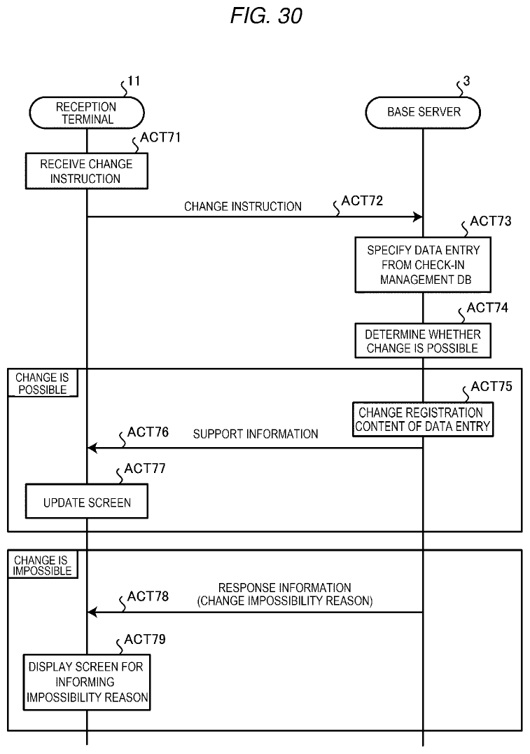

Here, operation examples of the base server 3 and the reception terminal 11 relating to the various kinds of change processing explained above are explained with reference to FIG. 30. FIG. 30 is a sequence chart illustrating an example of change processing performed between the base server 3 and the reception terminal 11. Note that, as a premise of the processing, it is assumed that the room details screen I is displayed on the display unit 116 of the reception terminal 11.

If receiving, via the room details screen I, operation for instructing to change an exit scheduled date and time, a room course, an option, and the like (ACT 71), the first cooperation processing unit 1103 of the reception terminal 11 transmits, to the base server 3, a change instruction including the store ID of the store where the reception terminal 11 is provided, a room ID of a karaoke box for which the operation was performed, and change content (ACT 72).

If receiving the change instruction, the check-in processing unit 313 of the base server 3 specifies, from the check-in management DB 336, a data entry corresponding to a set of the store ID and the room ID indicated by the change instruction (ACT 73). Subsequently, the check-in processing unit 313 determines, based on reservation information of the reservation management DB 337 correlated with the same room ID, an age category of a user included in the data entry, and the like, whether a change to the change content indicated by the change instruction is possible (ACT 74).

If determining that the change is possible, the check-in processing unit 313 of the base server 3 changes registration content in the specified data entry based on the indicated change content (ACT 75). Subsequently, the check-in processing unit 313 cooperates with the alert processing unit 318 to transmit support information reflecting the change content to the reception terminal 11 (ACT 76). Note that, if a date and time when a change is applied is designated in the change instruction, the check-in processing unit 313 changes the registration content at the designated date and time.

The first cooperation processing unit 1103 of the reception terminal 11 displays the room details screen I and the like based on the support information provided from the base server 3 to perform update to a screen reflecting the change content (ACT 77).

If determining that the change is impossible, the check-in processing unit 313 of the base server 3 cooperates with the alert processing unit 318 to transmit response information including a reason for the change impossibility to the reception terminal 11 (ACT 78). In this case, the first cooperation processing unit 1103 of the reception terminal 11 displays, for example, the reason for the change impossibility based on the response information provided from the base server 3 (ACT 79). Accordingly, the operator of the reception terminal 11 can, for example, easily review the change content based on the displayed reason for the change impossibility.

Referring back to FIG. 29, a halfway exit button Ibb for indicating halfway exit is displayed in the halfway exit field of the user information field Ib. The halfway exit button Ibb is an operation piece for indicating a user who exits the karaoke box halfway. If receiving operation of the halfway exit button Ibb, the first cooperation processing unit 1103 displays a halfway exit screen on which exit time (date and time) can be designated.

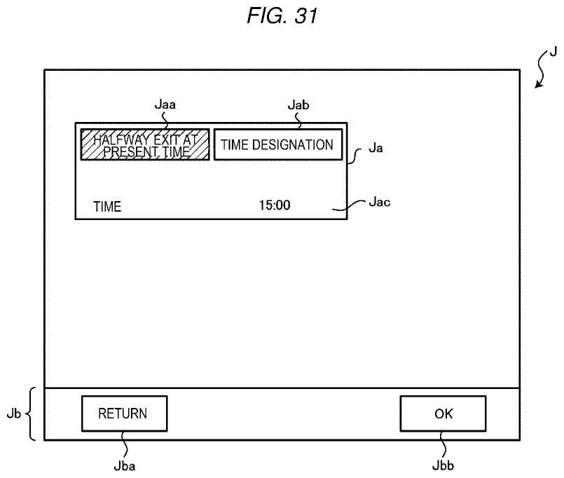

FIG. 31 is a diagram illustrating an example of the halfway exit screen displayed on the reception terminal 11. As illustrated in FIG. 31, a halfway exit screen J includes a time input field Ja and an operation piece field Jb. The time input field Ja includes, for example, a present time button Jaa capable of designating present time, a time designation button Jab for designating any time, and a time display field Jac.

If receiving operation of the present time button Jaa, the first cooperation processing unit 1103 of the reception terminal 11 displays the present time in the time display field Jac. If receiving operation of the time designation button Jab, the first cooperation processing unit 1103 receives time input to the time display field Jac via the operation unit 117. Note that it is assumed that time that can be input is within a range of the present time to a use scheduled date and time.

In the operation piece field Jb, a return button Jba and an OK button Jbb are displayed. The return button Jba is an operation piece for instructing to return to a screen at a transition source. If the return button Jba is operated, the first cooperation processing unit 1103 cooperates with the base server 3 to display the screen at the transition source.

The OK button Jbb is an operation piece for instructing to decide halfway exit time. If the OK button Jbb is operated, the first cooperation processing unit 1103 transmits, to the base server 3, a halfway exit instruction including the store ID of the store where the reception terminal 11 is provided, a room ID of a karaoke box for which the operation was performed, a user identifier for which the operation was performed, and time (date and time) displayed in the time display field Jac.

The check-out processing unit 316 of the base server 3 specifies, according to the halfway exit instruction, from the check-in management DB 336, user information corresponding to conditions of the store ID, the room ID, and the user identifier indicated by the halfway exit instruction. Then, the check-out processing unit 316 switches an entrance and exit state included in the specified user information to the “halfway exited” and registers time indicated by the halfway exit instruction in the halfway exit date and time.

Note that operation pieces provided in the operation piece field Jb are not limited to the examples explained above. For example, an operation piece for instructing to perform checkout for a user who exits the karaoke box halfway (hereinafter referred to as halfway checkout button) may be provided. An operation example in the case in which the halfway checkout button is provided is explained below.

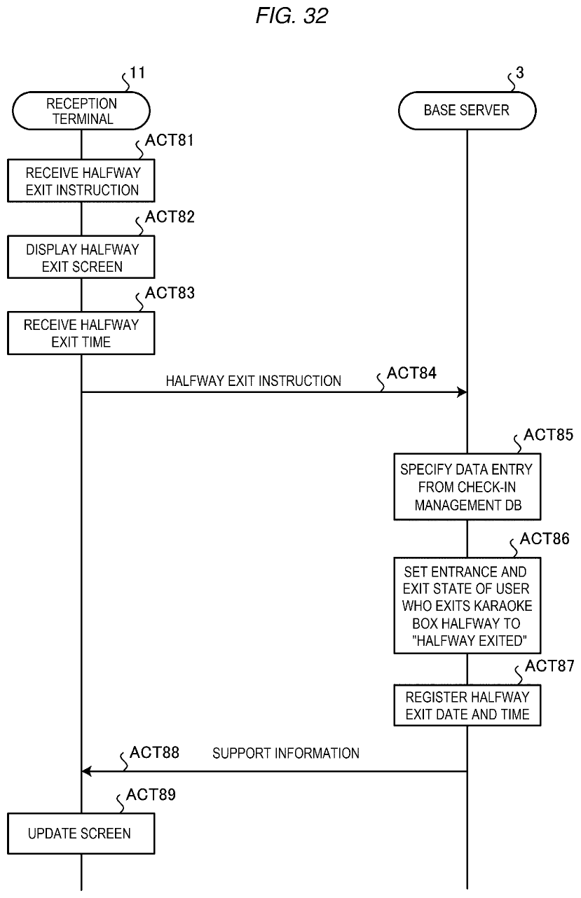

Here, operation examples of the base server 3 and the reception terminal 11 relating to the halfway exit of the user explained above are explained with reference to FIG. 32. FIG. 32 is a sequence chart illustrating an example of processing relating to halfway exit performed between the base server 3 and the reception terminal 11. Note that, as a premise of the processing, it is assumed that the room details screen I is displayed on the display unit 116 of the reception terminal 11.

If receiving, according to operation of, for example, the halfway exit button Ibb displayed on the room details screen I, operation for instructing a specific user identifier to exit a karaoke box halfway (ACT 81), the first cooperation processing unit 1103 of the reception terminal 11 displays the halfway exit screen J explained above (ACT 82). Subsequently, if receiving designation of halfway exit time via the halfway exit screen J (ACT 83), the first cooperation processing unit 1103 transmits, to the base server 3, a halfway exit instruction including the store ID of the store where the reception terminal 11 is provided, a room ID of a karaoke box for which the operation was performed, a user identifier of the user who exits the karaoke box halfway, and the designated halfway exit time (ACT 84).

If receiving the halfway exit instruction, the check-in processing unit 313 of the base server 3 specifies, from the check-in management DB 336, a data entry corresponding to a set of the store ID and the room ID indicated by the change instruction (ACT 85). Subsequently, the check-in processing unit 313 sets an entrance and exit state of, among user identifiers included in user information of the specified data entry, the user identifier indicated by the halfway exit instruction to the “halfway exited” (ACT 86) and registers time indicated by the halfway exit instruction in a halfway exit date and time field (ACT 87). Subsequently, the check-in processing unit 313 cooperates with the alert processing unit 318 to transmit support information reflecting registration content to the reception terminal 11 (ACT 88).

The first cooperation processing unit 1103 of the reception terminal 11 displays the room details screen I or the like based on the support information provided from the base server 3 to perform update to a screen reflecting the registration content (ACT 89).

Accordingly, the facility management system 100 can individually record users who exit the karaoke box halfway. Therefore, the facility management system 100 can individually manage, for each of the users, the users who use the karaoke box.

Referring back to FIG. 29, an entrance cancellation button Ibc for instructing to cancel entrance is displayed in the user information field Ib in correlation with each of user identifiers. The entrance cancellation button Ibc is an operation piece for indicating a user for whom entrance is cancelled. Note that the entrance cancellation button Ibc is disabled for a user identifier for which a halfway exit date and time is registered and a user identifier for which an entrance and exit state is the “entrance cancelled”.

If receiving operation of the entrance cancellation button Ibc, the first cooperation processing unit 1103 transmits, to the base server 3, an entrance cancellation instruction including the store ID of the store where the reception terminal 11 is provided, a room ID of a karaoke box for which the operation was performed, and a user identifier for which the operation was performed.

The check-in processing unit 313 of the base server 3 specifies, according to the entrance cancellation instruction, from the check-in management DB 336, user information corresponding to conditions of the indicated store ID, the indicated room ID, and the indicated user identifier. Then, the check-in processing unit 313 switches an entrance and exit state included in the specified user information to the “entrance cancelled”. According to the switch of the entrance and exit state, in the user information field Ib of the reception terminal 11, a status of the user identifier for which entrance was cancelled is updated to the “entrance cancelled”.

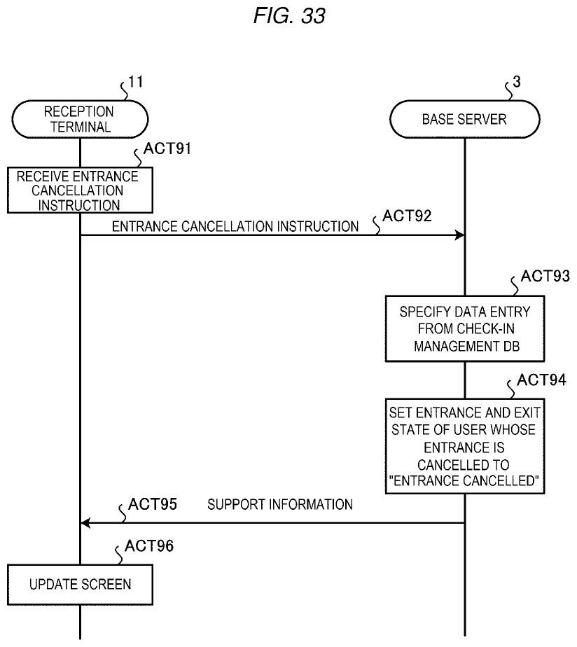

Here, operation examples of the base server 3 and the reception terminal 11 relating to the entrance cancellation for the user explained above are explained. FIG. 33 is a sequence chart illustrating an example of processing relating to entrance cancellation performed between the base server 3 and the reception terminal 11. Note that, as a premise of the processing, it is assumed that the room details screen I is displayed on the display unit 116 of the reception terminal 11.

If receiving, according to operation of the entrance cancellation button Ibc or the like displayed on the room details screen I, operation for instructing a specific user identifier to cancel entrance (ACT 91), the first cooperation processing unit 1103 of the reception terminal 11 transmits, to the base server 3, an entrance cancellation instruction including the room ID of the store where the reception terminal 11 is provided, a room ID of a karaoke box for which the operation was performed, and a user identifier for which entrance cancellation is performed (ACT 92).

If receiving the entrance cancellation instruction, the check-in processing unit 313 of the base server 3 specifies, from the check-in management DB 336, a data entry corresponding to a set of the store ID and the room ID indicated by the entrance cancellation instruction (ACT 93). Subsequently, the check-in processing unit 313 sets an entrance and exit state of, among user identifiers included in user information of the specified data entry, the user identifier indicated by the entrance cancellation instruction to the “entrance cancelled” (ACT 94). Subsequently, the check-in processing unit 313 cooperates with the alert processing unit 318 to transmit support information reflecting registration content to the reception terminal 11 (ACT 95).

The first cooperation processing unit 1103 of the reception terminal 11 displays the room details screen I or the like based on the support information provided from the base server 3 to perform update to a screen reflecting the registration content (ACT 96).

Accordingly, the facility management system 100 can easily perform entrance cancellation operation, for example, if the operator of the reception terminal 11 registers a user by mistake. Note that the operation of the entrance cancellation may be configured to switch enabling and disabling according to an authority of the operator (an authority of an employee) or the like.

Referring back to FIG. 29, various operation pieces are displayed in the operation piece field Ic of the room details screen I. For example, in the operation piece field Ic, a return button Ica, a halfway entrance button Ich, a service time button Icc, a slip printing button Icd, an OK button Ice, and the like are provided.

The return button Ica is an operation piece for instructing to return to a screen at a transition source. If the return button Ica is operated, the first cooperation processing unit 1103 cooperates with the base server 3 to display the screen at the transition source.

The halfway entrance button Ich is an operation piece for instructing to add a user who enters halfway. If receiving operation of the halfway entrance button Ich, the first cooperation processing unit 1103 displays a number of users addition screen on which an instruction to add a target user can be performed.

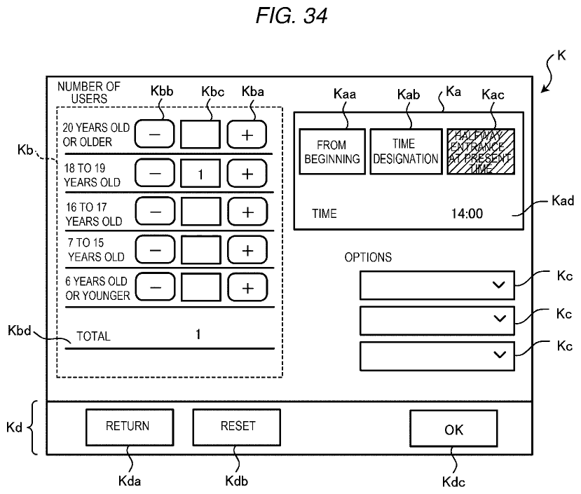

FIG. 34 is a diagram illustrating an example of the number of users addition screen displayed on the reception terminal 11. As illustrated in FIG. 34, a number of users addition screen K includes a time input field Ka, a number of users input field Kb, an option input field Kc, and an operation piece field kd.

In the time input field Ka, time of halfway entrance can be input. For example, in the time input field Ka, a from beginning button Kaa capable of designating an entrance date and time, a time designation button Kab for designating any time, a present time button Kac capable of designating the present time, and a time display field Kad are provided.

If receiving operation of the from beginning button Kaa, the first cooperation processing unit 1103 of the reception terminal 11 displays, based on, for example, user information for which the operation was performed, time set as the entrance date and time in the time display field Kad. If receiving operation of the time designation button Kab, the first cooperation processing unit 1103 displays time input via the operation unit 117 in the time display field Kad. Note that time that can be input is within a range of the entrance date and time to a use scheduled date and time. If receiving operation of the present time button Kac, the first cooperation processing unit 1103 of the reception terminal 11 displays the present time in the time display field Kad.

In the number of users input field Kb, the number of users to be added and attributes of the users can be input. For example, in the number of users input field Kb, a + button Kba and a − button Kbb capable of designating the number of users for each age category and a number of users display field Kbc are provided. A total number of users display field Kbd is provided in the number of users input field Kb. Note that the number of users input field Kb is the same as the number of users input field Ea explained above.

In the option input field Kc, an option to be used by a user to be added can be designated. Note that the option input field Kc is the same as the option input field Ec explained above.

In the operation piece field Kd, various operation pieces are displayed. For example, in the operation piece field Kd, a return button Kda, a reset button Kdb, an OK button Kdc, and the like are provided.

The return button Kda is an operation piece for instructing to return to a screen at a transition source. If the return button Kda is operated, the first cooperation processing unit 1103 cooperates with the base server 3 to display the screen at the transition source.

The reset button Kdb is an operation piece for instructing to reset information input to the number of users addition screen K. If the reset button Kdb is operated, the first cooperation processing unit 1103 clears various kinds of information input to the number of users addition screen K.

The OK button Kdc is an operation piece for instructing to decide information input to the number of users addition screen K. If the OK button Kdc is operated, the first cooperation processing unit 1103 transmits, to the base server 3, a halfway entrance instruction including the store ID of the store where the reception terminal 11 is provided, a room ID of a karaoke box for which the operation was performed, and various kinds of information input to the number of users addition screen K.

Note that, prior to the number of users addition screen K, the first cooperation processing unit 1103 may display an input screen for inputting user information of a user to be added (for example, a user information input screen D). In this case, the first cooperation processing unit 1103 transmits, to the base server 3, a halfway entrance instruction including user information of users to be added.

The check-in processing unit 313 of the base server 3 specifies, according to the halfway entrance instruction, from the check-in management DB 336, a data record corresponding to conditions of the indicated store ID and the indicated room ID. The check-in processing unit 313 adds information concerning the users indicated by the halfway entrance instruction to user information included in the specified data record. Here, the check-in processing unit 313 registers the “halfway entered” in an entrance and exit state of an added user identifier and registers, as a halfway entrance date and time, time indicated by the halfway entrance instruction. According to the registration, in the reception terminal 11, the information concerning the added user is reflected on the various screens.

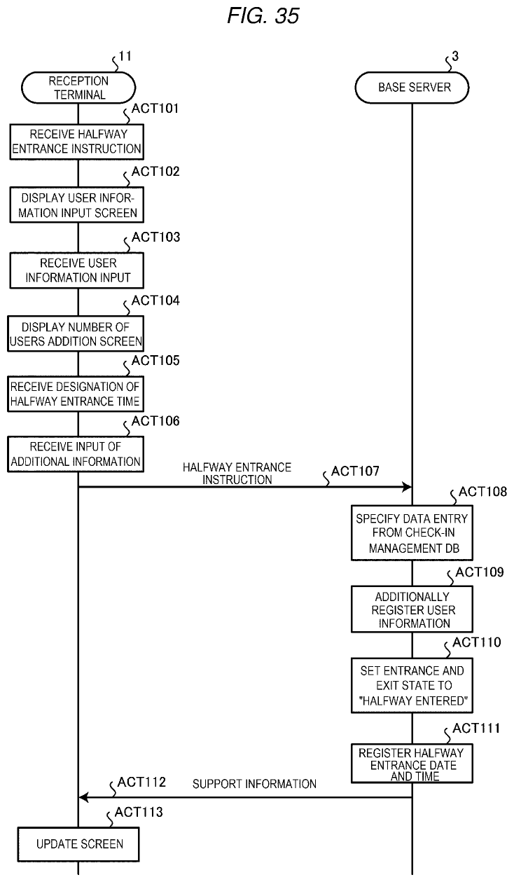

Here, operation examples of the base server 3 and the reception terminal 11 relating to the halfway entrance of the user explained above are explained with reference to FIG. 35. FIG. 35 is a sequence chart illustrating an example of processing relating to halfway entrance performed between the base server 3 and the reception terminal 11. Note that, as a premise of the processing, it is assumed that the room details screen I is displayed on the display unit 116 of the reception terminal 11. In the processing, an operation example in the case in which the user information input screen D is displayed prior to the number of users addition screen K is explained.

If receiving, according to operation of the halfway entrance button Ich or the like displayed on the room details screen I, operation for indicating halfway entrance of a user (ACT 101), the first cooperation processing unit 1103 of the reception terminal 11 displays the user information input screen D on the display unit 116 (ACT 102).

If receiving, via the user information input screen D, input of user information of the user who enters a karaoke box halfway (ACT 103), the first cooperation processing unit 1103 of the reception terminal 11 displays the number of users addition screen K on the display unit 116 (ACT 104).

The first cooperation processing unit 1103 receives designation of time of the halfway entrance on the number of users addition screen K (ACT 105). The first cooperation processing unit 1103 receives input of addition information such as an option on the number of users addition screen K (ACT 106). If decision of information relating to the user who enters the karaoke box halfway is instructed via the OK button Kdc or the like, the first cooperation processing unit 1103 transmits, to the base server 3, a halfway entrance instruction including the store ID of the store where the reception terminal 11 is provided, a room ID of a karaoke box, the user information, and the addition information (ACT 107).

If receiving the halfway entrance instruction, the check-in processing unit 313 of the base server 3 specifies, from the check-in management DB 336, a data entry corresponding to a set of the store ID and the room ID indicated by the halfway entrance instruction (ACT 108). Subsequently, the check-in processing unit 313 additionally registers the user information and the additional information indicated by the halfway entrance instruction in a user information field of the specified data entry (ACT 109).

The check-in processing unit 313 of the base server 3 sets an entrance and exit state of the added user information to the “halfway entered” (ACT 110) and registers time indicated by the halfway entrance instruction in a halfway entrance date and time field (ACT 111). Subsequently, the check-in processing unit 313 cooperates with the alert processing unit 318 to transmit support information reflecting registration content to the reception terminal 11 (ACT 112).

The first cooperation processing unit 1103 of the reception terminal 11 updates the room details screen I or the like based on the support information provided from the base server 3 to display a screen reflecting the registration content (ACT 113).

Accordingly, the facility management system 100 can individually record users who enter the karaoke box halfway. Therefore, the facility management system 100 can individually mange, for each of users, the users who use the karaoke box.

Referring back to FIG. 29, the service time button Icc provided in the operation piece field Ic of the room details screen I is an operation piece for instructing to grant a service time. The service time is a free-of-charge extension time provided from the store if the user is bothered because of some reason such as an inconvenience of the store. As an example, the service time is granted if a complaint is received form the user.

If receiving operation of the service time button Icc, the first cooperation processing unit 1103 displays a service time setting screen on which the service time can be set.

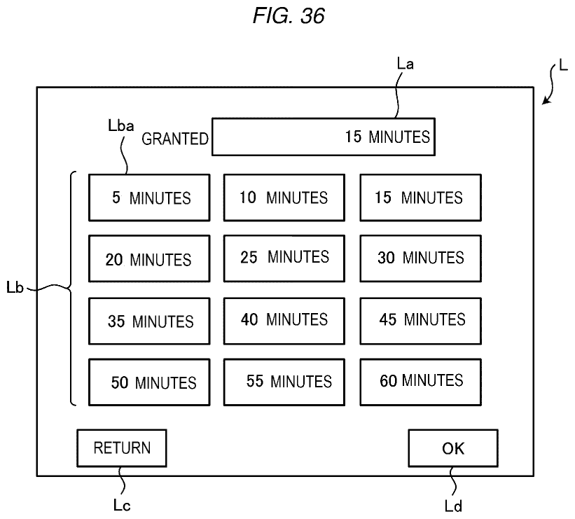

FIG. 36 is a diagram illustrating an example of the service time setting screen displayed on the reception terminal 11. As illustrated in FIG. 36, a service time setting screen L includes a grant finish display field La, a time selection field Lb, a return button Lc, and an OK button Ld.

In the grant finish display field La, a granted service time is displayed. In the time selection field Lb, a time button Lba is displayed. The time button Lba is an operation piece representing a time length of the service time. A plurality of time buttons Lba are provided at a predetermined time length (five minutes) interval. The operator operates any one of the time buttons Lba displayed in the time selection field Lb to select a time of a service time to be granted anew.

The return button Lc is an operation piece for instructing to return to a screen at a transition source. If the return button Lc is operated, the first cooperation processing unit 1103 cooperates with the base server 3 to display the screen at the transition source.

The OK button Ld is an operation piece for instructing to decide the time selected in the time selection field Lb. If the OK button Ld is operated, the first cooperation processing unit 1103 transmits, to the base server 3, a service time grant instruction including the store ID of the store where the reception terminal 11 is provided, a room ID of a karaoke box for which the operation was performed, and the time selected in the time selection field Lb.

The check-in processing unit 313 of the base server 3 specifies, according to the service time grant instruction, from the check-in management DB 336, a data record corresponding to conditions of the indicated store ID and the indicated room ID. The check-in processing unit 313 registers the time indicated by the service time grant instruction in a service time field included in the specified data record. The check-in processing unit 313 adds the time registered in the service time field to an exit scheduled date and time included in the specified data record. According to the addition of the time, in the reception terminal 11, for example, the exit scheduled date and time to which the service time is granted is displayed on various screens.

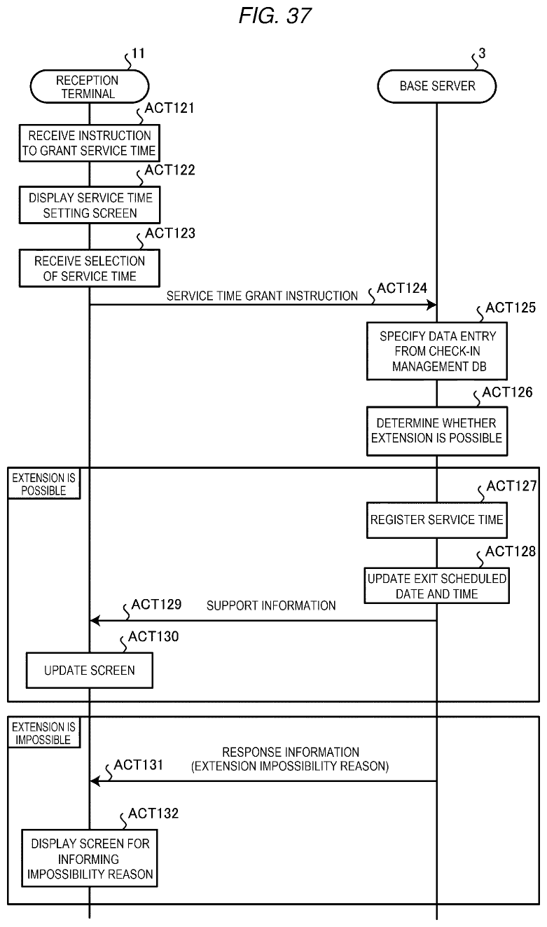

Here, operation examples of the base server 3 and the reception terminal 11 relating to the grant of the service time explained above are explained with reference to FIG. 37. FIG. 37 is a sequence chart illustrating an example of processing relating to grant of a service time performed between the base server 3 and the reception terminal 11. Note that, as a premise of the processing, it is assumed that the room details screen I is displayed on the display unit 116 of the reception terminal 11.

If receiving, according to operation of the service time button Icc or the like, operation for instructing to grant a service time (ACT 121), the first cooperation processing unit 1103 of the reception terminal 11 displays the service time setting screen L on the display unit 116 (ACT 122).

The first cooperation processing unit 1103 receives time selection for the service time to be granted on the service time setting screen L (ACT 123). If decision of the service time is instructed via the OK button Ld or the like, the first cooperation processing unit 1103 transmits, to the base server 3, a service time grant instruction including the store ID of the store where the reception terminal 11 is provided, a room ID of a karaoke box, and a time of the service time to be granted (ACT 124).

If receiving the service time grant instruction, the check-in processing unit 313 of the base server 3 specifies, from the check-in management DB 336, a data entry corresponding to a set of the store ID and the room ID indicated by the service time grant instruction (ACT 125). Subsequently, the check-in processing unit 313 determines, based on, for example, reservation information of the reservation management DB 337 correlated with the same room ID, whether extension to the time indicated by the service time grant instruction is possible (ACT 126).

Specifically, the check-in processing unit 313 determines whether a date and time obtained by adding the time of the service time to an exit scheduled date and time interferes with a reservation date and time of most recent reservation information correlated with the same karaoke box. Here, the check-in processing unit 313 determines that the extension is possible if the date and time does not interfere with the reservation date and time and determines that the extension is impossible if the date and time interferes with the reservation date and time.

If determining that the extension is possible, the check-in processing unit 313 of the base server 3 registers the time indicated by the service time grant instruction in the service time field included in the specified data record (ACT 127). The check-in processing unit 313 updates the exit scheduled date and time by adding the time registered in the service time field to the exit scheduled date and time included in the specified data record (ACT 128). Subsequently, the check-in processing unit 313 cooperates with the alert processing unit 318 to transmit support information reflecting registration content to the reception terminal 11 (ACT 129).

The first cooperation processing unit 1103 of the reception terminal 11 updates the room details screen I or the like based on the support information provided from the base server 3 to display a screen reflecting the registration content (ACT 130).

If determining that the extension is impossible, the check-in processing unit 313 of the base server 3 cooperates with the alert processing unit 318 to transmit response information a reason for the extension including impossibility to the reception terminal 11 (ACT 131). In this case, the first cooperation processing unit 1103 of the reception terminal 11 displays, for example, the reason for the extension impossibility based on the response information provided from the base server 3 (ACT 132). Accordingly, the operator of the reception terminal 11 can, for example, easily review, based on the displayed reason for the extension impossibility, the service time to be granted.

Note that, in the processing, the extension possibility is determined after the operation for deciding the time of the service time is performed in the reception terminal 11. However, determination timing for the extension possibility is not limited to this. For example, the determination of the extension possibility may be performed at timing when operation for designating (selecting) a service time is performed from the service time setting screen L. By providing the time button Lba within an extendable time range, the time of the service time that can be designated on the service time setting screen L may be limited to the extendable time range. Note that, in the processing, the check-in processing unit 313 of the base server 3 determines the extension possibility. However, the first cooperation processing unit 1103 of the reception terminal 11 may determine the extension possibility.

Referring back to FIG. 29, the slip printing button Icd of the operation piece field Ic is an operation piece for instructing to print a slip. If receiving operation of the slip printing button Icd, the first cooperation processing unit 1103 cooperates with the base server 3 to cause the printing unit 119 to print a slip relating to use of a room ID of a karaoke box for which the operation was performed. Specifically, if receiving the operation of the slip printing button Icd, the first cooperation processing unit 1103 transmits, to the base server 3, a slip number request including the store ID of the store where the reception terminal 11 is provided and the room ID of the karaoke box for which the operation was performed.

The check-in processing unit 313 of the base server 3 specifies, according to the slip number request, from the check-in management DB 336, a data record corresponding to conditions of the store ID and the room ID indicated by the slip number request. The check-in processing unit 313 transmits a slip number included in the specified data record to the reception terminal 11 that transmitted the slip number request.

If receiving the slip number from the base server 3 as a response to the slip number request, the first cooperation processing unit 1103 of the reception terminal 11 controls the printing unit 119 to print a slip including the slip number. Note that, since the slip is printed at the time of the check-in, the operation of the slip printing button Icd means reissuance of the slip.

The OK button Ice of the operation piece field Ic is an operation piece for instructing to decide various kinds of operation. For example, the OK button Ice is operated in deciding various kinds of operation performed on the room details screen I.

Note that operation may not be decided on sub-screens such as the halfway exit screen J and the service time setting screen L derivatively displayed from the room details screen I. Operation performed on the sub-screens may be decided by the OK button Ice of the room details screen I. In this case, it is preferable that, if the OK button Ice is operated on each of the sub-screens, the room details screen I clearly identifiably showing change content changed on the sub-screen may be displayed and the change content may be decided by operation of the OK button Ice provided on the room details screen I.

Referring back to FIG. 26, the complaint registration button Gc of the staying selection screen G is an operation piece for instructing to register complaints such as an opinion and a demand received from a user of a karaoke box. If receiving operation of the complaint registration button Gc, the first cooperation processing unit 1103 causes the display unit 116 to display a complaint registration screen on which complaint content can be registered.

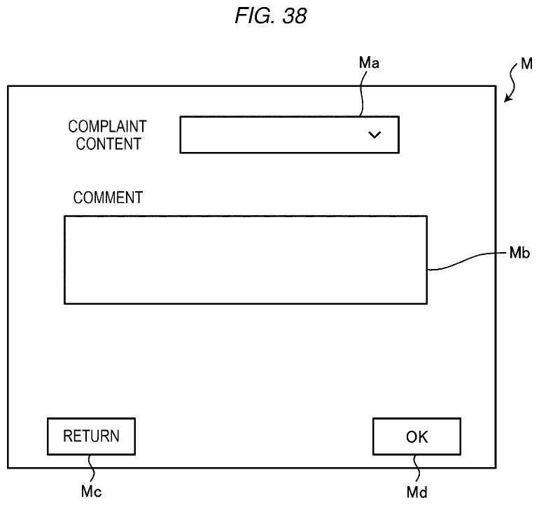

FIG. 38 is a diagram illustrating an example of the complaint registration screen displayed on the reception terminal 11. The complaint registration screen M is an example of an input screen for inputting complaint content declared by a user of a facility corresponding to the room button Bc. As illustrated in FIG. 38, the complaint registration screen M includes a complaint content field Ma, a comment field Mb, a return button Mc, and an OK button Md.

In the complaint content field Ma, complaint content received from a user can be input. For example, in the complaint content field Ma, an operation piece of a pulldown format or the like capable of selecting one kind of complaint content out of a preset plurality of kinds of complaint content is provided. The operator selects one kind of complaint content out of the plurality of kinds of complaint content, whereby the selected complaint content is input to the complaint content field Ma.

Any character string can be input to the comment field Mb. The operator inputs a comment such as details of a complaint received from the user or a message to the other employees to the comment field Mb.

The return button Mc is an operation piece for instructing to return to a screen at a transition source. If the return button Mc is operated, the first cooperation processing unit 1103 cooperates with the base server 3 to display the screen at the transition source.

The OK button Md is an operation piece for instructing to decide information input to the complaint registration screen M. If the OK button Md is operated, the first cooperation processing unit 1103 transmits, to the base server 3, a complaint registration instruction including the store ID of the store where the reception terminal 11 is provided, a room ID of a karaoke box for which the operation was performed, and the complaint content and the comment input to the complaint registration screen M. Note that the first cooperation processing unit 1103 may transmit the complaint registration instruction including the employee ID of the operator to the base server 3.

The complaint processing unit 315 of the base server 3 specifies, according to the complaint registration instruction, from the check-in management DB 336, a data record corresponding to conditions of the store ID and the room ID indicated by the complaint registration instruction. The complaint processing unit 315 stores the complaint content and the comment indicated by the complaint registration instruction, a date and time when the complaint registration instruction was received, and the like in a complaint information field included in the specified data record in correlation.

The complaint processing unit 315 of the base server 3 transmits a complaint reception notification including the room ID, the complaint content, and the comment indicated by the complaint registration instruction to the store clerk terminal 14 correlated with the store having the store ID indicated by the complaint registration instruction. Accordingly, the complaint content received from the user is notified to an employee of the store in real time.

Note that information displayed on the complaint registration screen M is not limited to the screen example illustrated in FIG. 38. For example, the first cooperation processing unit 1103 may cooperate with the base server 3 to, if existing complaint content is registered in complaint information, display the complaint content, a registration date and time, comment content, and the like together. In this case, the first cooperation processing unit 1103 may be configured to be capable of additionally writing a new comment such as complaint handling finished in existing complaint content and display the new comment together with, for example, an additionally written employee ID of an employee. Accordingly, it is possible to easily check the existing complaint content and check a situation of handling. Therefore, it is possible to achieve improvement of convenience.

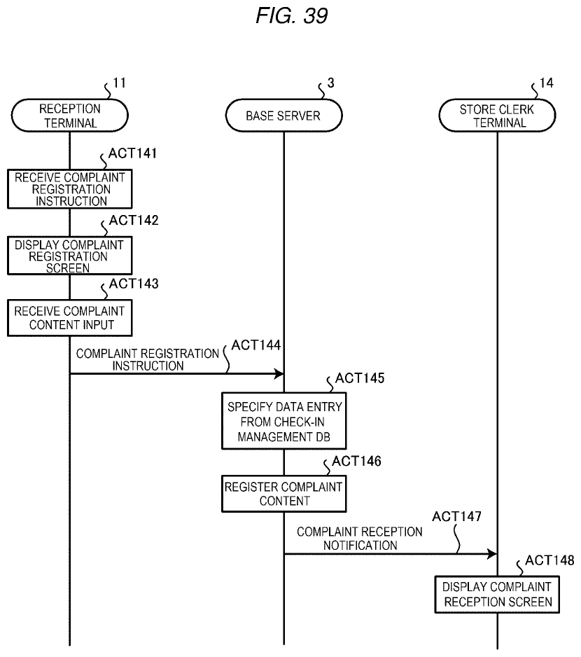

Here, operation examples of the base server 3 and the reception terminal 11 relating to the complaint registration explained above are explained with reference to FIG. 39. FIG. 39 is a sequence chart illustrating an example of processing relating to complaint registration performed between the base server 3 and the reception terminal 11. Note that, as a premise of the processing, it is assumed that the staying selection screen G is displayed on the display unit 116 of the reception terminal 11.

If receiving, according to operation of the complaint registration button Gc or the like, operation for instructing to register a complaint (ACT 141), the first cooperation processing unit 1103 of the reception terminal 11 displays, on the display unit 116, the complaint registration screen M to which complaint content can be input (ACT 142).

The first cooperation processing unit 1103 receives input of complaint content and a comment on the complaint registration screen M (ACT 143). If decision of the complaint content is instructed via the OK button Md or the like, the first cooperation processing unit 1103 transmits, to the base server 3, a complaint registration instruction including the store ID of the store where the reception terminal 11 is provided, a room ID of a karaoke box, and the input complaint content (ACT 144).

If receiving the complaint registration instruction, the complaint processing unit 315 of the base server 3 specifies, from the check-in management DB 336, a data entry corresponding to a set of the store ID and the room ID indicated by the complaint registration instruction (ACT 145). Subsequently, the complaint processing unit 315 registers, in a complaint information field of the specified data entry, the complaint content and the like indicated by the complaint registration instruction (ACT 146).

The complaint processing unit 315 of the base server 3 transmits, to the store clerk terminal 14 belonging to the store ID indicated by the complaint registration instruction, a complaint reception notification including the room ID and the complaint content indicated by the complaint registration instruction (ACT 147).

On the other hand, if receiving the complaint reception notification from the base server 3, the processor of the store terminal 14 causes, based on information included in the complaint reception notification, the display unit to display a screen showing the room ID and the complaint content (hereinafter referred to as complaint reception screen as well) (ACT 148).

FIG. 40 is a diagram illustrating an example of the complaint reception screen displayed on the store clerk terminal 14. As illustrated in FIG. 40, a room ID (a room No.) in which a complaint was registered and complaint content “food serving delay” are displayed on a complaint reception screen N together with a message for informing that the complaint was registered.

Accordingly, an employee carrying the store clerk terminal 14 can easily check a karaoke box in which a complaint was registered and registered complaint content by viewing the complaint reception screen. Therefore, the employee can quickly handle the complaint.

Note that a transmission destination of the complaint reception notification is not limited to the store clerk terminal 14. The complaint processing unit 315 may switch a device at a transmission destination according to complaint content. For example, if the complaint content indicates a serving delay of an ordered commodity (food and beverage), the complaint processing unit 315 may transmit the complaint reception notification to the kitchen terminal 13. For example, if the complaint content indicates malfunction of karaoke equipment or the like, the complaint processing unit 315 may transmit the complaint reception notification to the store clerk terminal 14.

Handling of a complaint by the employee can be smoothly performed by switching a device at a transmission destination according to complaint content as explained above. Therefore, it is possible to efficiently perform operation of the karaoke box.

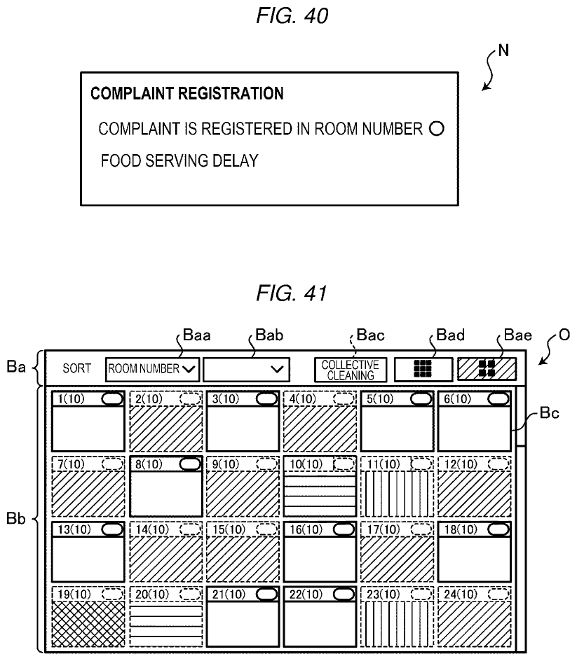

Referring back to FIG. 26, the room movement button Gd of the staying selection screen G is an operation piece operated if a user using a karaoke box is moved to another karaoke box. If receiving operation of the room movement button Gd, the first cooperation processing unit 1103 causes the display unit 116 to display a moving destination selection screen on which the karaoke box at a moving destination can be designated. For example, the first cooperation processing unit 1103 causes the display unit 116 to display a moving destination selection screen illustrated in FIG. 41.

FIG. 41 is a diagram illustrating an example of the moving destination selection screen displayed on the reception terminal 11. As illustrated in FIG. 41, a moving destination selection screen O has the same screen configuration as the screen configuration of the room list screen B. On the moving destination selection screen O, the room buttons Bc of karaoke boxes in the “vacant” state are enabled to be selectable.

On the moving destination selection screen O, the operator selects the room button Bc of a moving destination out of the room buttons Bc displayed to be selectable. If receiving the selection of the room button Bc of the moving destination, the first cooperation processing unit 1103 transmits, to the base server 3, a room movement instruction including the room ID of the store where the reception terminal 11 is provided, a room ID of a karaoke box at a moving source, and a room ID of a karaoke box at a moving destination.

The check-in processing unit 313 of the base server 3 specifies, according to the room movement instruction, from the check-in management DB 336, a data record corresponding to conditions of the indicated store ID and the indicated room ID of the moving source. Then, the check-in processing unit 313 changes the room ID included in the specified data record to the room ID of the moving destination indicated by the room movement instruction. Accordingly, the movement of the karaoke box is executed and the room list screen B after the movement is displayed on the display unit 116 of the reception terminal 11.

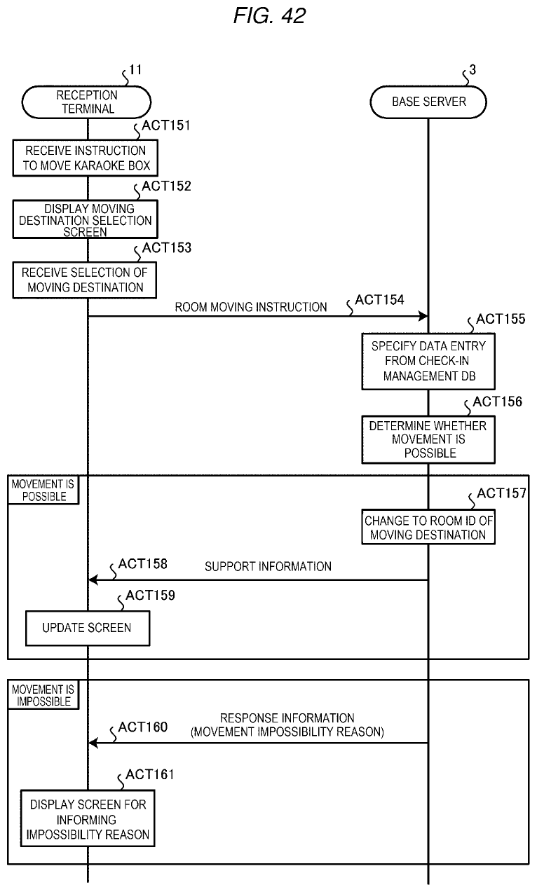

Here, operation examples of the base server 3 and the reception terminal 11 relating to the karaoke box room movement explained above are explained with reference to FIG. 42. FIG. 42 is a sequence chart illustrating an example of processing relating to karaoke box room movement performed between the base server 3 and the reception terminal 11. Note that, as a premise of the processing, it is assumed that the staying selection screen G is displayed on the display unit 116 of the reception terminal 11.

If receiving, according to operation of the room movement button Gd or the like, operation for instructing karaoke box room movement (ACT 151), the first cooperation processing unit 1103 of the reception terminal 11 displays, on the display unit 116, the moving destination selection screen O on which a karaoke box at a moving destination can be selected (ACT 152).

If receiving selection of the karaoke box at the moving destination on the moving destination selection screen O (ACT 153), the first cooperation processing unit 1103 transmits, to the base server 3, a room movement instruction including the store ID of the store where the reception terminal 11 is provided, a room ID of a karaoke box at a moving source, and a room ID of the karaoke box at the moving destination (ACT 154).

If receiving the room movement instruction, the check-in processing unit 313 of the base server 3 specifies, from the check-in management DB 336, a data entry corresponding to a set of the store ID and the room ID of the moving source indicated by the room movement instruction (ACT 155). Subsequently, the check-in processing unit 313 determines, based on basic information of the basic information DB 334 correlated with the room ID of the moving destination, reservation information of the reservation management DB 337 correlated with the room ID of the moving destination, and the like, whether it is possible to move the room ID of the moving source to the room ID of the moving destination (ACT 156).

For example, the check-in processing unit 313 compares the number of users of the karaoke box at the moving source and a minimum capacity and a maximum capacity of the karaoke box at the moving destination to determine whether the movement is possible. Here, if the number of users of the karaoke box at the moving source is equal to or more than the minimum capacity and less than the maximum capacity of the karaoke box at the moving destination, the check-in processing unit 313 determines that movement is possible. If the number of users of the karaoke box at the moving source is less than the minimum capacity and more than the maximum capacity of the karaoke box at the moving destination, the check-in processing unit 313 determines that movement is impossible.

For example, the check-in processing unit 313 compares an exit scheduled date and time of a user using the karaoke box at the moving source and a most recent reservation date and time set in the karaoke box at the moving destination to determine whether movement is possible. Here, if the exit scheduled date and time of the user does not interfere with the reservation date and time of the karaoke box at the moving destination, the check-in processing unit 313 determines that movement is possible. If the exit scheduled date and time of the user interferes with the reservation date and time, the check-in processing unit 313 determines that movement is impossible.

The check-in processing unit 313 determines, based on one or both of the number of users and the exit scheduled date and time explained above, whether movement is possible. If determining that movement is possible, the check-in processing unit 313 changes the room ID included in the data entry specified from the check-in management DB 336 to the room ID of the moving destination (ACT 157). Subsequently, the check-in processing unit 313 cooperates with the alert processing unit 318 to transmit support information reflecting change content to the reception terminal 11 (ACT 158).

The first cooperation processing unit 1103 of the reception terminal 11 updates the room details screen I or the like based on the support information provided from the base server 3 to display a screen reflecting the change content (ACT 159).

If determining that movement is impossible, the check-in processing unit 313 of the base server 3 cooperates with the information provision unit 317 to transmit response information including a reason for the movement impossibility to the reception terminal 11 (ACT 160).

In this case, the first cooperation processing unit 1103 of the reception terminal 11 displays, for example, the reason for the movement impossibility based on the response information provided from the base server 3 (ACT 161). Accordingly, the operator of the reception terminal 11 can, for example, easily review the karaoke box at the moving destination based on the displayed reason for the movement impossibility.

Note that, in the processing, the movement possibility is determined after the karaoke box at the moving destination is indicated in the base server 3. However, timing for determining the movement possibility is not limited to this. For example, the movement possibility may be determined at timing when operation for designating (selecting) the karaoke box at the moving destination is performed on the moving destination selection screen O.

On the moving destination selection screen O, the room button Bc of a movable karaoke box may be enabled to be selectable. In this case, in addition to the condition of the “vacant”, for example, the room button Bc of a karaoke box without a use reservation or a karaoke box for which a use reservation is made but a reservation date and time does not interfere with exit scheduled time of the karaoke box at the moving source only has to be enabled. In addition to the condition of the “vacant”, the room button Bc of the karaoke box in which the number of users of the karaoke box at the moving source can be stored has to be enabled.

In the processing, the check-in processing unit 313 of the base server 3 determines the movement possibility. However, the first cooperation processing unit 1103 of the reception terminal 11 may determine the movement possibility.

Referring back to FIG. 26, the checkout button Ge of the staying selection screen G is an operation piece operated if checkout, that is, check-out for a user who used a karaoke box, is performed. For example, the checkout button Ge is operated at the time of the check-out. Note that, if the reception terminal 11 and a checkout terminal are separately provided, the checkout button Ge may be disabled by, for example, being hidden in the reception terminal 11 and may be configured to be operable in the checkout terminal.

If receiving operation of the checkout button Ge, the first cooperation processing unit 1103 of the reception terminal 11 causes the reading unit 118 to operate and stays on standby until a slip number is read by the reading unit 118. The operator of the reception terminal 11 causes the reading unit 118 to read, for example, a code symbol printed on a slip of a user who checks out. If acquiring the slip number via the reading unit 118, the first cooperation processing unit 1103 transmits a check-out request including the slip number to the base server 3.

If receiving the checkout request, the check-out processing unit 316 of the base server 3 specifies, from the user management DB, a data record corresponding to the slip number indicated by the check-out request. Subsequently, the check-out processing unit 316 registers the present date and time in an exit date and time included in the specified data entry and calculates a use time from an entrance date and time to the exit date and time.

Subsequently, the check-out processing unit 316 of the base server 3 calculates a use amount of the karaoke box based on the calculated use time, a room course and the number of users included in the specified data record, attributes (age categories, presence or absence of member IDs, and the like) of users, an option, order information, a service time, and the like. Note that the check-out processing unit 316 excludes, from use amount calculation targets, users whose entrance and exit states are the “entrance cancelled” and whose checkout finish flags are the “settled”.

The check-out processing unit 316 of the base server 3 cooperates with the information provision unit 317 to transmit details data including a use amount and details relating to calculation of the use amount to the reception terminal 11 that transmitted the check-out request.

If receiving the details data from the base server 3, the first cooperation processing unit 1103 of the reception terminal 11 causes, based on the details data, the display unit 116 to display a checkout screen for performing checkout of the use amount.

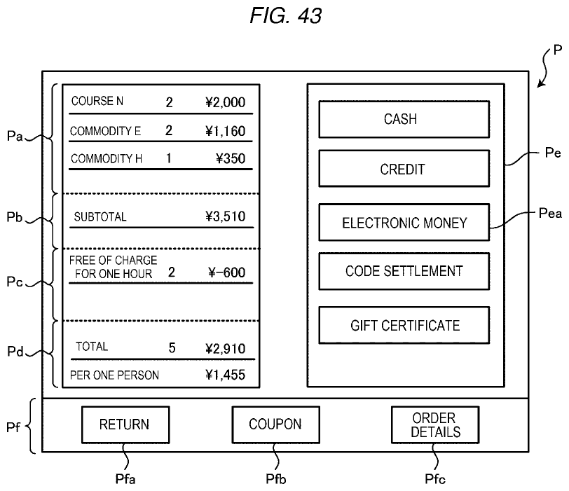

FIG. 43 is a diagram illustrating an example of the checkout screen displayed on the reception terminal 11. As illustrated in FIG. 43, a checkout screen P includes a details display field Pa, a subtotal display field Pb, a discount amount display field Pc, a total display field Pd, a payment method selection field Pe, and an operation piece field Pf.

In the details display field Pa, details relating to calculation of a use amount are displayed. In the subtotal display field Pb, a use amount before price-cut is displayed as a subtotal amount. In the discount amount display field Pc, details relating to a discount amount are displayed. In the total display field Pd, the remaining amount obtained by subtracting the discount amount from the subtotal amount is displayed as a total amount. In the total display field Pd, a use amount of each user is displayed. For example, in the total display field Pd, an amount obtained by dividing the total amount by the number of users is displayed as a use amount per one user.

In the payment method selection field Pe, a payment method button Pea representing various payment methods is displayed. For example, the operator to whom payment methods such as cash, credit, electronic money, code settlement, and gift certificate are displayed as the payment method button Pea selects, via the payment method button Pea, a payment method notified from a user.

In the operation piece field Pf, various operation pieces are provided. For example, in the operation piece field Pf, a return button Pfa, a coupon button Pfb, an order details button Pfc, and the like are provided.

The return button Pfa is an operation piece for instructing to return to a screen at a transition source. If the return button Pfa is operated, the first cooperation processing unit 1103 displays the screen at the transition source.

The coupon button Pfb is an operation piece for inputting coupon information of a coupon owned by a user. The coupon is a ticket for receiving a service of price-cut (or discount) distributed to the user in advance. For example, the coupon retains, in a form of a code symbol or the like, coupon information capable of specifying an amount to be cut. Note that the coupon may be electronically distributed or may be distributed by a paper medium. In the former case, the coupon information is correlated with, for example, a member ID and registered in the member management DB 332.

If the coupon button Pfb is operated, the first cooperation processing unit 1103 of the reception terminal 11 executes processing for receiving input of the coupon information of the coupon owned by the user. If receiving input of a coupon number, the first cooperation processing unit 1103 reflects an amount discounted by the coupon information in the discount amount display field Pc and updates the total display field Pd.

For example, if the coupon information is electronically distributed, the first cooperation processing unit 1103 cooperates with the information provision unit 317 of the base server 3 to acquire coupon information correlated with a member ID of the user from the member management DB. Then, the first cooperation processing unit 1103 displays a screen (not illustrated) on which the acquired coupon information is displayed as a list and receives input of coupon information selected from the screen.

Note that the first cooperation processing unit 1103 may acquire coupon information correlated with a member ID of one member such as a representative or may acquire coupon information correlated with member IDs of all members included in users. If checkout is performed for each user and the user is a member, the first cooperation processing unit 1103 only has to acquire coupon information correlated with a member ID of the member.

For example, if the coupon information is distributed in a form of a paper medium, the first cooperation processing unit 1103 enables the reading unit 118 and receives input of the coupon information via the reading unit 118.

The order details button Pfc is an operation piece operated if a breakdown of commodities order by the user is displayed and edited. If the order details button Pfc is operated, the first cooperation processing unit 1103 of the reception terminal cooperates with the information provision unit 317 of the base server 3 to acquire order information correlated with a slip number from the user management DB. The first cooperation processing unit 1103 displays a screen (not illustrated) representing a breakdown of the acquired order information. For example, the first cooperation processing unit 1103 displayed, in the same screen, a region representing the breakdown of the order information and a region representing a commodity menu to display a screen on which display of order content and commodity additional registration can be performed. If editing operation such as a change of the number of items of an ordered commodity, commodity additional registration, or registration deletion is performed on such a screen, the first cooperation processing unit 1103 updates the subtotal display field Pb and the total display field Pd according to content of the editing operation.

On the checkout screen P explained above, if receiving selection of one payment method button Pea from the payment method selection field Pe, the first cooperation processing unit 1103 of the reception terminal 11 performs checkout processing for a use charge with a payment method of the selected payment method button Pea. Specifically, the first cooperation processing unit 1103 of the reception terminal 11 executes checkout processing for paying a total amount displayed in the total display field Pd with the payment method of the selected payment method button Pea. Then, if the checkout processing is completed, the first cooperation processing unit 1103 transmits a checkout completion notification including a slip number of a processing target transaction to the base server 3.

Note that the first cooperation processing unit 1103 may perform the checkout processing for each user. For example, the first cooperation processing unit 1103 may be configured to receive selection operation for a payment method for each user to individually perform the checkout processing with the selected payment method.

If receiving a checkout completion notification, the check-out processing unit 316 of the base server 3 specifies, from the check-in management DB 336, a data entry corresponding to a slip number indicated by the checkout completion notification and sets checkout finish flags of users included in the data entry to checkout finished. The check-out processing unit 316 removes the specified data entry from the check-in management DB 336 by, for example, moving the specified data entry to another DB.

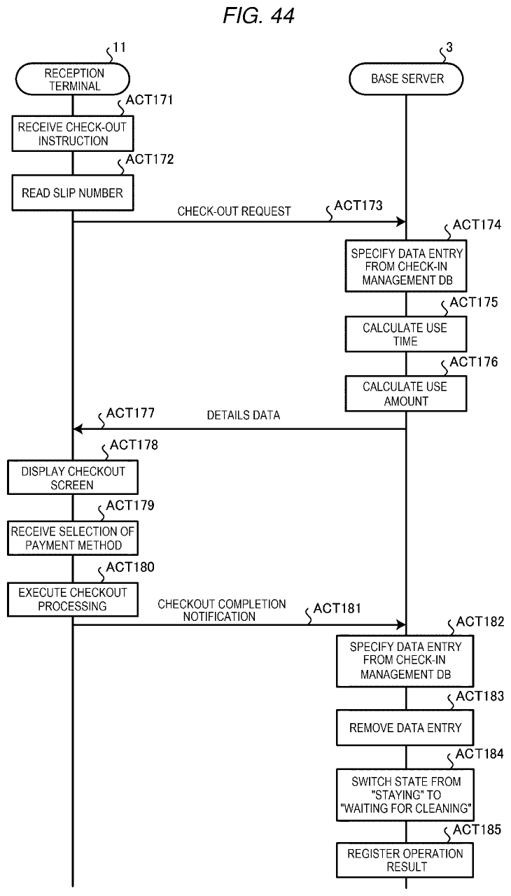

Here, operation examples of the base server 3 and the reception terminal 11 relating to the check-out processing explained above are explained with reference to FIG. 44. FIG. 44 is a sequence chart illustrating an example of check-out processing performed between the base server 3 and the reception terminal 11. Note that, as a premise of the processing, it is assumed that the staying selection screen G is displayed on the display unit 116 of the reception terminal 11.

If receiving, according to operation of the checkout button Ge or the like, operation for instructing to perform check-out (ACT 171), the first cooperation processing unit 1103 of the reception terminal 11 reads a slip number via the reading unit 118 (ACT 172). Subsequently, the first cooperation processing unit 1103 transmits a check-out request including the read slip number to the base server 3 (ACT 173).

If receiving the check-out request, the check-out processing unit 316 of the base server 3 specifies, from the user management DB, a data record corresponding to the slip number indicated by the checkout request (ACT 174). Subsequently, the check-out processing unit 316 calculates a use time from an entrance date and time included in the specified data entry to the present date and time (an exit date and time) (ACT 175).

Subsequently, the check-out processing unit 316 of the base server 3 calculates a use amount of a karaoke box based on various kinds of information included in the specified data entry, the calculated use time, and the like (ACT 176). Subsequently, the check-out processing unit 316 transmits details data including the use amount to the reception terminal 11 (ACT 177).

If receiving the details data from the base server 3 as a response to the check-out request, the first cooperation processing unit 1103 of the reception terminal 11 displays the checkout screen P on the display unit 116 based on the details data (ACT 178). Subsequently, if receiving selection of a payment method for the use amount (ACT 179), the first cooperation processing unit 1103 executes checkout processing for the use amount with the selected payment method (ACT 180). Then, if the checkout processing is completed, the first cooperation processing unit 1103 transmits a checkout completion notification including the slip number read earlier to the base server 3 (ACT 181).

If receiving the checkout completion notification, the check-out processing unit 316 of the base server 3 specifies, from the check-in management DB 336, a data entry corresponding to the slip number indicated by the checkout completion notification (ACT 182). Subsequently, after setting checkout finish flags of users included in the specified data entry to checkout finished, the check-out processing unit 316 removes the data entry from the check-in management DB 336 (ACT 183).

According to ACT 173, the state management unit 311 of the base server 3 switches a state of the state management DB 335 corresponding to a room ID of the data entry removed from the check-in management DB 336 from the “staying” to the “waiting for cleaning” (ACT 184). The state management unit 311 registers, in the operation result DB 338, an operation result of the karaoke box, the state of which was switched (ACT 185).

Accordingly, in the reception terminal 11, the karaoke box shifted to the state of waiting for cleaning is displayed to be identifiable. Therefore, the operator of the reception terminal 11 can easily check the karaoke box in the state of waiting for cleaning from the room list screen or the like.

Note that, in the check-out processing explained above, the checkout processing is performed if all the users exit the karaoke box. However, not only this, but, if a part of the users exits the karaoke box halfway, the checkout processing for the user may be individually performed. In this case, for example, by providing a halfway checkout button or the like in the operation piece field Jb of the halfway exit screen J explained above, according to a request of the user, checkout may be performed if the user exits the karaoke box.

If the halfway checkout button is provided, the first cooperation processing unit 1103 of the reception terminal 11 performs, for example, processing explained below to individually execute the checkout processing for the user who exits the karaoke box halfway.

First, if receiving operation of the halfway checkout button on the halfway exit screen J, the first cooperation processing unit 1103 transmits, to the base server 3, a halfway checkout instruction including the store ID of the store where the reception terminal 11 is provided, a room ID of a karaoke box for which the operation was performed, and a user identifier of a user who exits the karaoke box halfway. Note that, if the user who exits the karaoke box halfway presents a slip, the first cooperation processing unit 1103 may transmit, to the base server 3, a halfway checkout instruction including a slip number acquired from the slip and the user identifier of the user who exits the karaoke box halfway.

If receiving the halfway checkout instruction, the check-out processing unit 316 of the base server 3 specifies, from the user management DB, a data record corresponding to a condition indicated by the halfway checkout instruction. Subsequently, the check-in processing unit 313 calculates, based on various kinds of information such as a room course included in the specified data entry, a use time of the user identifier indicated by the halfway checkout instruction, attributes (an age category, presence or absence of a member ID, and the like), and an option, a use amount of the user who exits the karaoke box halfway. Then, the check-out processing unit 316 cooperates with the information provision unit 317 to transmit details data including the use amount of the user who exits the karaoke box halfway to the reception terminal 11 that transmitted the halfway exit instruction.

If receiving transaction data, the first cooperation processing unit 1103 of the reception terminal 11 displays the same checkout screen P as the checkout screen P illustrated in FIG. 43 based on the transaction data and executes the checkout processing. Then, if the checkout processing for the user who exits the karaoke box halfway is completed, the first cooperation processing unit 1103 of the reception terminal 11 transmits, to the base server 3, a halfway checkout completion notification including a set of the store ID of the store where the reception terminal 11 is provided, a room ID of the karaoke box for which the operation was performed (or a slip number), and a user identifier of the user who exits the karaoke box halfway.

If receiving the halfway checkout completion notification from the reception terminal 11, the check-out processing unit 316 of the base server 3 specifies, from the check-in management DB 336, a data entry corresponding to a condition indicated by the halfway checkout completion notification. Then, the check-out processing unit 316 sets a checkout finish flag of the user identifier indicated by the halfway checkout completion notification to checkout finished.

Accordingly, in the store, the checkout processing can be individually executed for each user who exits the karaoke box halfway. Therefore, in the facility management system 100, it is possible to achieve improvement of convenience relating to use and management of karaoke boxes.

Referring back to FIG. 14, the explanation of the room list screen B is continued. If receiving operation on the room button Bc of the “waiting for cleaning” state on the room list screen B, the first cooperation processing unit 1103 displays a cleaning start screen on which a cleaning start can be instructed.

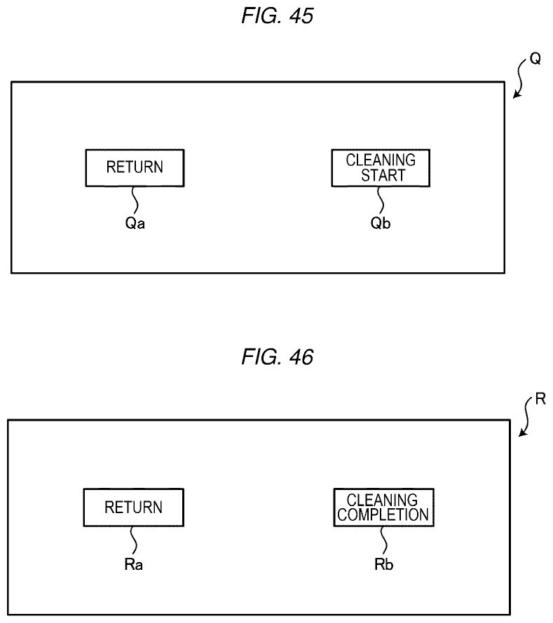

FIG. 45 is a diagram illustrating an example of the cleaning start screen displayed on the reception terminal 11. As illustrated in FIG. 45, a cleaning start screen Q includes a return button Qa and a cleaning start button Qb for instructing a cleaning start. The return button Qa is an operation piece for instructing to return to a screen at a transition source. If the return button Qa is operated, the first cooperation processing unit 1103 displays the screen at the transition source.

The cleaning start button Qb is an operation piece for instructing a cleaning start. If receiving operation of the cleaning start button Qb, the first cooperation processing unit 1103 transmits, to the base server 3, a cleaning start notification including the store ID of the store where the reception terminal 11 is provided and a room ID of a karaoke box for which the operation was performed. The first cooperation processing unit 1103 may transmit the cleaning start notification including the employee ID of the operator to the base server 3.

If receiving the cleaning start notification, the state management unit 311 of the base server 3 specifies, from the state management DB 335, a data entry corresponding to the store ID and the room ID indicated by the cleaning start notification. Subsequently, the state management unit 311 switches a room state of the specified data entry from the “waiting for cleaning” to the “cleaning”. The state management unit 311 registers an operation result of the karaoke box, the state of which was switched, in the operation result DB 338.

On the room list screen B illustrated in FIG. 12, if receiving operation on the room button Bc of the “cleaning” state, the first cooperation processing unit 1103 displays, for example, a cleaning completion screen including an operation piece for instructing to complete cleaning.

FIG. 46 is a diagram illustrating an example of the cleaning completion screen displayed on the reception terminal 11. As illustrated in FIG. 46, a cleaning completion screen R includes a return button Ra and a cleaning completion button Rb for instructing to complete cleaning. The return button Ra is an operation piece for instructing to return to a screen at a transition source. If the return button Ra is operated, the first cooperation processing unit 1103 displays the screen at the transition source.

The cleaning completion button Rb is an operation piece for instructing to complete cleaning. If receiving operation of the cleaning completion button Rb, the first cooperation processing unit 1103 transmits, to the base server 3, a cleaning completion notification including the store ID of the store where the reception terminal 11 is provided and a room ID of a karaoke box for which the operation was performed. The first cooperation processing unit 1103 may transmit the cleaning completion notification including the employee ID of the operator to the base server 3.

If receiving the cleaning completion notification, the state management unit 311 of the base server 3 specifies, from the state management DB 335, a data entry corresponding to the store ID and the room ID indicated by the cleaning completion notification. Subsequently, the state management unit 311 switches a room state of the specified data entry from the “cleaning” to the “vacant”. The state management unit 311 registers an operation result of the karaoke box, the state of which was switched, in the operation result DB 338.

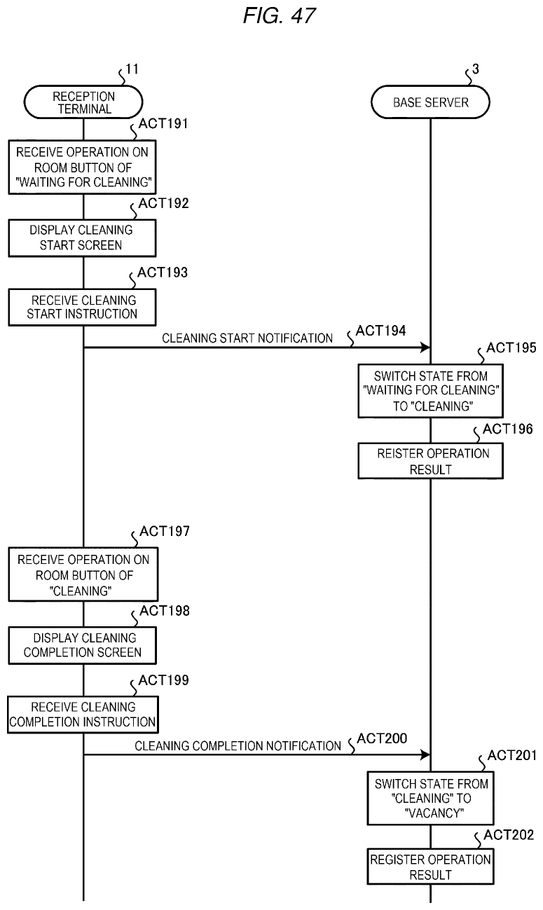

Here, operation examples of the base server 3 and the reception terminal 11 relating to karaoke box cleaning management are explained with reference to FIG. 47. FIG. 47 is a sequence chart illustrating an example of processing relating to cleaning management performed between the base server 3 and the reception terminal 11. Note that, as a premise of the processing, it is assumed that the room list screen B is displayed on the display unit 116 of the reception terminal 11.

If receiving operation of the room button Bc of the “waiting for cleaning” state (ACT 191), the first cooperation processing unit 1103 of the reception terminal 11 displays the cleaning start screen Q on the display unit 116 (ACT 192). If receiving an instruction to start cleaning according to, for example, operation of the cleaning start button Qb (ACT 193), the first cooperation processing unit 1103 transmits, to the base server 3, a cleaning start notification including the store ID of the store where the reception terminal 11 is provided and a room ID of a karaoke box for which the operation was performed (ACT 194).

If receiving the cleaning start notification, the state management unit 311 of the base server 3 switches a state of the state management DB 335 corresponding to the room ID indicated by the cleaning start notification from the “waiting for cleaning” to the “cleaning” (ACT 195). The state management unit 311 registers an operation result of the karaoke box, the state of which was switched, in the operation result DB 338 (ACT 196).

Accordingly, in the reception terminal 11, the karaoke box shifted to the state of cleaning is displayed to be identifiable. Therefore, the operator of the reception terminal 11 can easily check the karaoke box in the state of cleaning from the room list screen B or the like.

If receiving operation of the room button Bc of the “cleaning” state (ACT 197), the first cooperation processing unit 1103 of the reception terminal 11 displays the cleaning completion screen R on the display unit 116 (ACT 198). If receiving, according to, for example, operation of the cleaning completion button Rb, an instruction to complete cleaning (ACT 199), the first cooperation processing unit 1103 transmits, to the base server 3, a cleaning completion notification including the store ID of the store where the reception terminal 11 is provided and a room ID of the karaoke box for which the operation was performed (ACT 200).

If receiving the cleaning completion notification, the state management unit 311 of the base server 3 switches a state of the state management DB 335 corresponding to the room ID indicated by the cleaning completion notification from the “cleaning” to the “vacant” (ACT 201). The state management unit 311 registers an operation result of the karaoke box, the state of which was switched, in the operation result DB 338 (ACT 202).

Accordingly, in the reception terminal 11, the karaoke box shifted to the state of vacant is displayed to be identifiable. Therefore, the operator of the reception terminal 11 can easily check the karaoke box in the state of vacant from the room list screen B or the like.

Referring back to FIG. 13, operations in the case in which other tab operation pieces are operated from the operation screen A are explained.

The tab Abb of the operation screen A is an operation piece operated if checking operation situations of karaoke boxes provided in the store where the reception terminal 11 is provided. If receiving operation of the tab Abb, the first cooperation processing unit 1103 of the reception terminal 11 transmits an operation situation request including the store ID of the store where the reception terminal 11 is provided to the base server 3.

If receiving the operation situation request from the reception terminal 11, the information provision unit 317 of the base server 3 reads, from the state management DB 335, the operation result management DB, and the like a data entry relating to the store ID indicated by the operation situation request. The information provision unit 317 generates, based on the read data entry, support information representing operation situations of the room ID. For example, the information provision unit 317 generates, based on records relating to present and past state transitions of a karaoke box stored in the state management DB 335 and the operation result management DB, support information representing the state transitions of the karaoke box in time series. Then, the information provision unit 317 provides the generated support information to the reception terminal 11 that transmitted the operation situation request.

If receiving the support information from the base server 3 as a response to the operation situation request, the first cooperation processing unit 1103 of the reception terminal 11 causes, based on the support information, the display unit 116 to display (in the display region Ac) an operation situation screen representing the operation situations of the karaoke boxes provided in the store where the reception terminal 11 is provided.

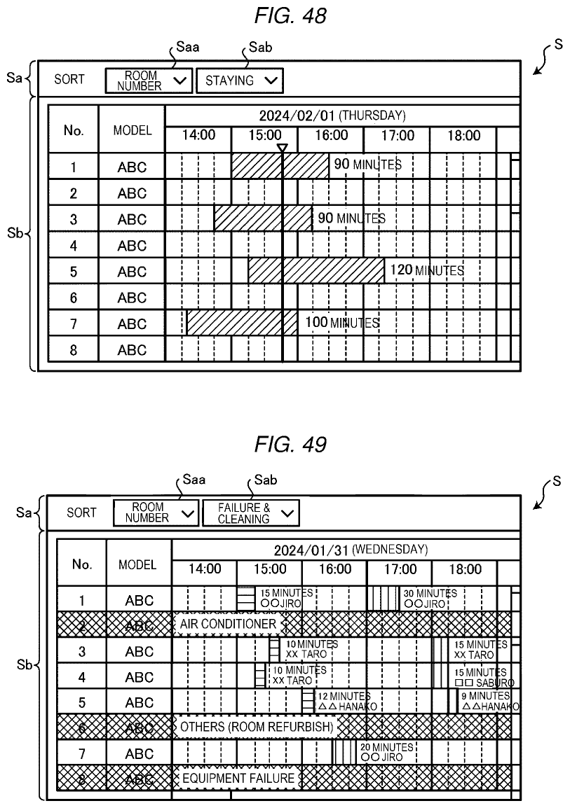

FIG. 48 is a diagram illustrating an example of the operation situation screen displayed on the reception terminal 11. As illustrated in FIG. 48, an operation situation screen S includes an operation piece field Sa and an operation situation field Sb.

In the operation piece field Sa, various operation pieces relating to display control for an operation situation are displayed. For example, in the operation piece field Sa, a first operation piece Saa for indicating arrangement order (display order) of karaoke boxes displayed in the operation situation field Sb, a second operation piece Sab capable of indicating a narrowing-down condition for the karaoke boxes displayed in the operation situation field Sb, and the like are provided.

With the first operation piece Saa and the second operation piece Sab, the order of room IDs to be displayed can be changed by combining, for example, the order of room IDs (room numbers), exit scheduled times, and the order of maximum capacities (or minimum capacities). With the first operation piece Saa and the second operation piece Sab, the order of room IDs to be displayed can be changed in states of the “staying”, the “cleaning”, and the “out of order” of a target to be displayed.

In the operation situation field Sb, information representing an operation state of a karaoke box is displayed. For example, in the operation situation field Sb, in correlation with a room ID and a model name of karaoke equipment provided in the room ID, situations of time-series state transitions of the room ID corresponding thereto are displayed in a graph format such as a Gantt chart. Here, a numerical value in parentheses displayed in correlation with a room ID indicates a maximum capacity of a karaoke box corresponding to the room ID. The model name of the karaoke equipment and the maximum capacity can be acquired from the basic information DB 334.

In the operation situation field Sb illustrated in FIG. 48, a display example in the case in which the “room number” is set by the first operation piece Saa and the “staying” is set by the second operation piece Sab. In this case, in the operation situation field Sb, for example, present and past use times of room IDs currently in the state of the “staying” are represented on a time axis by a period bar Sba representing the period. Note that a time displayed in correlation with the period bar Sba indicates a time from a start date and time to an end date and time or from the start date and time to a use scheduled date and time.

Accordingly, the operator of the reception terminal 11 can easily check, by viewing the operation situation screen S, operation situations of karaoke boxes provided in the store where the reception terminal 11 is provided, that is, results of use times of the karaoke boxes and use situations of the karaoke boxes.

Note that it is assumed that a range of the time axis displayed in the operation situation field Sb is set based on the present date and time. However, it is preferable that the range can be changed according to operation from the operator. The operation situation field Sb is not limited to a form of displaying the present and past operation situations together. The present or past operation situation may be displayed. Further, situations of reservation dates and times registered in the karaoke boxes may be displayed individually or together by using the reservation management DB 337.

FIG. 49 is a diagram illustrating another example of the operation situation screen displayed on the reception terminal 11. The operation situation screen S illustrated in FIG. 49 shows a display example in the case in which the “room number” is set by the first operation piece Saa and the “out of order” and the “cleaning” are set by the second operation piece Sab.

In this case, in the operation situation field Sb, highlighting such as gray-out is applied to a room ID and a graph in a state of the “out of order”, whereby the “out of order” is displayed to be identifiable. Note that character strings such as “air conditioner” displayed in the graph represents a failure reason stored in correlation with the room ID.

In a room ID in the state of the “cleaning”, a period bar Sba representing a period in which the cleaning was performed is displayed on a time axis. Note that a time and a name displayed in correlation with the period bar Sba indicate a time form a start date and time to a completion date and time of the cleaning and a name of an employee who was in charge of the cleaning.

Accordingly, the operator of the reception terminal 11 can easily check, by viewing the operation situation screen S, operation situations of karaoke boxes provided in the store where the reception terminal 11 is provided, that is, a karaoke box in a state of a failure, a time required for cleaning, a person in charge of the cleaning, and the like.

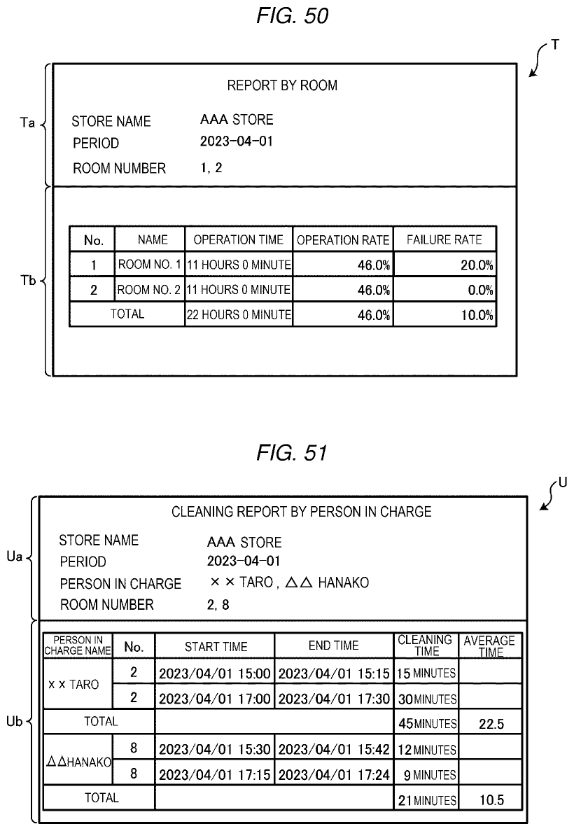

Information representing an operation situation of a karaoke box is not limited to the forms illustrated in FIGS. 48 and 49. For example, the information provision unit 317 of the base server 3 may derive, for each karaoke box, information such as occupied times of states in a predetermined period and rates obtained by dividing the occupied times of the states by a predetermined time and provide information for displaying a result of the derivation to the reception terminal 11 as support information. In this case, the first cooperation processing unit 1103 of the reception terminal 11 may display, for example, a screen illustrated in FIG. 50 (hereinafter referred to as report by room screen) as an operation situation.

FIG. 50 is a diagram illustrating an example of the report by room screen displayed on the reception terminal 11. Note that a method of displaying the report by room screen does not particularly matter. For example, by performing predetermined operation from the operation situation screen S, the report by room screen may be transitioned from the operation situation screen S and displayed. For example, a dedicated tab operation piece for displaying the report by room screen may be provided on the operation screen A illustrated in FIG. 13.

As illustrated in FIG. 50, a report by room screen T includes an information display field Ta and an operation situation field Tb. In the information display field Ta, items such as a store name, a period, and a room number (a room ID) are displayed. In the store name, a store name of a store is displayed.

In the period, a period in which an operation situation is derived is displayed. The items of the period and the room number can be edited via the operation unit 117. In FIG. 50, an example is illustrated in which Apr. 1, 2023 in the past is set in the period.

In the room number, a room ID of a karaoke box for which an operation situation is derived is displayed. The item of the room number can be edited via the operation unit 117. In FIG. 50, an example is illustrated in which karaoke boxes with room IDs “1” and “2” are set in the room number.

In the operation situation field Tb, occupied times of states in a predetermined period set in the period of the information display field Ta, rates of the occupied times, and the like are displayed for each karaoke box having a room ID set in the room number of the information display field Ta. In FIG. 50, an example is illustrated in which, in correlation with a room ID and a name of a karaoke box corresponding to the room ID, an occupied time (an operation time) and a rate (an operation rate) of the “staying” state and an occupied time and a rate (a failure rate) of the “out of order” state in a predetermined time set in the period Tab are displayed.

In the operation situation field Tb, a total field for displaying a total of operation times, an average of operation rates, an average of failure rates, and the like is provided for the room ID set in the room number of the information display field Ta.

Accordingly, the operator of the reception terminal 11 can easily check, by viewing the report by room screen T, an operation time and an operation rate, a failure rate, and the like of a karaoke box in a predetermined time and can multidirectionally grasp an operation situation of the karaoke box. For example, the operator of the reception terminal 11 can specify a karaoke box with a high (or low) operation rate and specify a karaoke box in which a failure frequently occurs. Therefore, the facility management system 100 can efficiently perform karaoke box operation support.

Note that a time length displayed in the operation situation field Tb is not limited to the state of the “staying” and occupied times in other states may be displayed. A rate displayed in the operation situation field Tb is not limited to the states of the “staying” and the “out of order” and rates of other states may be displayed.

In FIGS. 48 to 50, an example of representing an operation situation of a karaoke box is explained. However, operation state of an employee belonging to the store may be represented. For example, the information provision unit 317 of the base server 3 may derive, based on data of the operation result DB relating to a store ID indicated by an operation situation request, for each employee ID, for example, a time required for cleaning the karaoke box and display a screen representing derived information (hereinafter referred to as cleaning report by person in charge screen as well) as an operation situation.

FIG. 51 is a diagram illustrating an example of the cleaning report by person in charge screen displayed on the reception terminal 11. Note that a method of displaying a cleaning report by person in charge screen U does not particularly matter. For example, the cleaning report by person in charge screen U may be displayed by performing predetermined operation on the operation situation screen S. For example, a dedicated tab operation piece for displaying the cleaning report by person in charge screen U may be provided on the operation screen A illustrated in FIG. 13.

As illustrated in FIG. 51, the cleaning report by person in charge screen U includes an information display field Ua and an operation situation field Ub. In the information display field Ua, items such as a store name, a period, a person in charge, and a room number are displayed. In the store name, a name of a store is displayed. In the period, a period in which an operation situation is derived is displayed. In the person in charge, an employee ID and a name of an employee for whom an operation situation is derived are displayed. In the room number, a room ID of a karaoke box for which an operation situation is derived is displayed.

Note that the items of the period, the person in charge, and the room number can be edited via the operation unit 117 or the like. In FIG. 51, an example is illustrated in which Apr. 1, 2023 in the past is set in the period. An example is illustrated in which employees having employee names “XX Taro” and “YY Hanako” are set in the persons in charge. An example is illustrated in which karaoke boxes with room IDs “2” and “8” are set in the room number.

In the operation situation field Ub, for each employee having an employee ID set in the person in charge of the information display field Ua, a result for a predetermined time or the like relating to cleaning of a karaoke box having the room number in the information display field Ua carried out in the period of the information display field Ua is displayed. In FIG. 51, an example is illustrated in which, for each employee name, a room ID of a karaoke box for which an employee having the employee name was in charge of cleaning and a start time, an end time, a cleaning time, and the like of the cleaning are displayed in correlation. Here, the start time and the end time correspond to a start date and time and an end date time recorded in an operation result in which state information is the “cleaning”. The cleaning time is information indicating a time from the start date and time to a completion date and time.

In the operation situation field Ub, a total field is provided for each employee ID. In the total field, a total of cleaning times and an average of the cleaning times are displayed.

Accordingly, by viewing the cleaning report by person in charge screen U, the operator of the reception terminal 11 can easily check a required time, an average time, and the like relating to cleaning of the karaoke box by the employee in a predetermined time and can multidirectionally grasp an operation situation of the employee. For example, the operator of the reception terminal 11 can specify an employee who requires a long time for cleaning. Therefore, the facility management system 100 can efficiently perform karaoke box operation support.

Note that it is conceivable that a cleaning time depends on the size of a karaoke box. Therefore, information representing the size of the karaoke box (for example, a maximum capacity) may be displayed in correlation with the room ID of the operation situation field Ub.

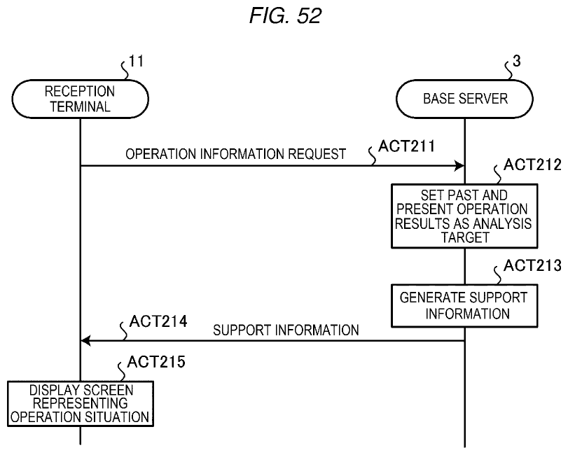

Here, operation examples of the base server 3 and the reception terminal 11 relating to display of an operation situation are explained with reference to FIG. 52. FIG. 52 is a sequence chart illustrating an example of processing relating to display of an operation situation performed between the base server 3 and the reception terminal 11. Note that, as a premise of the processing, it is assumed that the operation screen A is displayed on the display unit 116 of the reception terminal 11.

If being instructed to display an operation situation according to, for example, operation of the tab Abb, the first cooperation processing unit 1103 of the reception terminal 11 transmits an operation situation request including the store ID of the store where the reception terminal 11 is provided to the base server 3 (ACT 211).

If receiving the operation situation request, the information provision unit 317 of the base server 3 refers to the state management DB 335, the operation result DB, and the like relating to the store ID indicated by the operation situation request and sets, as an analysis target, a data entry representing past and present operation results (ACT 212). Subsequently, the information provision unit 317 generates, based on the data entry of the analysis target, support information representing an operation situation concerning a karaoke box or an employee (ACT 213). Subsequently, the information provision unit 317 provides the generated support information to the reception terminal 11 that transmitted the operation situation request.

If receiving the support information from the base server 3 as a response to the operation situation request, the first cooperation processing unit 1103 of the reception terminal 11 displays, based on the support information, on the display unit 116, screens representing the operation situation concerning the karaoke box or the employee (the operation situation screen S, the report by room screen T, the cleaning report by person in charge screen U, and the like) (ACT 215).

If receiving operation for changing conditions of an operation situation and an element to be displayed, the first cooperation processing unit 1103 of the reception terminal 11 returns to ACT 211 and transmits an operation situation request including the condition to the base server 3. Then, the first cooperation processing unit 1103 displays a screen showing the operation situation in ACT 215 based on support information generated by the base server 3 according to the changed condition.

Accordingly, the operator of the reception terminal 11 can multidirectionally grasp, based on the screen showing the operation situation, operation situations concerning the karaoke box and the employee of the store where the reception terminal 11 is provided. Therefore, the facility management system 100 can efficiently perform karaoke box operation support.

Note that, in the above explanation, a form in which the reception terminal 11 cooperates with the base server 3 to display various screens is explained. However, not only this, but, for example, the terminal for external sales 5 and the store clerk terminal 14 may cooperate with the base server 3 to display the various screens explained above. A displayable screen and an operable range may be limited according to a role of a terminal in the store, an authority of an employee who operates the terminal, and the like.

### [Cooperative Operation of the Base Server and the Terminal for External Sales]

Subsequently, an operation example performed between the base server 3 and the terminal for external sales 5 is explained. The second cooperation processing unit 513 of the terminal for external sales 5 performs the same processing as the cooperation start processing explained above with the base server 3 to start cooperation with the base server 3.

Specifically, if succeeding in authentication of an external salesperson to be an operator, the information provision unit 317 of the base server 3 specifies, from the employee management DB, a store ID of a store to which an employee ID indicated by a login request belongs. Subsequently, the information provision unit 317 provides, based on various kinds of information stored in the various DBs, support information relating to the specified store ID to the terminal for external sales 5 that transmitted the login request.

For example, the information provision unit 317 of the base server 3 provides support information capable of displaying the base operation screen (the room list screen) and the like explained above to the terminal for external sales 5. Note that, if a plurality of store IDs are correlated with the employee ID, the information provision unit 317 switches the store IDs and provides the support information capable of displaying the screen.

If the support information is provided from the base server 3 according to the authentication success, the second cooperation processing unit 513 of the terminal for external sales 5 causes, based on the support information, the display unit 116 to display the various screens. For example, the second cooperation processing unit 513 of the terminal for external sales 5 causes, based on the support information provided from the base server 3, the display unit 116 to display the room list screen B and the like explained above. The external salesperson operating the terminal for external sales 5 can check a vacancy situation and a reservation situation of a karaoke box by viewing the room button Bc displayed on the room list screen B.

Note that, if a plurality of store IDs are correlated with the employee ID of the external salesperson, the second cooperation processing unit 513 of the terminal for external sales 5 switches, according to operation for switching the store IDs, a store ID to be displayed. For example, if operation for swiping the room list screen B to the left and the right is performed, the second cooperation processing unit 513 of the terminal for external sales 5 determines that switching operation for the store ID was performed and displays the room list screen B relating to the store ID after the switching.

The second cooperation processing unit 513 of the terminal for external sales 5 cooperates with the base server 3 to provide, as a support screen for supporting an external sales activity of the external salesperson, a screen on which a karaoke box can be booked.

Specifically, if receiving, from the room list screen B, operation of the room button Bc of a karaoke box that is in the state of the “vacant”, the second cooperation processing unit 513 of the terminal for external sales 5 causes the display unit 116 to display a room booking screen on which room booking for the karaoke box corresponding to the room button Bc can be performed.

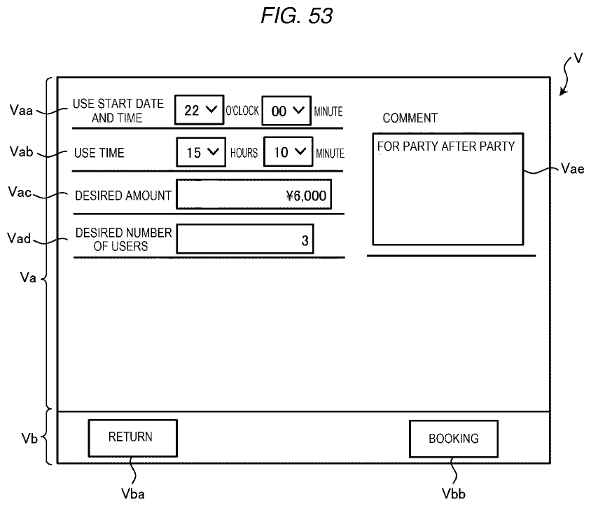

FIG. 53 is a diagram illustrating an example of the room booking screen displayed on the terminal for external sales 5. As illustrated in FIG. 53, a room booking screen V includes a reservation information field Va and an operation piece field Vb.

The reservation information field Va includes items such as a use start time field Vaa, a use time field Vab, a desired amount field Vac, a desired number of users field Vad, and a comment field Vae. Use start time of a user induced by the external salesperson is input to the use start time field Vaa. A use scheduled time of the user induced by the external salesperson is input to the use time field Vab. A planned amount relating to use of a karaoke box desired by the user induced by the external salesperson is input to the desired amount field Vac. The number of users (the number of reserved users) induced by the external salesperson is input to the desired number of users field Vad.

Any character string can be input to the comment field Vae. The external salesperson inputs, to the comment field Vae, an employee ID of the external salesperson and comments such as precautions concerning a user and messages (a discount and a setting request for a free time) to employees of the store.

Various operation pieces are provided in the operation piece field Vb. For example, a return button Vba, a room booking button Vbb, and the like are provided in the operation piece field Vb. The return button Vba is an operation piece for instructing to return to a screen at a transition source. If the return button Vba is operated, the second cooperation processing unit 513 displays the screen at the transition source.

The room booking button Vbb is an operation piece for instructing to decide information input to the reservation information field Va. If the room booking button Vbb is operated, the second cooperation processing unit 513 transmits, to the base server 3, a room booking request including the store ID and the room ID for which the operation was performed and the various kinds of information input to the reservation information field Va. Note that the second cooperation processing unit 513 may transmit the room booking request including the employee ID of the operator.

If receiving the room booking request from the terminal for external sales 5, the reservation management unit 312 of the base server 3 stores the store ID and the room ID indicated by the room booking request and the various kinds of information in the reservation management DB 337 in correlation. Specifically, the reservation management unit 312 stores information such as use start time, a use time, and the number of reserved users in the reservation information field of the reservation management DB 337. The reservation management unit 312 stores a planned amount, a comment, and the like in the additional information field. Note that the reservation management unit 312 may store, in the additional information field, a date and time when the room booking request was received.

Accordingly, in the reception terminal 11 of the store corresponding to the store ID indicated by the room booking request, on the room list screen or the like, the use start time indicated by the room booking request is displayed on for example, the room button Bc of the corresponding room ID. Therefore, a karaoke box booked by the external salesperson is secured such that other users cannot use the karaoke box. Therefore, the external salesperson can efficiently induce a user using the terminal for external sales 5.

Note that the reservation management unit 312 of the base server 3 executes, always or at a predetermined time interval, elapsed time determination comparing the present date and time and reservation dates and times of reservation information stored in the reservation management DB 337 to detect reservation information at a predetermined time elapsed from a reservation date and time. If detecting the reservation information at the predetermined time elapsed from the reservation date and time, the reservation management unit 312 deletes a data entry relating to the reservation information from the reservation management DB 337.

A predetermine elapsed time serving as a determination indicator can be optionally set. In deleting the reservation information, the reservation management unit 312 confirms with the operator of the reception terminal 11 or the terminal for external sales 5 whether the deletion is possible. If an instruction allowing to delete the reservation information is received from the operator, the reservation management unit 312 may delete the reservation information from the reservation management DB 337.

Accordingly, in the store, it is possible to prevent a state in which a karaoke box secured by a room booking request is carelessly continued to be secured. Therefore, in the store, it is possible to efficiently perform karaoke box operation and improve a rate relating to karaoke box use.

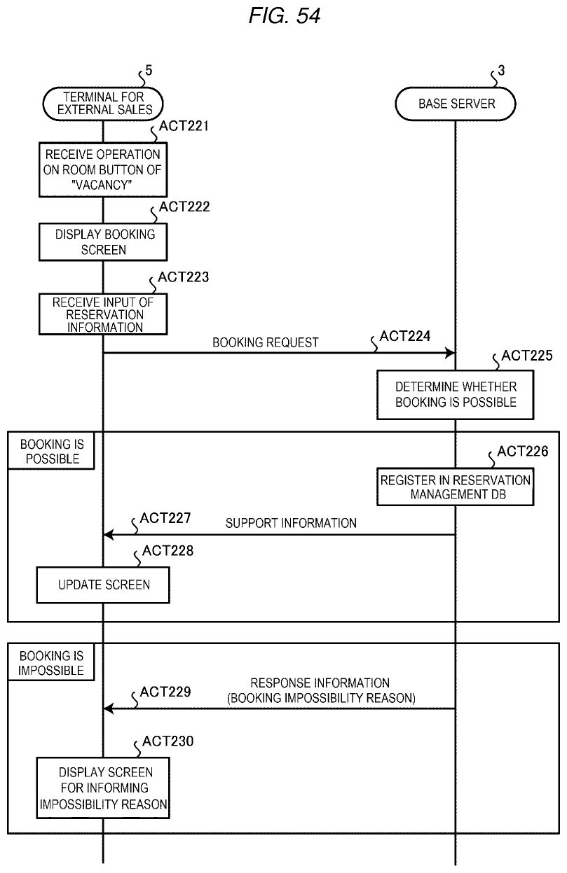

Here, operation examples of the base server 3 and the terminal for external sales 5 relating to karaoke box booking are explained with reference to FIG. 54. FIG. 54 is a sequence chart illustrating an example of processing relating to karaoke box booking performed between the base server 3 and the terminal for external sales 5. Note that, as a premise of the processing, it is assumed that the room list screen B is displayed on the display unit 116 of the terminal for external sales 5.

If receiving, from the room list screen B, operation on the room button Bc of a karaoke box that is in the state of the “vacant” (ACT 221), the second cooperation processing unit 513 of the terminal for external sales 5 displays a room booking screen V on the display unit 116 (ACT 222).

Subsequently, if receiving, via the room booking screen V, input of reservation information or the like for which a reservation date and time or the like is set (ACT 223), the second cooperation processing unit 513 of the terminal for external sales 5 transmits, to the base server 3, a room booking request including a store ID and a room ID for which the operation was performed, the input reservation information, and an employee ID of an operator who operates the terminal for external sales 5 (ACT 224).

If receiving the room booking request, the reservation management unit 312 of the base server 3 refers to the reservation management DB 337 and determines, based on existing reservation information stored in correlation with a set of the store ID and the room ID indicated by the room booking request, whether booking is possible (ACT 225).

For example, the reservation management unit 312 determines whether a time period indicated by the room booking request interferes with an existing reservation date and time. If the time period indicated by the room booking request does not interfere with the existing reservation date and time, the reservation management unit 312 determines that the room booking is possible. If the time period indicated by the room booking request interferes with the existing reservation date and time, the reservation management unit 312 determines that the room booking is impossible.

If determining that the room booking is possible, the reservation management unit 312 of the base server 3 registers reservation information, an employee ID, and the like in the reservation management DB 337 in correlation with the store ID and the room ID indicated by the room booking request (ACT 226). Subsequently, the reservation management unit 312 cooperates with the information provision unit 317 to transmit support information reflecting change content to the terminal for external sales 5 (ACT 227).

The second cooperation processing unit 513 of the terminal for external sales 5 updates the room list screen B or the like based on the support information provided from the base server 3 to display a screen reflecting the change content (ACT 228).

If determining that the room booking is impossible, the reservation management unit 312 of the base server 3 cooperates with the information provision unit 317 to transmit response information including a reason for the room booking impossibility to the reception terminal 11 (ACT 229).

In this case, the second cooperation processing unit 513 of the terminal for external sales 5 displays, for example, the reason for the room booking impossibility based on the response information provided from the base server 3 (ACT 230).

Accordingly, an external salesperson can secure, in a store to which the external salesperson belongs, a karaoke box for a user induced by external sales activities. Therefore, the facility management system 100 can perform karaoke box operation support.

To supplement, if an external salesperson induced a customer to be a user, it was sometimes necessary to, after checking a stay scheduled time and a desired charge of the customer, check, using means such as a telephone, whether the customer was in a situation of being able to enter a store. Since the external salesperson present outside the store was unable to grasp a real-time entrance state of the store, the external salesperson was sometimes unable to inform a stay time conforming to the desire of the induced customer. In a Web reservation system or the like as well, a problem sometimes occurred in that double booking occurred between a person who made a reservation one hour later and the induced customer. It was necessary to inform the desire of the induced customer to the store side with means such as a telephone. A trouble with the customer sometimes occurred because information such as a charge determined by negotiation with the customer was not correctly communicated to the store side.

On the other hand, with the facility management system 100 in the present embodiment, by inputting information concerning entrance corresponding to a desire of a customer from the terminal for external sales 5 and booking a karaoke box of a store, it is possible to prevent double booking between the customer and a customer induced by the store or another external salesperson from occurring. With the facility management system 100, since information such as a desired amount confirmed at the time of negotiation with the customer can be retained on a system and notified to the store side, if the induced customer enters the store, it is possible to cause an employee of the store to correctly grasp the information. Further, with the facility management system 100, if the customer does not enter the store even if a fixed time elapses after booking is performed, a room booking state can be automatically released. Therefore, it is possible to shift the state to a state in which another customer can use the karaoke box.

Note that, in the processing, the possibility of booking (that is, reservation possibility) is determined after the room booking request is received in the base server 3. However, determination timing is not limited to this. For example, the possibility of room booking may be determined at timing when operation for designating (selecting) a room booking target karaoke box is performed on the room list screen B.

On the room list screen B, the room button Bc of a karaoke box that can be booked may be enabled to be selectable. In this case, in addition to the condition of the “vacant”, for example, the room button Bc of a karaoke box without a use reservation or a karaoke box in which a use reservation is made but a reservation date and time is after a predetermined time (for example, after five hours or more or the next day or later) only has to be enabled.

In the processing, the check-in processing unit 313 of the base server 3 performs the determination of room booking possibility. However, the second cooperation processing unit 513 of the terminal for external sales 5 may perform the determination of room booking possibility. In this case, if determining that room booking is impossible, the second cooperation processing unit 513 displays, for example, a reason for the room booking impossibility to inform the external salesperson.

If receiving the room booking request, the reservation management unit 312 of the base server 3 may compare maximum and minimum capacities of the karaoke box indicated by the room booking request and the number of users indicated by the room booking request to determine possibility of room booking (that is, reservation possibility). For example, if the number of users indicated by the room booking request is within a range of the maximum and minimum capacities of the karaoke box, the reservation management unit 312 determines that the room booking is possible. If the number of users indicated by the room booking request deviates from the range of the maximum and minimum capacities of the karaoke box, the reservation management unit 312 determines that the room booking is impossible.

In the case of a room booking request by the external salesperson, the possibility of room booking may be determined in a range exceeding the maximum and minimum capacities set in the karaoke box. For example, if discriminating, according to an access from the terminal for external sales 5 or an employee ID included in the room booking request, that a use reservation is a use reservation by the external salesperson, the reservation management unit 312 may extend the maximum capacity and/or the minimum capacity set in the karaoke box by a predetermined amount and determine possibility of room booking in an extended range. Alternatively, if discriminating that the use reservation is the use reservation by the external salesperson, the reservation management unit 312 may release limitation of the maximum capacity and/or the minimum capacity set in the karaoke box.

Note that, if the comparative determination of the maximum and minimum capacities is performed, timing for the determination is not limited to this. For example, the comparative determination of maximum and minimum capacities may be performed at timing when operation for inputting the number of users is performed on the room booking screen V.

The check-in processing unit 313 of the base server 3 may perform or the second cooperation processing unit 513 of the terminal for external sales 5 may perform the comparative determination of the maximum and minimum capacities. In this case, if determining that the number of users deviates from the range of the maximum and minimum capacities, the second cooperation processing unit 513 displays, as a reason for the room booking impossibility, the deviation from the range of the maximum and minimum capacities to inform the external salesperson.

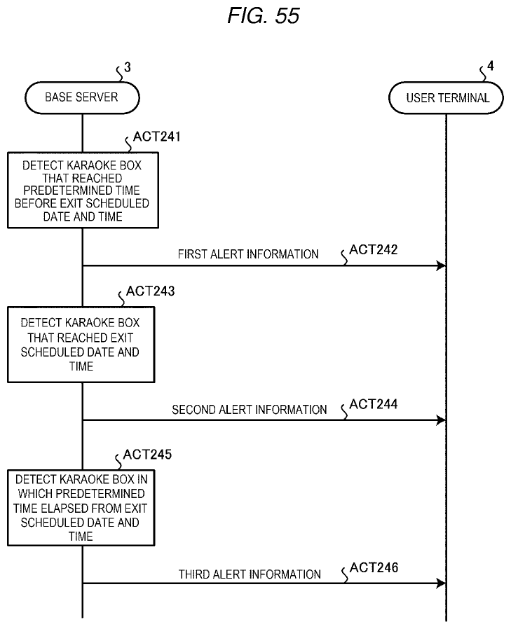

Subsequently, an operation example relating to alert processing performed by the alert processing unit 318 of the base server 3 is explained. FIG. 55 is a sequence chart illustrating an example of the alert processing performed by the alert processing unit 318 of the base server 3.

First, the alert processing unit 318 of the base server 3 performs, based on the present date and time and exit scheduled dates and times of data entries registered in the check-in management DB 336, first detection processing for detecting a karaoke box that reached a predetermined time before an exit scheduled date and time (ACT 241). If detecting a karaoke box that reached a predetermined time before an exit scheduled date and time, the alert processing unit 318 transmits, based on a member ID or a contact of a user who uses the karaoke box, first alert information for alerting the user terminal 4 of the user to the exit scheduled date and time and the reaching the predetermined time before the exit scheduled date and time (ACT 242).

The alert processing unit 318 of the base server 3 performs, based on the present date and time and the exit scheduled dates and times of the data entries registered in the check-in management DB 336, second detection processing for detecting a karaoke box that reached an exit scheduled date and time (ACT 243). If detecting a karaoke box that reached an exit scheduled date and time, the alert processing unit 318 transmits, based on a member ID or a contact of a user who uses the karaoke box, second alert information for alerting the user terminal 4 of the user to the exit scheduled date and time and the reaching the exit scheduled date and time (ACT 244).

The alert processing unit 318 of the base server performs, based on the present date and time and the exit scheduled dates and times of the data entries registered in the check-in management DB 336, third detection processing for detecting a karaoke box at a predetermined time elapsed from an exit scheduled date and time (ACT 245). If detecting a karaoke box at a predetermined time elapsed from an exit scheduled date and time, the alert processing unit 318 transmits, based on a member ID or a contact of a user who uses the karaoke box, third alert information for alerting the user terminal 4 of the user to the exit scheduled date and time and the predetermined time having elapsed from the exit scheduled date and time (ACT 246).

Accordingly, since a user using the karaoke box receives the alert before and after the exit scheduled date and time and at timing of reaching the exit scheduled date and time, the user can efficiently perform preparation for exit, an extension procedure for a use time, and the like. Therefore, the facility management system 100 can perform support relating to karaoke box use.

Note that the user terminal 4 that is an alert destination of alert information may be, for example, the user terminal 4 of a user registered in a representative information field or may be the user terminal 4 of another user. In the latter case, the alert information may be transmitted to the user terminals 4 of all users. Note that it is preferable to transmit the alert information to the user terminals 4 of users whose entrance and exit states are the “staying” and the “halfway entered”. If the user in the representative information field is the “halfway exited” or the “entrance cancelled”, one user may be selected out of the users whose entrance and exit states are the “staying” and the “halfway entered” and the alert information may be transmitted to the user terminal 4 of the user.

An alert destination of the alert information is not limited to the user terminal 4. For example, the alert processing unit 318 may transmit, based on a store ID and a room ID included in a data entry of the check-in management DB 336, the alert information to the order terminal 12 provided in a karaoke box corresponding to the store ID and the room ID. For example, the alert processing unit 318 may transmit, based on a store ID included in a data entry of the check-in management DB 336, the alert information to the reception terminal 11 and the store clerk terminal 14 of a store corresponding to the store ID.

In the processing, the alert information is transmitted before and after the exit scheduled date and time and at the timing of reaching the exit scheduled date and time. However, not only this, but the alert information may be transmitted at any timing. For example, transmission timing for the alert information may be able to be set for each store by storing timing relating to transmission of the alert information in the store management DB in correlation with a store ID.

As explained above, according to the present embodiment, it is possible to manage a use situation of a facility for each user. More specifically, a store can grasp, in addition to states of facilities, for example, whether the facilities are used by users or are vacant, halfway exit and halfway entrance of a user. By making use of this, it is possible to further calculate, for each user, an amount reflecting an actual use time, a course, an option, attributes (for example, an age and a status), and the like of the user. In other words, according to the present embodiment, it is possible to manage not only a use charge and a use time of the facility but also entrance and exit in units of one person.

According to the present embodiment, it is possible to aggregate, for each room and/or for each person in charge, how long times of the “out of order”, the “cleaning”, and the like were and provide an aggregation result in a form of a list or the like. Accordingly, it is possible to give guidance and work instruction to a person in charge who takes long time for cleaning. It is possible to grasp, about a room that is out of order for a long time, in conjunction with a function of registering a failure cause, which equipment causes the long time failure and provide reference information for selection of equipment.

According to the present embodiment, it is possible to perform complaint registration if receiving a complaint from a user. According to the present embodiment, it is possible to, if the complaint registration is performed, notify registered content to the store clerk terminal 14 carried by an employee. Accordingly, it is possible to achieve improvement of user experience and convenience of the user.

Note that the embodiment explained above can also be modified and carried out as appropriate by changing a part of the components and the functions of the devices explained above. Therefore, in the following explanation, several modifications relating to the embodiment explained above are explained as other embodiments. Note that, in the following explanation, differences from the embodiment explained above are mainly explained. Detailed explanation is omitted about similarities to the content explained above. The modifications explained below may be individually carried out or may be carried out in combination as appropriate.

### (Modification 1)

In the embodiment explained above, the form in which the reception the operation result of the store where the reception terminal 11 is provided is displayed in the reception terminal 11 is explained. However, a store for which the display is performed is not limited to this.

For example, the information provision unit 317 of the base server 3 may provide the reception terminal 11 with support information capable of displaying operation results of a plurality of stores, the support information being based on a belonging store and an authority correlated with an employee ID of the operator who operates the reception terminal 11. For example, if an employee is a manager of an area where a plurality of stores are present or a manager who collectively manages all the stores, the information provision unit 317 generates and provides support information representing operation results of the plurality of stores managed by the employee. The information provision unit 317 derives, for each store, operation rates and failure rates of all karaoke boxes in a predetermined period and generates support information including a result of the derivation.

If transmitting an operation result request to the base server 3, the first cooperation processing unit 1103 of the reception terminal 11 transmits the operation result request including the employee ID of the operator who operates the reception terminal 11 itself. A screen representing an operation result may be a form of switching and displaying the operation result for each store or may display operation results of the plurality of stores in the same screen to display the operation results in a comparative form among the stores. In the latter case, the first cooperation processing unit 1103 displays the operation rates and the failure rates of all the karaoke boxes in the predetermined period in a comparative state among the stores.

Accordingly, since the operator of the reception terminal 11 can check operation situations of the plurality of stores, the operator can grasp properties (characteristics), improvements, and the like of the stores. Therefore, the facility management system 100 can improve convenience relating to karaoke box operation.

### (Modification 2)

In the embodiment explained above, the employee operates the reception terminal 11. However, the user himself or herself may operate the reception terminal 11. In this case, the reception terminal 11 may be configured to selectively switch an operation mode in which the employee operates the reception terminal 11 (hereinafter referred to as manned mode as well) and an operation mode in which the user himself or herself operates the reception terminal 11 (hereinafter referred to as self-mode as well).

A method of switching the operation modes does not particularly matter. Various methods can be adopted. For example, a method of inputting an employee ID and a password and performing authentication of the employee to shift to the manned mode and instructing shift to the self-mode in the manned mode may be adopted.

Note that, if causing the reception terminal 11 to operate in the self-mode, it is preferable to limit a part of the functions and the screens explained above. For example, it is preferable to make the function relating to the display of the operation result unusable. The function relating to the complaint registration may made unusable.

### (Modification 3)

In the embodiment explained above, the slip number is issued at the check-in time and printed on the slip. However, not only this, but the slip number may not be used. Specifically, information capable of specifying a data entry relating to a karaoke box used by the user from the user DB only has to be included in the slip and printed. For example, the first cooperation processing unit 1103 of the reception terminal 11 may print both or one of a room ID of a karaoke box and a member ID of a representative on the slip. The room ID and the member ID may be printed on the slip in a form of a code symbol.

Accordingly, processing relating to issuance of the slip number can be omitted in the base server 3. Therefore, it is possible to achieve efficiency of processing.

### (Modification 4)

In the embodiment explained above, an example is explained in which the base server 3 operates as an entity of the processing. However, the reception terminal 11 may be configured to operate as the entity of the processing by including a part or all of the functional components of the base server 3.

For example, the reception terminal 11 may be configured to directly operate the user management DB retained by the base server 3 by including the check-in processing unit 313 and the check-out processing unit 316. For example, the reception terminal 11 may derive an operation situation from the various DBs retained by the base server 3 and dynamically generate various screens by including the information provision unit 317.

### (Modification 5)

In the embodiment explained above, the form in which the facility used by the user is the karaoke box and the reception terminal 11 is installed at a reception of the store including the karaoke box is explained. However, the facility to be used is not limited to the karaoke box and can be applied to another facility if the facility is a facility lent to a user in hour unit. For example, the facility may be a leisure facility such as a darts bar or a manga café or an exercise facility such as a sports gym, a golf course, or a bowling alley. That is, the reception terminals 11 installed at receptions of these facilities may be configured as in the embodiment explained above.

The embodiment (and the modifications) are explained above. However, these embodiments are presented as examples and are not intended to limit the scope of the invention. These new embodiments can be implemented in other various forms. Various omissions, substitutions, combinations, and changes can be made without departing from the gist of the invention. These embodiments and the modifications of the embodiments are included in the scope and the gist of the invention and included in the inventions described in claims and the scope of equivalents of the inventions.

Programs executed in the devices in the embodiment explained above are provided by being incorporated in advance in storage media (ROMs or storage units) included in the devices. However, the programs are not limited to this. For example, the programs may be configured to be provided by being recorded in a computer-readable recording medium such as a CD-ROM, a flexible disk (FD), a CD-R, or a DVD (Digital Versatile Disk) as a file of an installable format or an executable format. Further, the storage media are not limited to media independent of a computer or an incorporated system and include storage media in which programs transmitted by a LAN, the Internet, or the like are downloaded and stored or temporarily stored.

The programs executed in the devices in the embodiment may be stored on a computer connected to a network such as the Internet and provided by being downloaded through the network or may be configured to be provided or distributed through the network such as the Internet.

What is claimed is:

1. A job support device, comprising:
a check-in component configured to, if receiving an instruction to start use of a facility, store, in correlation with a facility identifier configured to identify the facility, in a storage component, a user identifier of a user who uses the facility and a date and a time when the user starts the use;
a halfway entrance component configured to, if a halfway entrance of a user is indicated to the facility being used, store, in correlation with the facility identifier of the facility, in the storage component, a user identifier of the user who enters the facility halfway and a date and a time of the halfway entrance; and
a check-out component configured to, if receiving an instruction to end the use of the facility, calculate a use charge of the facility based on a use time of the facility of each of the user identifiers correlated with the facility identifier of the facility.

2. A job support device according to claim 1, wherein the halfway entrance component stores, in the storage component, as the date and the time of the halfway entrance, one of the date and time when the use of the facility starts, a present date and a present time, and a date and a time designated from the user.

3. The job support device according to claim 1, further comprising a halfway exit component configured to, if halfway exit of the user using the facility is indicated, store, in the storage component, a date and a time of the halfway exit in correlation with, among the user identifiers stored in correlation with the facility identifier of the facility, a user identifier of the user who exits the halfway exit.

4. The job support device according to claim 3, wherein the halfway exit component stores, in the storage component, as the date and the time of the halfway exit, one of a present date and a present time and a date and a time designated by the user.

5. The job support device according to claim 1, further comprising a menu storage component configured to store, in correlation with the user identifiers, in the storage component, menus used in the facility by the users corresponding to the user identifiers, wherein
the check-out component calculates the use charge of the facility based on an amount of the menu correlated with each of the user identifiers.

6. The job support device according to claim 1, wherein the check-out component calculates a total amount obtained by totaling use amounts of the users or a use amount for each of the users.

7. The job support device according to claim 1, wherein the use time is calculated by determining a time length from an entrance date and an entrance time to an exit date and an exit time.

8. A job support method, comprising:
if receiving an instruction to start use of a facility, storing, in correlation with a facility identifier configured to identify the facility, in a storage component, a user identifier of a user who uses the facility and a date and a time when the user starts the use;
if halfway entrance of a user is indicated to the facility being used, storing, in correlation with the facility identifier of the facility, in the storage component, a user identifier of the user who enters the facility halfway and a date and a time of the halfway entrance; and
if receiving an instruction to end the use of the facility, calculating a use charge of the facility based on a use time of the facility of each of the user identifiers correlated with the facility identifier of the facility.

9. A job support method according to claim 8, further comprising:
storing as the date and the time of the halfway entrance, one of the date and time when the use of the facility starts, a present date and a present time, and a date and a time designated from the user.

10. The job support method according to claim 8, further comprising:
if halfway exit of the user using the facility is indicated, storing a date and a time of the halfway exit in correlation with, among the user identifiers stored in correlation with the facility identifier of the facility, a user identifier of the user who exits the halfway exit.

11. The job support method according to claim 10, further comprising storing, as the date and the time of the halfway exit, one of a present date and a present time and a date and a time designated by the user.

12. The job support method according to claim 8, further comprising:
storing, in correlation with the user identifiers, menus used in the facility by the users corresponding to the user identifiers; and
calculating the use charge of the facility based on an amount of the menu correlated with each of the user identifiers.

13. The job support method according to claim 8, further comprising calculating a total amount obtained by totaling use amounts of the users or a use amount for each of the users.

14. The job support method according to claim 8, further comprising calculating the use time by determining a time length from an entrance date and an entrance time to an exit date and an exit time.

15. A karaoke box store device, comprising:
a check-in component configured to, if receiving an instruction to start use of a karaoke box store, store, in correlation with a facility identifier configured to identify the karaoke box store, in a storage component, a user identifier of a user who uses the karaoke box store and a date and a time when the user starts the use;
a halfway entrance component configured to, if a halfway entrance of a user is indicated to the karaoke box store being used, store, in correlation with the karaoke box store identifier of the karaoke box store, in the storage component, a user identifier of the user who enters the facility halfway and a date and a time of the halfway entrance; and
a check-out component configured to, if receiving an instruction to end the use of the karaoke box store, calculate a use charge of the karaoke box store based on a use time of the karaoke box store of each of the user identifiers correlated with the facility identifier of the karaoke box store.

16. The karaoke box store device according to claim 15, wherein the halfway entrance component stores, in the storage component, as the date and the time of the halfway entrance, one of the date and time when the use of the karaoke box store starts, a present date and a present time, and a date and a time designated from the user.

17. The karaoke box store device according to claim 15, further comprising a halfway exit component configured to, if halfway exit of the user using the karaoke box store is indicated, store, in the storage component, a date and a time of the halfway exit in correlation with, among the user identifiers stored in correlation with the facility identifier of the karaoke box store, a user identifier of the user who exits the halfway exit.

18. The karaoke box store device according to claim 17, wherein the halfway exit component stores, in the storage component, as the date and the time of the halfway exit, one of a present date and a present time and a date and a time designated by the user.

19. The karaoke box store device according to claim 15, further comprising a menu storage component configured to store, in correlation with the user identifiers, in the storage component, menus used in the karaoke box store by the users corresponding to the user identifiers, wherein
the check-out component calculates the use charge of the karaoke box store based on an amount of the menu correlated with each of the user identifiers.

20. The karaoke box store device according to claim 15, wherein the check-out component calculates a total amount obtained by totaling use amounts of the users or a use amount for each of the users.
